(19) United States
(12) Patent Application Publication
(10) Pub. No.: US 2024/0370118 A1
(43) Pub. Date: Nov. 7, 2024

(54) TOUCH SCREEN DISPLAY WITH PROXIMITY BASED VARIABLE TOUCH RESOLUTION

(71) Applicant: SigmaSense, LLC., Austin, TX (US)

(72) Inventors: Michael Shawn Gray, Elgin, TX (US); Patrick Troy Gray, Cedar Park, TX (US); Daniel Keith Van Ostrand, Leander, TX (US); Richard Stuart Seger, JR., Belton, TX (US); Timothy W. Markison, Mesa, AZ (US)

(73) Assignee: SigmaSense, LLC., Austin, TX (US)

(21) Appl. No.: 18/774,679

(22) Filed: Jul. 16, 2024

Related U.S. Application Data
(63) Continuation of application No. 17/348,409, filed on Jun. 15, 2021, now abandoned.
Application No. 17/348,409 is a continuation-in-part of application No. 17/248,473, filed on Jan. 26, 2021, now Pat. No. 11,586,309.
Application No. 17/248,473 is a continuation of application No. 16/132,131, filed on Sep. 14, 2018, now Pat. No. 10,908,718.

(51) Int. Cl. G06F 3/041; G06F 3/044

(52) U.S. Cl. CPC G06F 3/041661; G06F 3/0412; G06F 3/0446

(57) ABSTRACT

A touch screen display includes a display configured to display images in a display area. Touch sensitive row electrodes and touch sensitive column electrodes are integrated into the display and spaced apart to support a highest touch resolution. Also included are drive-sense circuits, a first switch network coupling a first group of drive-sense circuits to the touch sensitive row electrodes, and a second switch network coupling a second group of drive-sense circuits to the touch sensitive column electrodes. A switch controller is coupled to the first switch network and to the second switch network, and controls the first and second switch networks to control touch resolution of at least a portion of the display area. A processing is coupled to the switch controller and drive-sense circuits, and is configured to detect a proximate finger or stylus and, in response, transmit touch resolution change information to the switch controller.

### CROSS REFERENCE TO RELATED APPLICATIONS

The present U.S. Utility Patent Application claims priority pursuant to 35 U.S.C. § 120 as a continuation of U.S. Utility application Ser. No. 17/348,409, entitled “TOUCH SCREEN DISPLAY WITH VARIABLE TOUCH RESOLUTION,”, filed Jun. 15, 2021, which is a continuation-in-part of U.S. Utility application Ser. No. 17/248,473, entitled “LARGE TOUCH SCREEN DISPLAY WITH INTEGRATED ELECTRODES,” filed Jan. 26, 2021, issued as U.S. Pat. No. 11,586,309 on Feb. 21, 2023, which is a continuation of U.S. Utility application Ser. No. 16/132,131, entitled “LARGE TOUCH SCREEN DISPLAY WITH INTEGRATED ELECTRODES,” filed Sep. 14, 2018, issued as U.S. Pat. No. 10,908,718 on Feb. 2, 2021, all of which are hereby incorporated herein by reference in their entirety and made part of the present U.S. Utility Patent Application for all purposes.

### BACKGROUND OF THE INVENTION

### Technical Field of the Invention

This invention relates generally to touch screen displays, and more particularly to touch screen displays with variable touch resolution.

### Description of Related Art

Sensors are used in a wide variety of applications ranging from in-home automation, to industrial systems, to health care, to transportation, and so on. For example, sensors are placed in bodies, automobiles, airplanes, boats, ships, trucks, motorcycles, cell phones, televisions, touch-screens, industrial plants, appliances, motors, checkout counters, etc. for the variety of applications.

In general, a sensor converts a physical quantity into an electrical or optical signal. For example, a sensor converts a physical phenomenon, such as a biological condition, a chemical condition, an electric condition, an electromagnetic condition, a temperature, a magnetic condition, mechanical motion (position, velocity, acceleration, force, pressure), an optical condition, and/or a radioactivity condition, into an electrical signal.

A sensor includes a transducer, which functions to convert one form of energy (e.g., force) into another form of energy (e.g., electrical signal). There are a variety of transducers to support the various applications of sensors. For example, a transducer is capacitor, a piezoelectric transducer, a piezoresistive transducer, a thermal transducer, a thermocouple, a photoconductive transducer such as a photoresistor, a photodiode, and/or a phototransistor.

A sensor circuit is coupled to a sensor to provide the sensor with power and to receive the signal representing the physical phenomenon from the sensor. The sensor circuit includes at least three electrical connections to the sensor: one for a power supply; another for a common voltage reference (e.g., ground); and a third for receiving the signal representing the physical phenomenon. The signal representing the physical phenomenon will vary from the power supply voltage to ground as the physical phenomenon changes from one extreme to another (for the range of sensing the physical phenomenon).

The sensor circuits provide the received sensor signals to one or more computing devices for processing. A computing device is known to communicate data, process data, and/or store data. The computing device may be a cellular phone, a laptop, a tablet, a personal computer (PC), a work station, a video game device, a server, and/or a data center that support millions of web searches, stock trades, or on-line purchases every hour.

The computing device processes the sensor signals for a variety of applications. For example, the computing device processes sensor signals to determine temperatures of a variety of items in a refrigerated truck during transit. As another example, the computing device processes the sensor signals to determine a touch on a touch screen. As yet another example, the computing device processes the sensor signals to determine various data points in a production line of a product.

### BRIEF DESCRIPTION OF THE SEVERAL VIEWS OF THE DRAWING(S)

FIG. 1A is a logic diagram of an embodiment of a method for altering the resolution of a touch screen display.

FIG. 1B is a logic diagram of another embodiment of a method for altering the resolution of a touch screen display.

FIG. 1C is a logic diagram of an embodiment of methods for implementation by a switch controller to enact and/or alter the touch resolution of a touch screen display.

FIG. 2 is a schematic block diagram of an embodiment of a computing device.

FIG. 3 is a schematic block diagram of another embodiment of a computing device.

FIG. 4 is a schematic block diagram of an embodiment of a touch screen display.

FIG. 5 is a schematic block diagram of another embodiment of a touch screen display.

FIG. 6 is a logic diagram of an embodiment of a method for sensing a touch on a touch screen display.

FIG. 7 is a schematic block diagram of an embodiment of a drive sense circuit.

FIG. 8 is a schematic block diagram of another embodiment of a drive sense circuit.

FIG. 9A is a cross section schematic block diagram of an example of a touch screen display with in-cell touch sensors.

FIG. 9B is a schematic block diagram of an example of a transparent electrode layer with thin film transistors.

FIG. 9C is a schematic block diagram of an example of a pixel with three sub-pixels.

FIG. 9D is a schematic block diagram of another example of a pixel with three sub-pixels.

FIG. 9E is a schematic block diagram of an example of sub-pixel electrodes coupled together to form row electrodes of a touch screen sensor.

FIG. 9F is a schematic block diagram of an example of sub-pixel electrodes coupled together to form column electrodes of a touch screen sensor.

FIG. 9G is a schematic block diagram of an example of sub-pixel electrodes coupled together to form row electrodes and column electrodes of a touch screen sensor.

FIG. 9H is a schematic block diagram of an example of a segmented common ground plane forming row electrodes and column electrodes of a touch screen sensor.

FIG. 9I is a schematic block diagram of another example of sub-pixel electrodes coupled together to form row and column electrodes of a touch screen sensor.

FIG. 9J is a cross section schematic block diagram of an example of a touch screen display with on-cell touch sensors.

FIG. 10A is a cross section schematic block diagram of an example of self-capacitance with no-touch on a touch screen display.

FIG. 10B is a cross section schematic block diagram of an example of self-capacitance with a touch on a touch screen display.

FIG. 11 is a cross section schematic block diagram of an example of self-capacitance and mutual capacitance with no-touch on a touch screen display.

FIG. 12 is a cross section schematic block diagram of an example of self-capacitance and mutual capacitance with a touch on a touch screen display.

FIG. 13 is an example graph that plots condition verses capacitance for an electrode of a touch screen display.

FIG. 14 is an example graph that plots impedance verses frequency for an electrode of a touch screen display.

FIG. 15 is a time domain example graph that plots magnitude verses time for an analog reference signal.

FIG. 16 is a frequency domain example graph that plots magnitude verses frequency for an analog reference signal.

FIG. 17 is a schematic block diagram of an example of a first drive sense circuit coupled to a first electrode and a second drive sense circuit coupled to a second electrode without a touch proximal to the electrodes.

FIG. 18 is a schematic block diagram of an example of a first drive sense circuit coupled to a first electrode and a second drive sense circuit coupled to a second electrode with a finger touch proximal to the electrodes.

FIG. 19 is a schematic block diagram of an example of a first drive sense circuit coupled to a first electrode and a second drive sense circuit coupled to a second electrode with a pen touch proximal to the electrodes.

FIG. 20 is a schematic block diagram of another example of a first drive sense circuit coupled to a first electrode and a second drive sense circuit coupled to a second electrode with a pen touch proximal to the electrodes.

FIG. 21 is a schematic block diagram of another embodiment of a touch screen display.

FIG. 22 is a schematic block diagram of a touchless example of a few drive sense circuits and a portion of the touch screen processing module of a touch screen display.

FIG. 23 is a schematic block diagram of a finger touch example of a few drive sense circuits and a portion of the touch screen processing module of a touch screen display.

FIG. 24 is a schematic block diagram of a pen touch example of a few drive sense circuits and a portion of the touch screen processing module of a touch screen display.

FIG. 25 is a schematic block diagram of an embodiment of a computing device having touch screen display.

FIG. 26 is a schematic block diagram of another embodiment of a computing device having touch screen display.

FIG. 27 is a schematic block diagram of another embodiment of a computing device having touch screen display.

FIG. 28 is a schematic block diagram of another example of a first drive sense circuit coupled to a first electrode and a second drive sense circuit coupled to a second electrode without a touch proximal to the electrodes.

FIG. 29 is a schematic block diagram of an example of a computing device generating a capacitive image of a touch screen display.

FIG. 30 is a schematic block diagram of another example of a computing device generating a capacitive image of a touch screen display.

FIG. 31 is a logic diagram of an embodiment of a method for generating a capacitive image of a touch screen display.

FIG. 32 is a schematic block diagram of an example of generating capacitive images over a time period.

FIG. 33 is a logic diagram of an embodiment of a method for identifying desired and undesired touches using a capacitive image.

FIG. 34 is a schematic block diagram of an example of using capacitive images to identify desired and undesired touches.

FIG. 35 is a schematic block diagram of another example of using capacitive images to identify desired and undesired touches.

FIG. 36 is a schematic block diagram of an embodiment of a near bezel-less touch screen display.

FIG. 37 is a schematic block diagram of another embodiment of a near bezel-less touch screen display.

FIG. 38 is a schematic block diagram of an embodiment of touch screen circuitry of a near bezel-less touch screen display.

FIG. 39 is a schematic block diagram of an example of frequencies for the various analog reference signals for the drive-sense circuits.

FIG. 40 is a schematic block diagram of another embodiment of a near bezel-less touch screen display.

FIG. 41 is a schematic block diagram of another embodiment of multiple near bezel-less touch screen displays.

FIG. 42 is a schematic block diagram of an embodiment of processing modules for the multiple near bezel-less touch screen displays of FIG. 41.

FIG. 43 is a cross section schematic block diagram of an example of a touch screen display having a thick protective transparent layer.

FIG. 44 is a cross section schematic block diagram of another example of a touch screen display having a thick protective transparent layer.

FIG. 45 is a schematic block diagram of an electrical equivalent circuit of two drive sense circuits coupled to two electrodes without a finger touch.

FIG. 46 is a schematic block diagram of an electrical equivalent circuit of two drive sense circuits coupled to two electrodes with a finger touch.

FIG. 47 is a schematic block diagram of an electrical equivalent circuit of a drive sense circuit coupled to an electrode without a finger touch.

FIG. 48 is an example graph that plots finger capacitance verses protective layer thickness of a touch screen display.

FIG. 49 is an example graph that plots mutual capacitance verses protective layer thickness and drive voltage verses protective layer thickness of a touch screen display.

FIG. 50 is an example graph that plots self-capacitance verses protective layer thickness and drive voltage verses protective layer thickness of a touch screen display.

FIG. 51 is a cross section schematic block diagram of another example of a touch screen display having a thick protective transparent layer.

FIG. 52 is a schematic block diagram of an embodiment of a large touch screen display with an on-screen control panel.

FIG. 53 is a schematic block diagram of another embodiment of a large touch screen display with an on-screen control panel.

FIG. 54 is a schematic block diagram of an embodiment of a plurality of electrodes creating a plurality of touch sense cells.

FIG. 55 is a schematic block diagram of another embodiment of a plurality of electrodes creating a display area and a control panel area.

FIG. 56 is a schematic block diagram of an example of activating or deactivating an on-screen control panel on a large touch screen display.

FIG. 57 is a logic diagram of an example of utilizing an on-screen control panel of a large touch screen display.

FIG. 58 is a schematic block diagram of an embodiment of a scalable touch screen display.

FIG. 59 is a schematic block diagram of an embodiment of a sense-processing circuit of a scalable touch screen display.

FIG. 60 is a schematic block diagram of an example of frequency dividing for reference signals for drive-sense circuits of a touch screen display.

FIG. 61 is a schematic block diagram of an example of bandpass filtering for the frequency dividing of the reference signals for drive-sense circuits of a touch screen display.

FIG. 62 is a schematic block diagram of another example of bandpass filtering for the frequency dividing of the reference signals for drive-sense circuits of a touch screen display.

FIG. 63 is a schematic block diagram of an example of frequency and time dividing for reference signals for drive-sense circuits of a touch screen display.

FIGS. 64A and 64B are a schematic block diagram of another example of frequency and time dividing for reference signals for drive-sense circuits of a touch screen display.

FIG. 65 is a schematic block diagram of a touch screen device employing switch networks to selectively couple row and column electrodes to particular drive-sense circuits of a touch screen display to achieve the highest touch resolution of the touch screen display.

FIG. 66 is a schematic block diagram of a touch screen device employing switch networks to selectively couple multiple row and column electrodes to single drive-sense circuits of a touch screen display to achieve a lesser touch resolution of the touch screen display.

FIG. 67 is a schematic block diagram of a touch screen device employing switch networks to selectively couple fewer than all row and column electrodes to selected drive-sense circuits of a touch screen display to achieve a lesser touch resolution of the touch screen display.

FIG. 68 is a schematic block diagram of a touch screen device employing switch networks to selectively couple fewer than all row and column electrodes to selected drive-sense circuits in different portions of the touch screen to achieve different touch resolutions in different parts of the touch screen display.

FIG. 69 is a schematic block diagram of a touch screen device employing switch networks to selectively couple fewer than all row and column electrodes to selected drive-sense circuits in some portions of the touch screen, and selectively couple multiple row and column electrodes to single drive-sense circuits to achieve different touch sensitivities or resolutions in different parts of the touch screen display.

FIG. 70 a schematic diagram of a touch screen device capable of selectively coupling electrode pads to drive-sense circuits.

FIG. 71 is a diagram illustrating grouping of sub-pixel electrodes to form highest resolution electrode pads.

FIG. 72 is a diagram illustrating a grouping of electrode pads to form row and column electrodes having a pitch consistent with a highest touch resolution.

FIG. 73 is a diagram illustrating a grouping of larger electrode pads to form row and column electrodes having a pitch consistent with a lesser touch resolution.

FIG. 74 is a diagram illustrating a grouping of electrode pads to form row and column electrodes having a pitch consistent with an intermediate touch resolution.

FIG. 75 is a diagram illustrating a grouping of electrode pads, with two unused electrode pads between electrode pads connected to form row and column electrodes having a pitch consistent with a low touch resolution.

FIG. 76 is a diagram illustrating a grouping of electrode pads, with one unused electrode pad between electrode pads connected to form row and column electrodes having a pitch consistent with a medium touch resolution.

FIG. 77 is a diagram illustrating a touch screen display configured to have different touch resolutions in different portions of the screen by selectively coupling electrode pads to form row and column electrodes with different pitches in different portions of the screen.

FIG. 78 is a flowchart illustrating a method of adjusting a touch resolution of a touch sensitive display.

FIG. 79 is a flowchart illustrating another method of adjusting a touch resolution of a touch sensitive display.

FIG. 80 is a flowchart illustrating a method of controlling a switch network to adjust a touch resolution of a touch sensitive display including row and column electrodes.

FIG. 81 is a flowchart illustrating a method of controlling a switch network to adjust a touch resolution of a touch sensitive display including electrode pads.

FIG. 82 is a logic diagram of an example of altering the resolution of a touch screen display based on video content that includes a touch-related image(s).

FIG. 83 is a logic diagram of an example of altering the resolution of a touch screen display based on characteristics of displayed video content.

FIG. 84 is a block diagram of a mobile communication device having touch sensors used to determine when to disable functions of the mobile communication device.

FIG. 85 is a diagram illustrating various views of a mobile communication device and touch sensors located thereon.

FIG. 86 is a diagram illustrating various views of a differing touch sensor construct of the mobile communication device.

FIG. 87A is a diagram illustrating the mobile communication device located in a pocket of a user.

FIG. 87B is a diagram illustrating the mobile communication device resting on a surface.

FIG. 88A is a diagram illustrating the mobile communication device held by a hand of a user.

FIG. 88B is a diagram illustrating the mobile communication device held in both hands of a user.

FIG. 89 is a flow chart illustrating operation of the mobile communication device according to aspects herein.

### DETAILED DESCRIPTION OF THE INVENTION

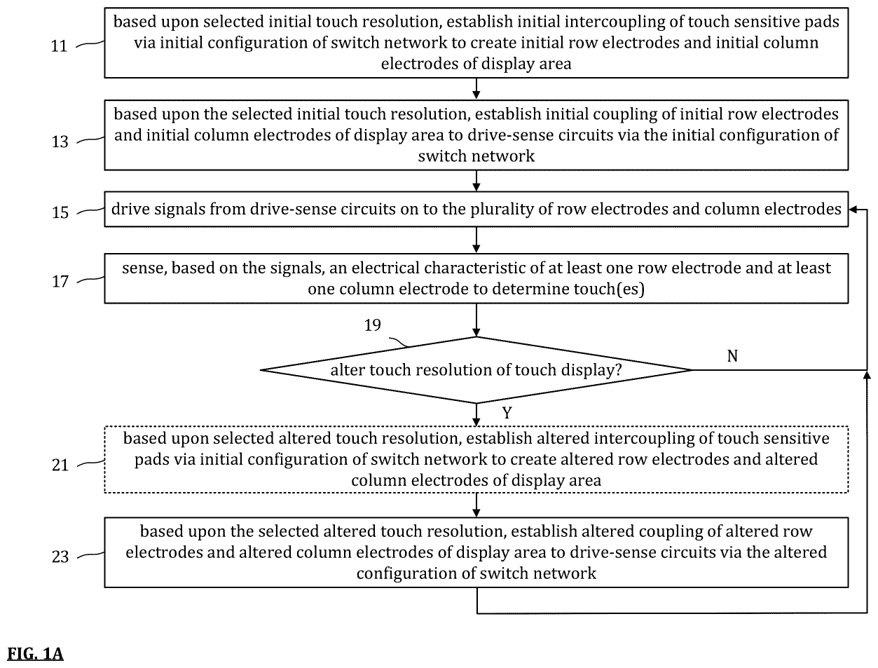

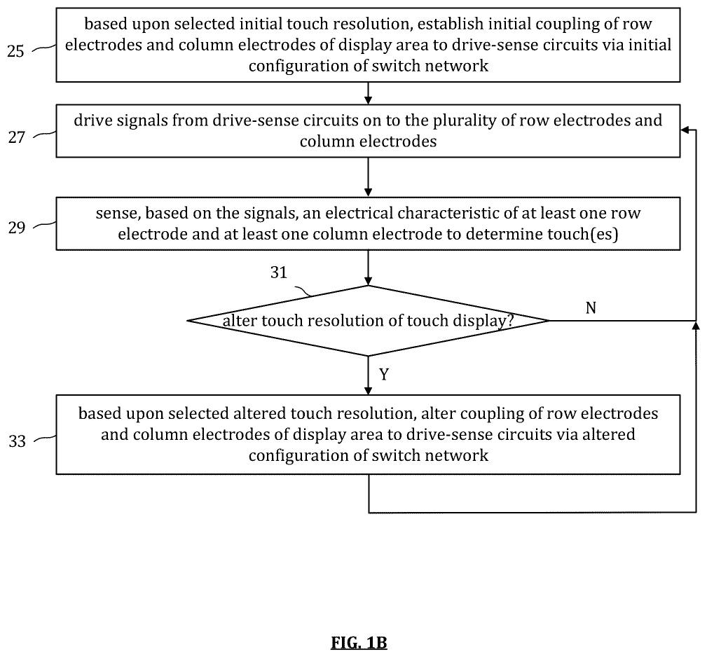

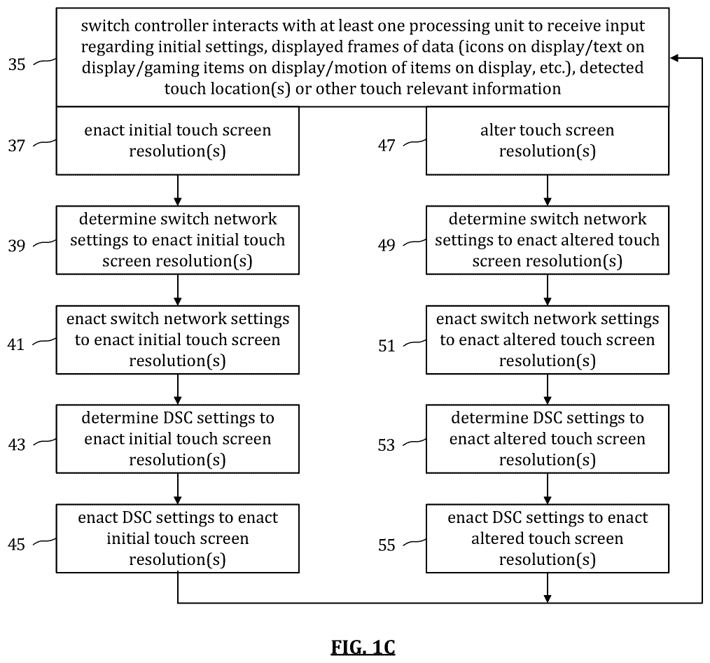

FIG. 1A is a logic diagram of an embodiment of a method for altering the resolution of a touch screen display having touch sensitive row and column electrodes formed of touch sensitive pads (also referred to herein as electrode pads). In the illustrated method, the touch sensitive pads are selectively coupled together to form touch sensitive row and column electrodes, which in turn are selectively coupled to drive-sense circuits (DSCs) to dynamically establish a desired touch resolution in all or portions of a display area of a touch screen display. Such flexibility in touch resolution enables a touch screen display to adapt, for example, to the individual characteristics of a user (e.g., finger size) and/or the nature of displayed video content to improve touch accuracy.

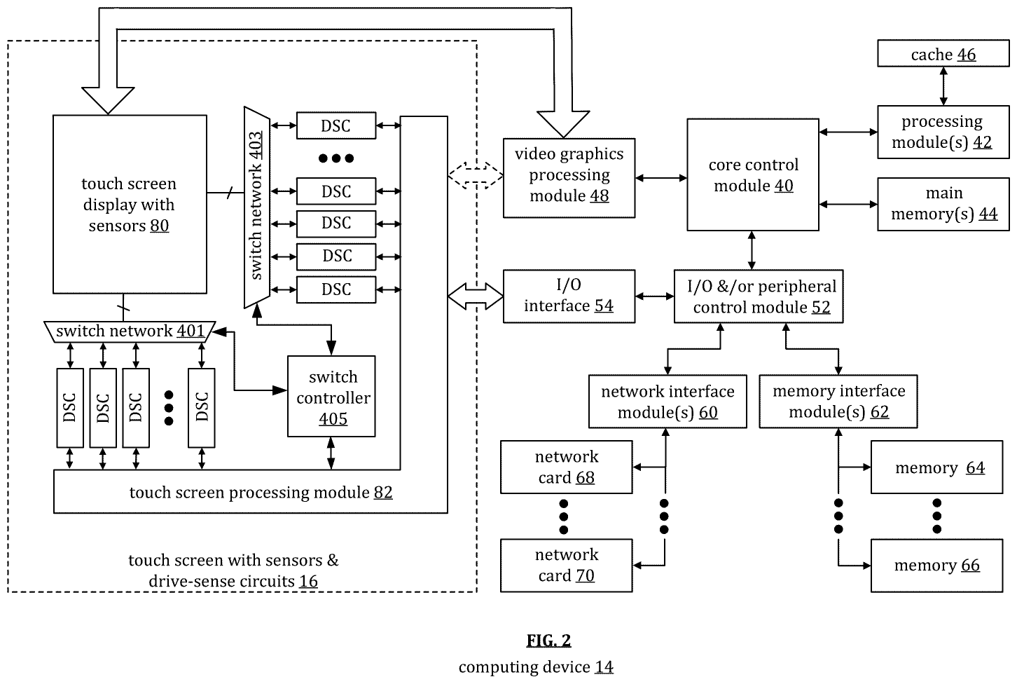

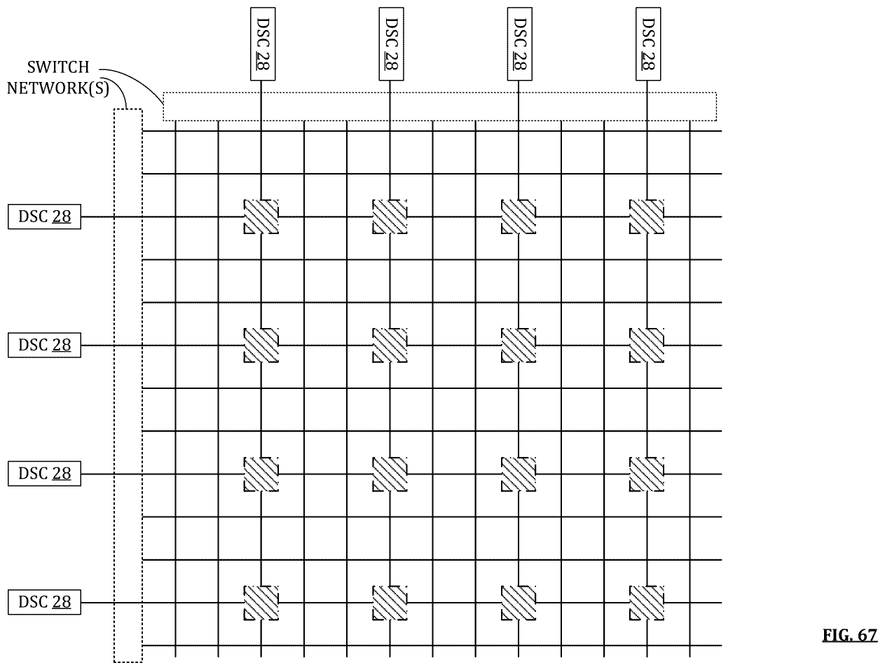

The method of FIG. 1A is performed by one or more processing modules of the touch screen display, such as described with reference to FIGS. 2-4, operating in conjunction with a switch controller and one or more switch networks. The method begins at step 11 where, based upon a selected initial touch resolution, a processing module of the touch screen display establishes an initial intercoupling of touch sensitive pads, via an initial configuration of a switch network, to create initial row electrodes and initial column electrodes of the display area. Various embodiments and arrangements of touch sensitive pads are described more fully below with reference to FIGS. 65-69.

The initial touch resolution can correspond, for example, to a default touch resolution, a user-selected touch resolution, or a last known touch resolution prior to a power cycle of the touch screen display. In another example, the initial touch resolution is established utilizing identification information associated with displayed video content. For example, meta-data associated with fast-paced gaming content or sports-related content with touch-based input options can be utilized by the processing module to establish (or modify) the initial touch resolution. As described more fully below, the initial touch resolution can be the same across all of the display area or can differ in different areas of the display.

The method continues at step 13 where, based upon the selected initial touch resolution, the processing module establishes an initial coupling of the initial row electrodes and column electrodes of the display area to drive-sense circuits via the initial configuration of the switch network. In an example, each of the initial row electrodes and initial column electrodes are independently coupled to a drive-sense circuit. In another example, two or more of the initial row electrodes or initial column electrodes are coupled to a single drive-sense circuit. Examples of such configurations are described in greater detail with reference to FIGS. 65-69.

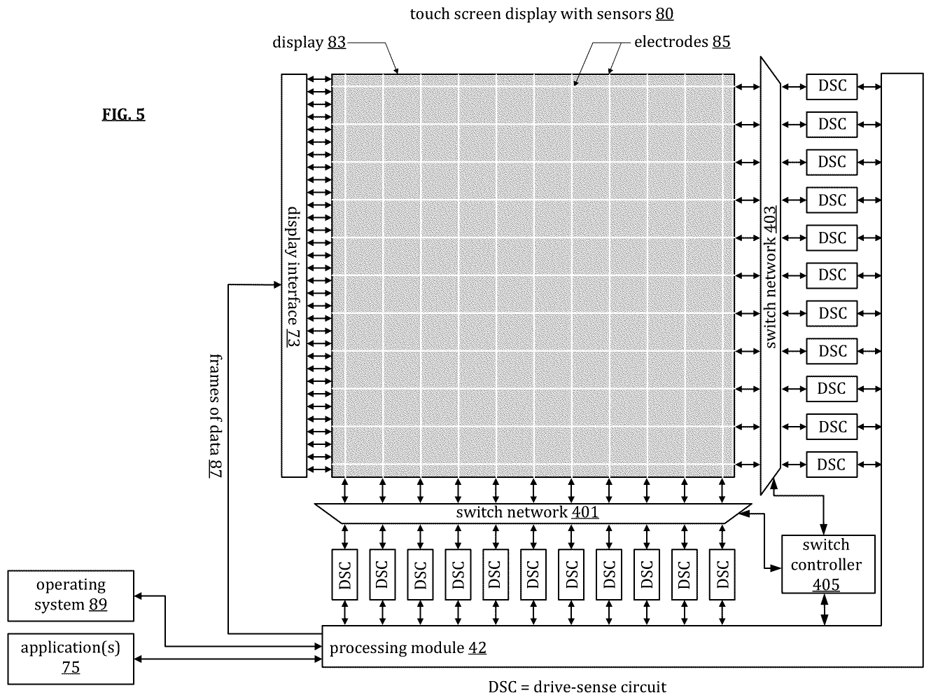

Next, at step 15, the processing module enables the drive-sense circuits (DSCs) to drive signals on to the plurality of row electrodes and column electrodes formed at step 11. The method continues at step 17 where the processing module senses, based on the signals, an electrical characteristic of at least one row electrode and at least one column electrode to determine a touch(es). Briefly, the signals provided by the DSCs are utilized to detect changes in sensed capacitance values of the row and column electrodes that are indicative of a touch or approaching touch. Further details regarding operation of the DSCs are provided below (see, e.g., FIGS. 6-8 and FIGS. 10A-24 and the associated detailed description).

The method continues at step 19 where the processing module determines whether to alter the touch resolution of the touch display. The determination can be based, for example, on the detection of a finger/stylus touch at step 17. In another example, the determination can be based on detecting a proximate finger/stylus (e.g., at a specified distance from the display area). Additional examples of determining to alter a touch resolution are described in greater detail below. If the processing module determines not to alter the initial touch resolution (e.g., no touch is detected), the method repeats at step 15.

If determining to alter the initial touch resolution, the processing module selects an altered touch resolution, and the method continues at step 21. In this step, the processing module utilizes the altered touch resolution to establish an altered intercoupling of touch sensitive pads via an altered configuration of the switch network to create altered row electrodes and altered column electrodes of the display area.

Next, at step 23, the processing module utilizes the altered touch resolution to establish altered coupling of the altered row electrodes and the altered column electrodes of the display area to the DSCs via the altered configuration of the switch network. As described more fully below, the altered touch resolution can be the same across all of the display area or can differ in different areas of the display. Further, in one embodiment the processing module can be configured to alter the initial touch resolution by altering the coupling of the initial row electrodes and initial column electrodes to the DSCs (e.g., without performing step 21). In another embodiment, the processing module alters the initial touch resolution by altering the intercoupling of the touch sensitive pads without performing step 23.

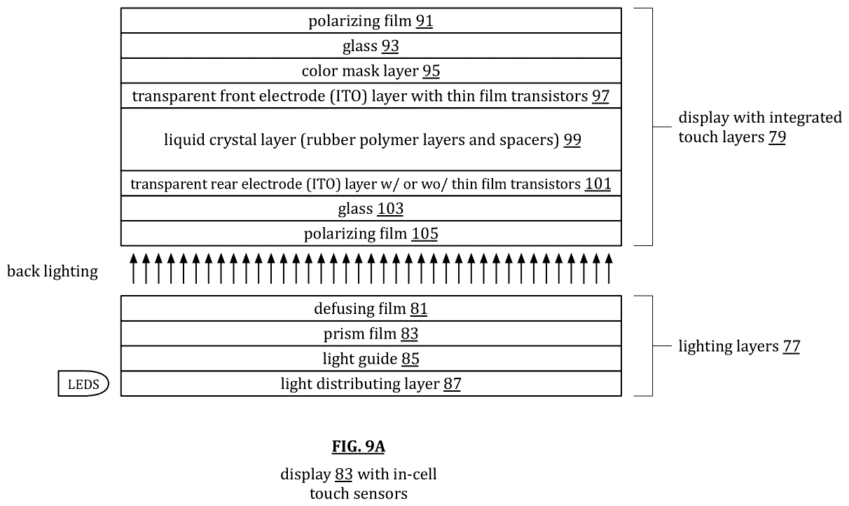

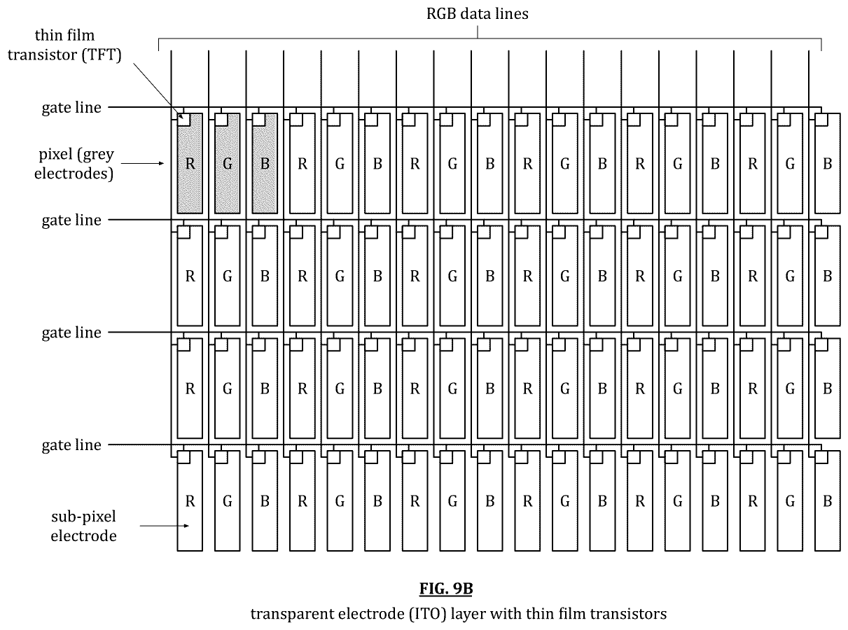

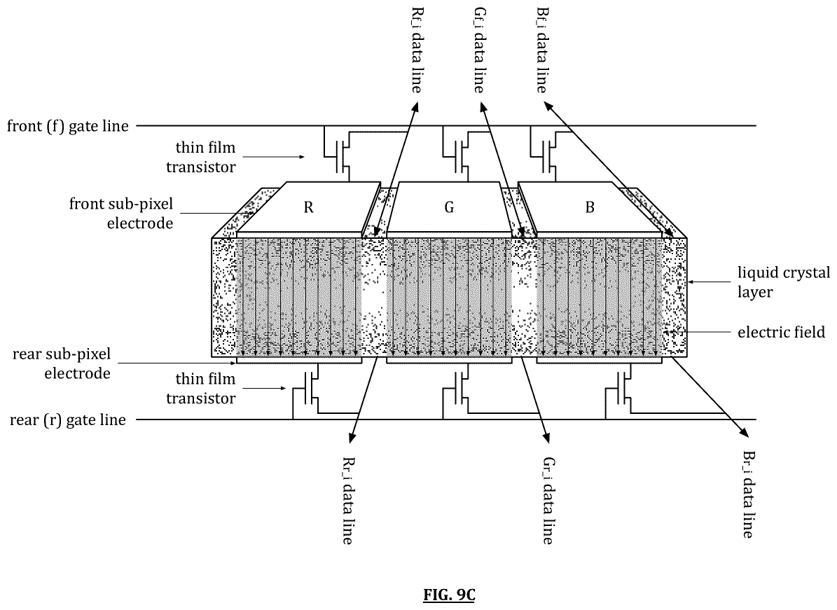

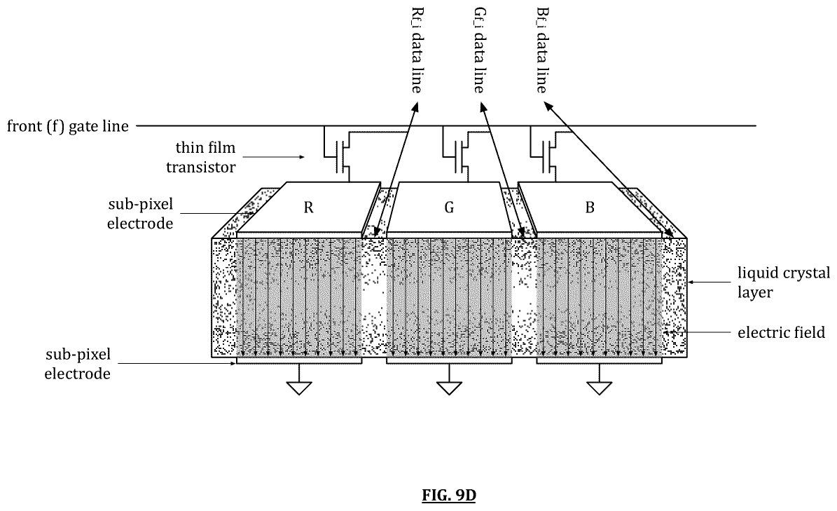

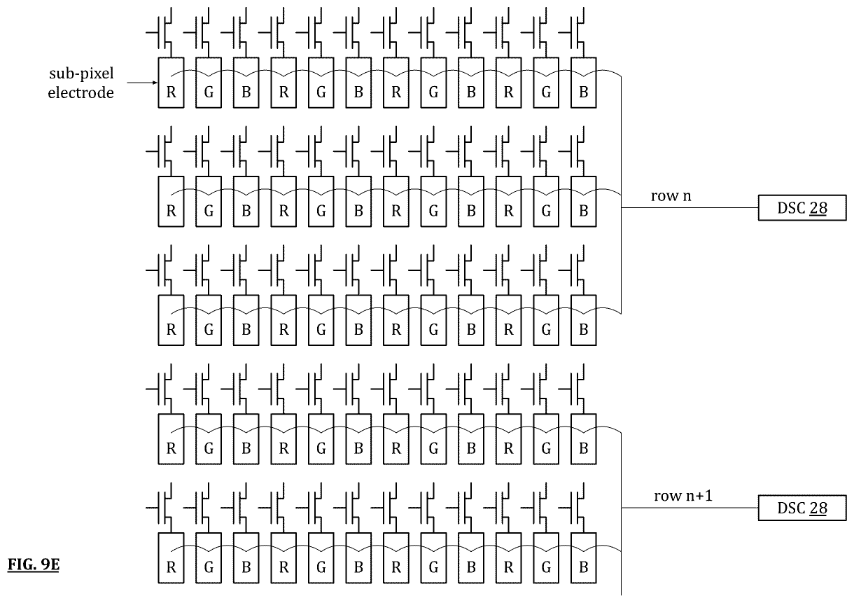

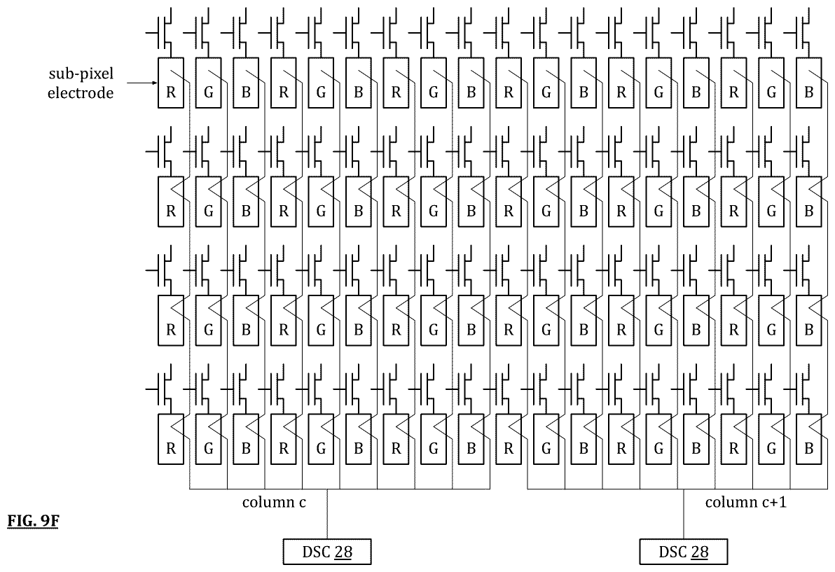

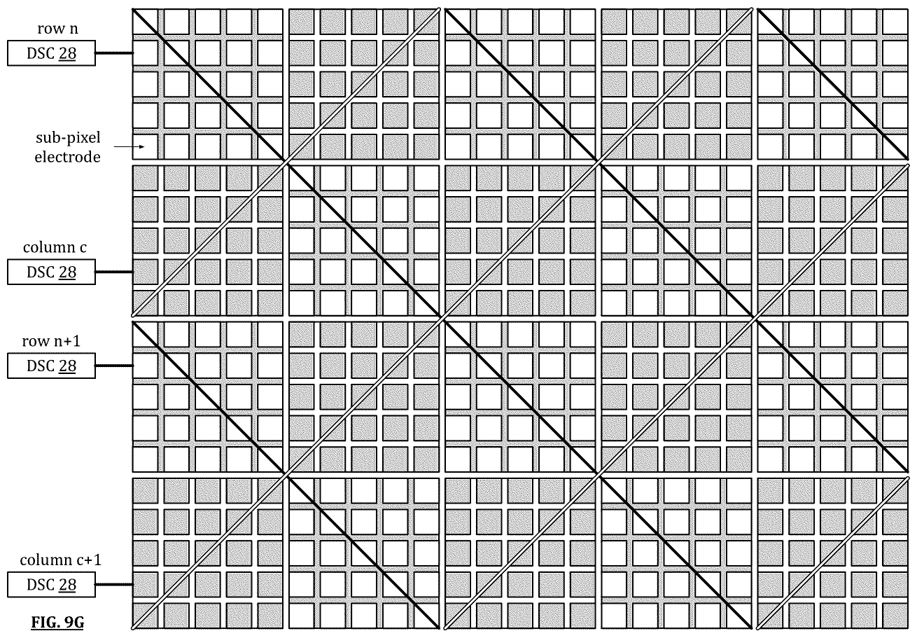

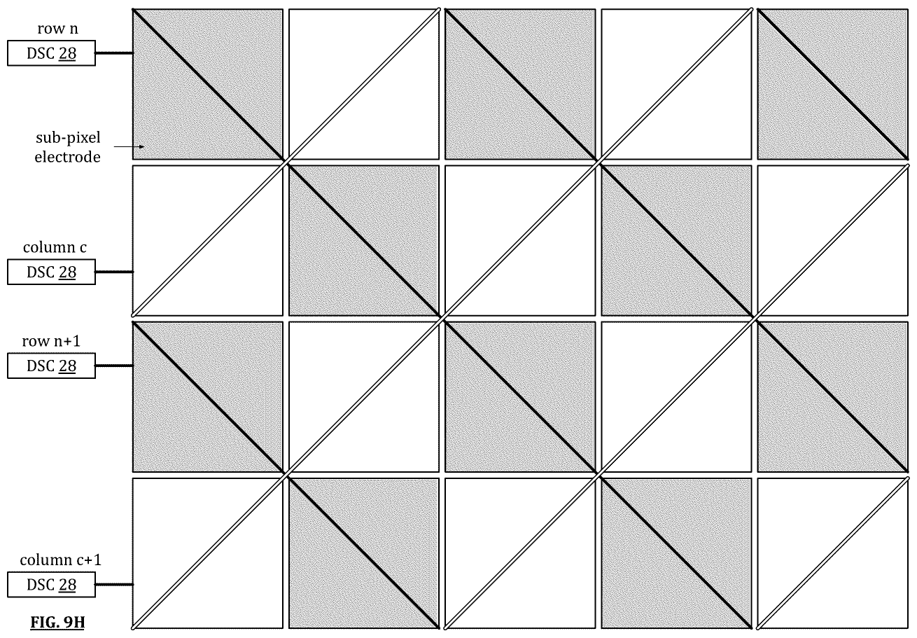

FIG. 1B is a logic diagram of another embodiment of a method for altering the resolution of a touch screen display. This embodiment operates in a similar manner to that of FIG. 1A, with the exception that the row electrodes and column electrodes are essentially fixed in one or more layers of the display area of the touch screen display. Examples of row electrodes and column electrodes that can be formed in such a manner are described more fully below, e.g., with reference to FIGS. 9A-9J.

The method begins at step 25 where, based upon a selected initial touch resolution, a processing module(s) of the touch screen display establishes an initial coupling of the initial row electrodes and column electrodes of the display area to drive-sense circuits via an initial configuration of a switch network. In an example, each of the initial row electrodes and initial column electrodes are independently coupled to a drive-sense circuit. In another example, two or more of the initial row electrodes or initial column electrodes are coupled to a single drive-sense circuit. Examples of such configurations are described in greater detail with reference to FIGS. 65-69.

Next, at step 27, the processing module enables the drive-sense circuits (DSCs) to drive signals on to the plurality of row electrodes and column electrodes. The plurality of row electrodes and column electrodes can include all or a subset(s) of the electrodes of the display area. The method continues at step 29 where the processing module senses, based on the signals, an electrical characteristic of at least one row electrode and at least one column electrode to determine a touch(es) as generally described above.

The method continues at step 31 where the processing module determines whether to alter the touch resolution of the touch display. The determination can be based, for example, on the detection of a finger/stylus touch or approaching touch at step 29. If the processing module determines not to alter the initial touch resolution (e.g., no touch is detected), the method repeats at step 27.

If determining to alter the initial touch resolution, the processing module selects an altered touch resolution, and the method continues at step 33. In this step, the processing module utilizes the altered touch resolution to establish an altered coupling of the row electrodes and the column electrodes of the display area to the DSCs via the altered configuration of the switch network. As described more fully below, the altered touch resolution can be the same across all of the display area or can differ in different areas of the display.

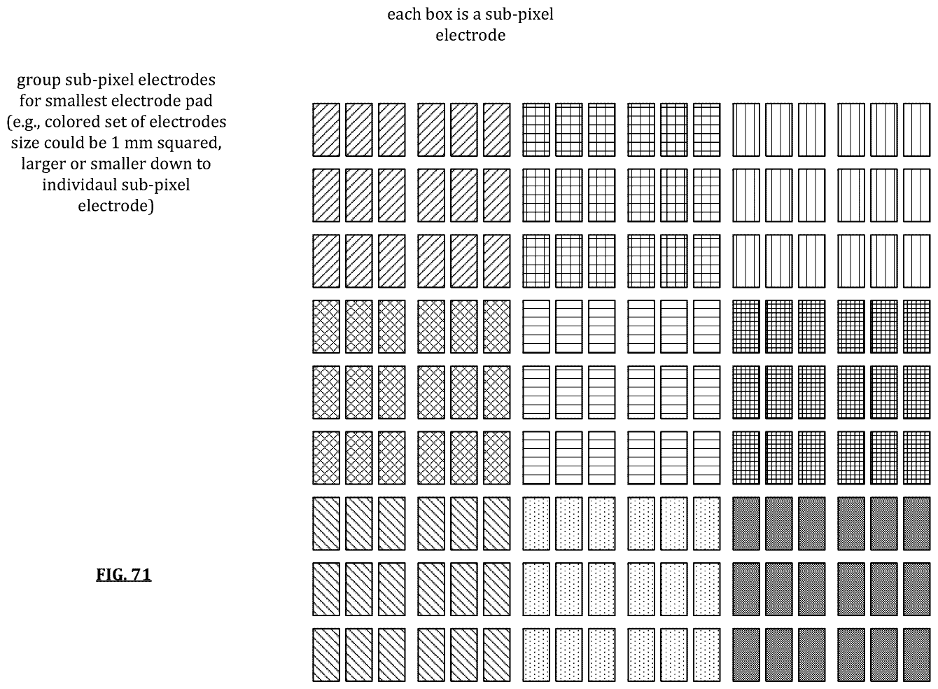

FIG. 1C is a logic diagram of an embodiment of methods for implementation by a switch controller to enact and/or alter the touch resolution of a touch screen display in accordance with the methods of FIGS. 1A and 1B. Operation and construction of an embodiment of a switch controller is described more fully below with reference to the example of FIG. 70.

The illustrated method begins at step 35, where the switch controller interacts with at least one processing unit or processing module to receive input regarding initial settings, displayed frames of data (e.g., touch-related icons on display, text on display, gaming-related items on display, motion of items on display, etc.), detected touch location(s) or other touch relevant information. In response to receiving input regarding initial settings, the method proceeds to step 37 where the switch controller enacts the initial touch screen resolution(s). As previously noted, a uniform initial touch screen resolution can be established for the display area or differing initial touch screen resolutions can be established for different portions of the display area.

Next, at step 39, the switch controller determines switch network settings to enact the initial touch screen resolution(s). The method continues at step 41 where the switch controller enacts the switch network settings to implement the initial touch screen resolution(s). Enacting the switch network settings includes, for example, generating control signals for one or more switch networks that operate to selectively couple row electrodes and column electrodes to DSCs of the touch screen display.

In the illustrated embodiment, the method continues at step 43 where the switch controller determines DSC settings to enact the initial touch screen resolution(s). Such DSC settings can include, for example, selection of appropriate reference voltages/signals for the DSCs such as described with reference to FIG. 70. Next, the method continues at step 45 where the switch controller enacts the DSC settings to implement the initial touch screen resolution(s).

In response to receiving input regarding settings for altering a touch screen resolution, the method proceeds to step 47 where the switch controller enacts the altered touch screen resolution(s). Next, at step 49, the switch controller determines switch network settings to enact the altered touch screen resolution(s). The method continues at step 51 where the switch controller enacts the switch network settings to implement the altered touch screen resolution(s). Similar to step 41, enacting the switch network settings includes, for example, generating control signals for one or more switch networks that operate to selectively couple row electrodes and column electrodes to DSCs of the touch screen display.

In the illustrated embodiment, the method continues at step 53 where the switch controller determines DSC settings to enact the altered touch screen resolution(s). Such DSC settings can include, for example, selection of various reference voltages/signals for the DSCs such as described with reference to FIG. 70. Next, the method continues at step 55 where the switch controller enacts the DSC settings to implement the altered touch screen resolution(s).

FIG. 2 is a schematic block diagram of an embodiment of a computing device 14.

The computing device 14 includes a touch screen 16, a core control module 40, one or more processing modules 42, one or more main memories 44, cache memory 46, a video graphics processing module 48, a display 50, an Input-Output (I/O) peripheral control module 52, one or more input interface modules 56, one or more output interface modules 58, one or more network interface modules 60, and one or more memory interface modules 62. A processing module 42 is described in greater detail at the end of the detailed description of the invention section and, in an alternative embodiment, has a direct connection to the main memory 44. In an alternate embodiment, the core control module 40 and the I/O and/or peripheral control module 52 are one module, such as a chipset, a quick path interconnect (QPI), and/or an ultra-path interconnect (UPI).

The touch screen 16 includes a touch screen display 80, a plurality of sensors 30, a plurality of drive-sense circuits (DSC), one or more switch networks 401 and 403, a switch controller 405, and a touch screen processing module 82. In general, the sensors (e.g., electrodes, capacitor sensing cells, capacitor sensors, inductive sensor, etc.) detect a proximal touch of the screen. Switch controller 405 selects particular sensors to be coupled to particular drive-sense circuits (DSCs) to adjust a touch resolution, sometimes referred to herein as “touch granularity” or simply “granularity,” of all or part of the touch screen display 80. Switch controller 405 can receive information from any or all of the processing modules, and use that information as a basis for selecting sensors/DSC coupling arrangements. Switch controller 405 then transmits control signals to the switch network(s) causing the switch networks to selectively couple the selected sensors to the selected drive sense circuits. For example, when one or more fingers touches the screen, capacitance of sensors proximal to the touch(es) are affected (e.g., impedance changes). The drive-sense circuits (DSC) coupled to the affected sensors detect the change and provide a representation of the change to the touch screen processing module 82, which may be a separate processing module or integrated into the processing module 42. By changing the coupling of sensors to DSCs, a touch resolution of the touch screen display can be changed. By using different coupling arrangements in different areas of the touch screen display, multiple different touch screen resolutions can be realized concurrently in those different areas.

The touch screen processing module 82 processes the representative signals from the drive-sense circuits (DSC) to determine the location of the touch(es). This information is inputted to the processing module 42 for processing as an input. For example, a touch represents a selection of a button on screen, a scroll function, a zoom in-out function, etc.

Each of the main memories 44 includes one or more Random Access Memory (RAM) integrated circuits, or chips. For example, a main memory 44 includes four DDR4 (4^{th} generation of double data rate) RAM chips, each running at a rate of 2,400 MHz. In general, the main memory 44 stores data and operational instructions most relevant for the processing module 42. For example, the core control module 40 coordinates the transfer of data and/or operational instructions from the main memory 44 and the memory 64-66. The data and/or operational instructions retrieved from memory 64-66 are the data and/or operational instructions requested by the processing module or will the instructions most likely be needed by the processing module. When the processing module is done with the data and/or operational instructions in main memory, the core control module 40 coordinates sending updated data to the memory 64-66 for storage.

The memory 64-66 includes one or more hard drives, one or more solid state memory chips, and/or one or more other large capacity storage devices that, in comparison to cache memory and main memory devices, is/are relatively inexpensive with respect to cost per amount of data stored. The memory 64-66 is coupled to the core control module 40 via the I/O and/or peripheral control module 52 and via one or more memory interface modules 62. In an embodiment, the I/O and/or peripheral control module 52 includes one or more Peripheral Component Interface (PCI) buses to which peripheral components connect to the core control module 40. A memory interface module 62 includes a software driver and a hardware connector for coupling a memory device to the I/O and/or peripheral control module 52. For example, a memory interface 62 is in accordance with a Serial Advanced Technology Attachment (SATA) port.

The core control module 40 coordinates data communications between the processing module(s) 42 and the network(s) 26 via the I/O and/or peripheral control module 52, the network interface module(s) 60, and a network card 68 or 70. A network card 68 or 70 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 60 includes a software driver and a hardware connector for coupling the network card to the I/O and/or peripheral control module 52. For example, the network interface module 60 is in accordance with one or more versions of IEEE 802.11, cellular telephone protocols, 10/100/1000 Gigabit LAN protocols, etc.

The core control module 40 coordinates data communications between the processing module(s) 42 and input device(s) 72 via the input interface module(s) 56 and the I/O and/or peripheral control module 52. An input device 72 includes a keypad, a keyboard, control switches, a touchpad, a microphone, a camera, etc. An input interface module 56 includes a software driver and a hardware connector for coupling an input device to the I/O and/or peripheral control module 52. In an embodiment, an input interface module 56 is in accordance with one or more Universal Serial Bus (USB) protocols.

The core control module 40 coordinates data communications between the processing module(s) 42 and output device(s) 74 via the output interface module(s) 58 and the I/O and/or peripheral control module 52. An output device 74 includes a speaker, etc. An output interface module 58 includes a software driver and a hardware connector for coupling an output device to the I/O and/or peripheral control module 52. In an embodiment, an output interface module 56 is in accordance with one or more audio codec protocols.

The processing module 42 communicates directly with a video graphics processing module 48 to display data on the display 50. The display 50 includes an LED (light emitting diode) display, an LCD (liquid crystal display), and/or other type of display technology. The display has a resolution, an aspect ratio, and other features that affect the quality of the display. The video graphics processing module 48 receives data from the processing module 42, processes the data to produce rendered data in accordance with the characteristics of the display, and provides the rendered data to the display 50.

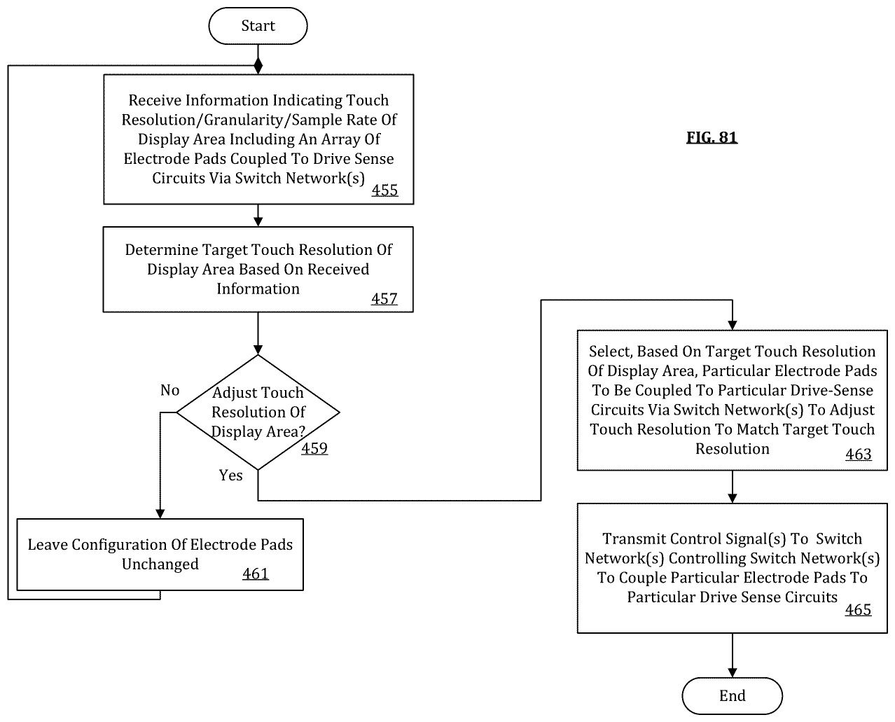

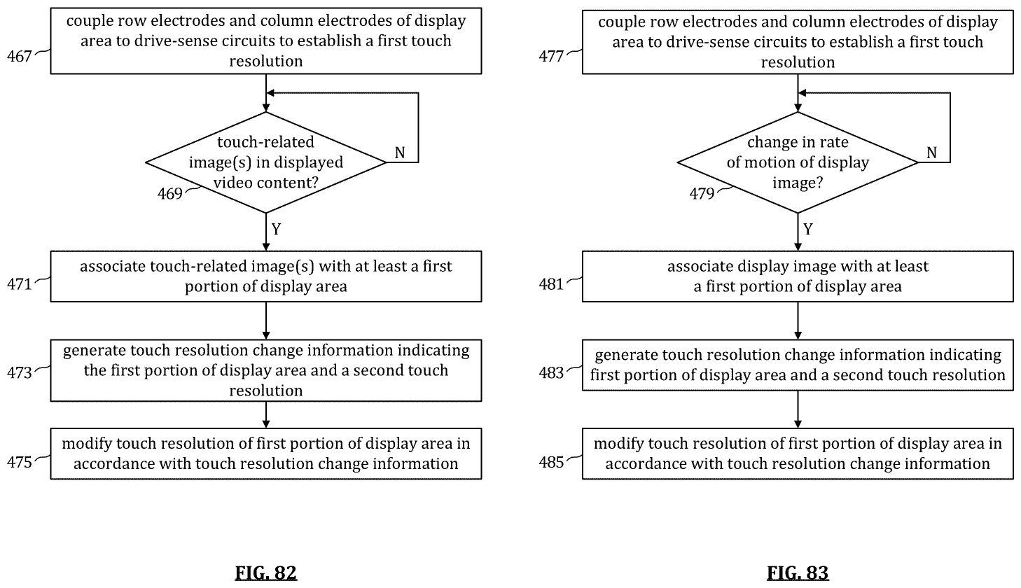

In various embodiments, such as described in conjunction with FIGS. 82 and 83, touch screen processing module 82 can receive touch-related image information, rate of motion information, content meta-data and/or other video content-related information from the video graphics processing module 48.

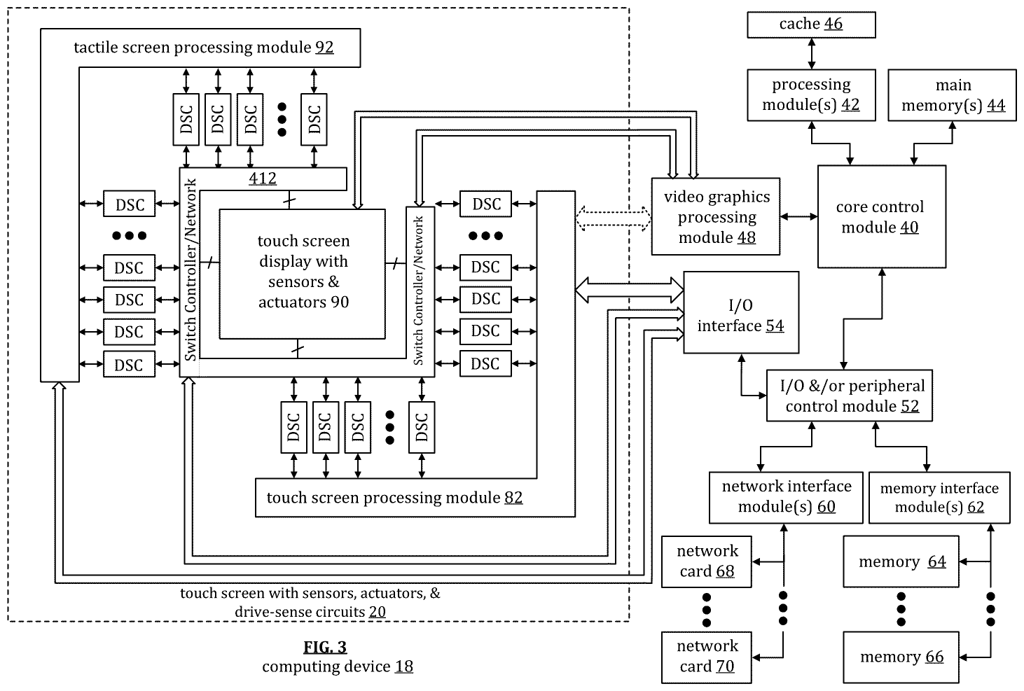

FIG. 3 is a schematic block diagram of another embodiment of a computing device 18 that includes a core control module 40, one or more processing modules 42, one or more main memories 44, cache memory 46, a video graphics processing module 48, a touch and tactile screen 20, an Input-Output (I/O) peripheral control module 52, one or more input interface modules 56, one or more output interface modules 58, one or more network interface modules 60, and one or more memory interface modules 62. The touch and tactile screen 20 includes a touch and tactile screen display 90, a plurality of sensors 30, a plurality of actuators 32, a plurality of drive-sense circuits (DSC), a touch screen processing module 82, a switch controller/network 412, and a tactile screen processing module 92.

Computing device 18 operates similarly to computing device 14 of FIG. 2 with the addition of a tactile aspect to the screen 20 as an output device. The tactile portion of the screen 20 includes the plurality of actuators (e.g., piezoelectric transducers to create vibrations, solenoids to create movement, etc.) to provide a tactile feel to the screen 20. To do so, the processing module creates tactile data, which is provided to the appropriate drive-sense circuits (DSC) via the tactile screen processing module 92, which may be a stand-alone processing module or integrated into processing module 42. The drive-sense circuits (DSC) convert the tactile data into drive-actuate signals and provide them to the appropriate actuators to create the desired tactile feel on the screen 20.

Similar to the combination of switch network 401, switch network 403, and switch controller 405 illustrated as separate devices in FIG. 2, the switch controller/network 412 controls the coupling of sensors to drive-sense circuits (DSCs) to adjust the touch resolution of touch screen display 90. FIG. 3 also illustrates data connections via I/O Interface 54 and video graphics processing module 48 through which switch controller/network 412 can receive information used to determine an arrangement of sensors and DSCs to use for realizing a target resolution of all, or part, of the touch screen display 90. The information provided to switch controller/network 412 can include, but is not limited to, information identifying a characteristics of a program interacting with touch screen display 90, a display location of particular objects, characteristics of a data frame being rendered on touch screen display 90, and the like. Although not specifically illustrated, any illustrated processing module can provide data to switch controller/network 412, either directly or indirectly.

FIG. 4 is a schematic block diagram of an embodiment of a touch screen display 80 that includes a plurality of drive-sense circuits (DSCs), a touch screen processing module 82, a display 83, a switch controller 405, multiple switch networks 401 and 403, and a plurality of electrodes 85. The touch screen display 80 is coupled to a processing module 42, a video graphics processing module 48, and a display interface 73, which are components of a computing device (e.g., 14-18), an interactive display, or other device that includes a touch screen display. An interactive display functions to provide users with an interactive experience (e.g., touch the screen to obtain information, command actions to be initiated remotely, provide process initiation, termination, and control, be entertained, etc.). For example, a store provides interactive displays for customers to find certain products, to obtain coupons, to enter contests, etc.

There are a variety of other devices that include a touch screen display. For example, a vending machine includes a touch screen display to select and/or pay for an item. As another example of a device having a touch screen display is an Automated Teller Machine (ATM). As yet another example, an automobile includes a touch screen display for entertainment media control, navigation, climate control, etc.

In various implementations, the touch screen display 80 includes can include a large display 83 that has a resolution equal to or greater than full high-definition (HD), an aspect ratio of a set of aspect ratios, and a screen size equal to or greater than thirty-two inches. The following table lists various combinations of resolution, aspect ratio, and screen size for the display 83, but the table is not an exhaustive list.

| | Width | Height | pixel aspect | screen | |
|---|---|---|---|---|---|
| Resolution | (lines) | (lines) | ratio | aspect ratio | screen size (inches) |
| HD (high | 1280 | 720 | 1:1 | 16:9 | 32, 40, 43, 50, 55, 60, 65, |
| definition) | | | | | 70, 75, &/or >80 |
| Full HD | 1920 | 1080 | 1:1 | 16:9 | 32, 40, 43, 50, 55, 60, 65, |
| | | | | | 70, 75, &/or >80 |
| HD | 960 | 720 | 4:3 | 16:9 | 32, 40, 43, 50, 55, 60, 65, |
| | | | | | 70, 75, &/or >80 |
| HD | 1440 | 1080 | 4:3 | 16:9 | 32, 40, 43, 50, 55, 60, 65, |
| | | | | | 70, 75, &/or >80 |
| HD | 1280 | 1080 | 3:2 | 16:9 | 32, 40, 43, 50, 55, 60, 65, |
| | | | | | 70, 75, &/or >80 |
| QHD (quad | 2560 | 1440 | 1:1 | 16:9 | 32, 40, 43, 50, 55, 60, 65, |
| HD) | | | | | 70, 75, &/or >80 |
| UHD (Ultra | 3840 | 2160 | 1:1 | 16:9 | 32, 40, 43, 50, 55, 60, 65, |
| HD) or 4K | | | | | 70, 75, &/or >80 |
| 8K | 7680 | 4320 | 1:1 | 16:9 | 32, 40, 43, 50, 55, 60, 65, |
| | | | | | 70, 75, &/or >80 |
| HD and | 1280->=7680 | 720->=4320 | 1:1, 2:3, etc. | 2:3 | 50, 55, 60, 65, 70, 75, |
| above | | | | | &/or >80 |

In other implementations, display 83 can be a smaller display, such as those included in handheld devices such as remote controls, smart phones, and the like, wearable devices, such as those intended to be worn on a user's wrist or other appendage, and the like.

The display 83 is one of a variety of types of displays that is operable to render frames of data into visible images. For example, the display is one or more of: a light emitting diode (LED) display, an electroluminescent display (ELD), a plasma display panel (PDP), a liquid crystal display (LCD), an LCD high performance addressing (HPA) display, an LCD thin film transistor (TFT) display, an organic light emitting diode (OLED) display, a digital light processing (DLP) display, a surface conductive electron emitter (SED) display, a field emission display (FED), a laser TV display, a carbon nanotubes display, a quantum dot display, an interferometric modulator display (IMOD), and a digital microshutter display (DMS). The display is active in a full display mode or a multiplexed display mode (i.e., only part of the display is active at a time).

The display 83 further includes integrated electrodes 85 that provide the sensors for the touch sense part of the touch screen display. The electrodes 85 are distributed throughout the display area or where touch screen functionality is desired. For example, a first group of the electrodes are arranged in rows and a second group of electrodes are arranged in columns. As will be discussed in greater detail with reference to one or more of FIGS. 9-12, the row electrodes are separated from the column electrodes by a dielectric material.

The electrodes 85 are comprised of a transparent conductive material and are in-cell or on-cell with respect to layers of the display. For example, a conductive trace is placed in-cell or on-cell of a layer of the touch screen display. The transparent conductive material, which is substantially transparent and has negligible effect on video quality of the display with respect to the human eye. For instance, an electrode is constructed from one or more of: Indium Tin Oxide, Graphene, Carbon Nanotubes, Thin Metal Films, Silver Nanowires Hybrid Materials, Aluminum-doped Zinc Oxide (AZO), Amorphous Indium-Zinc Oxide, Gallium-doped Zinc Oxide (GZO), and poly polystyrene sulfonate (PEDOT).

In an example of operation, the processing module 42 is executing an operating system 89 and one or more user applications 75. The user application 75 includes, but is not limited to, a video playback application, a spreadsheet application, a word processing application, a computer aided drawing application, a photo display application, an image processing application, a database application, etc. While executing an application 75, the processing module generates data for display (e.g., video data, image data, text data, etc.). The processing module 42 sends the data to the video graphics processing module 48, which converts the data into frames of video 87.

The video graphics processing module 48 sends the frames of video 87 (e.g., frames of a video file, refresh rate for a word processing document, a series of images, etc.) to the display interface 73. The display interface 73 provides the frames of video to the display 83, which renders the frames of video into visible images.

While the display 83 is rendering the frames of video into visible images, the drive-sense circuits (DSC) provide sensor signals to the electrodes 85. When the screen is touched, capacitance of the electrodes 85 proximal to the touch (i.e., directly or close by) is changed. The DSCs detect the capacitance change for effected electrodes and provide the detected change to the touch screen processing module 82.

The touch screen processing module 82 processes the capacitance change of the effected electrodes to determine one or more specific locations of touch and provides this information to the processing module 42. Processing module 42 processes the one or more specific locations of touch to determine if an operation of the application is to be altered. For example, the touch is indicative of a pause command, a fast forward command, a reverse command, an increase volume command, a decrease volume command, a stop command, a select command, a delete command, etc.

Regardless of the exact size of the touch screen display 80, switch controller 405 can be used to control the connection of particular electrodes 85 to particular DSCs so that a touch resolution of touch screen display 80 can be adjusted to a target touch resolution. For example, in a top portion of the screen, a ratio of three row electrodes per DSC can be used to achieve a first touch resolution, while in a bottom portion of the screen a ratio of one row electrode per DSC can be used to achieve a second touch resolution. Similarly, different numbers of column electrodes coupled to each DSC can be used to establish different resolutions in right and left portions of the screen. In various embodiments, different sub-electrodes (not illustrated) are combined to make a single electrode 85. In some such embodiments, switch controller 405 can select particular sub electrodes to be included in any particular electrode 85, and use switch network 401 to couple those electrodes to each other, and to particular DSCs, leaving unselected sub-electrodes unused.

In some embodiments, switch controller 405 receives information from processing module 42 specifying a particular target touch resolution for one or more areas of touch screen display 80. In other embodiments the switch controller 405 determines a target touch resolution based on information received from processing module 42 or some other processing module. In some implementations, information received by switch controller 405 can include a resolution delta, specifying a magnitude and direction of a change between a current touch resolution and a target touch resolution. In other implementations, the received information can include an application type identifier; application touch resolution parameters; a display object identifier; a display object location; frame characteristics or frame identification information (e.g. whether a frame being rendered is an Intra frame (I-frames), predicted frames that are based on previous reference frames (P-frames), bi-directionally predicted using preceding and frames that follow (B-Frames) or DC frames (basic block reference levels); or other information sufficient to allow switch controller 405 to determine a target resolution of one or more areas of touch screen display 80.

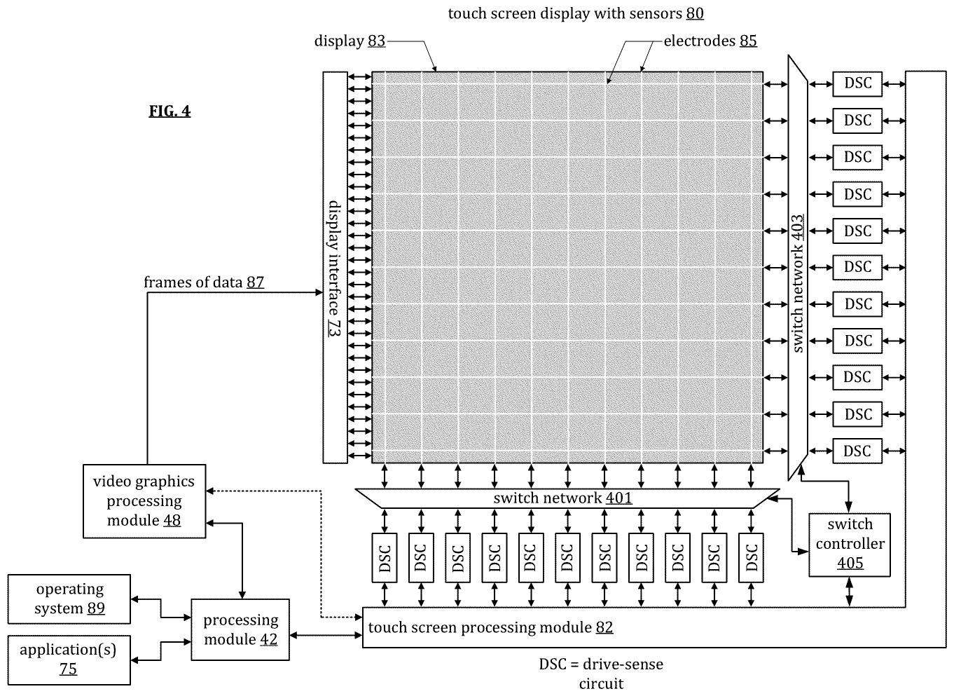

FIG. 5 is a schematic block diagram of another embodiment of a touch screen display 80 that includes a plurality of drive-sense circuits (DSC), the processing module 42, a display 83, and a plurality of electrodes 85. The processing module 42 is executing an operating system 89 and one or more user applications 75 to produce frames of data 87. The processing module 42 provides the frames of data 87 to the display interface 73. The touch screen display 80 operates similarly to the touch screen display 80 of FIG. 4 with the above noted differences.

FIG. 6 is a logic diagram of an embodiment of a method for sensing a touch on a touch screen display that is executed by one or more processing modules (e.g., 42, 82, and/or 48 of the previous figures). The method begins at step 100 where the processing module generates a control signal (e.g., power enable, operation enable, etc.) to enable a drive-sense circuit to monitor the sensor signal on the electrode. The processing module generates additional control signals to enable other drive-sense circuits to monitor their respective sensor signals. In an example, the processing module enables all of the drive-sense circuits for continuous sensing for touches of the screen. In another example, the processing module enables a first group of drive-sense circuits coupled to a first group of row electrodes and enables a second group of drive-sense circuits coupled to a second group of column electrodes.

The method continues at step 102 where the processing module receives a representation of the impedance on the electrode from a drive-sense circuit. In general, the drive-sense circuit provides a drive signal to the electrode. The impedance of the electrode affects the drive signal. The effect on the drive signal is interpreted by the drive-sense circuit to produce the representation of the impedance of the electrode. The processing module does this with each activated drive-sense circuit in serial, in parallel, or in a serial-parallel manner.

The method continues at step 104 where the processing module interprets the representation of the impedance on the electrode to detect a change in the impedance of the electrode. A change in the impedance is indicative of a touch. For example, an increase in self-capacitance (e.g., the capacitance of the electrode with respect to a reference (e.g., ground, etc.)) is indicative of a touch on the electrode. As another example, a decrease in mutual capacitance (e.g., the capacitance between a row electrode and a column electrode) is also indicative of a touch near the electrodes. The processing module does this for each representation of the impedance of the electrode it receives. Note that the representation of the impedance is a digital value, an analog signal, an impedance value, and/or any other analog or digital way of representing a sensor's impedance.

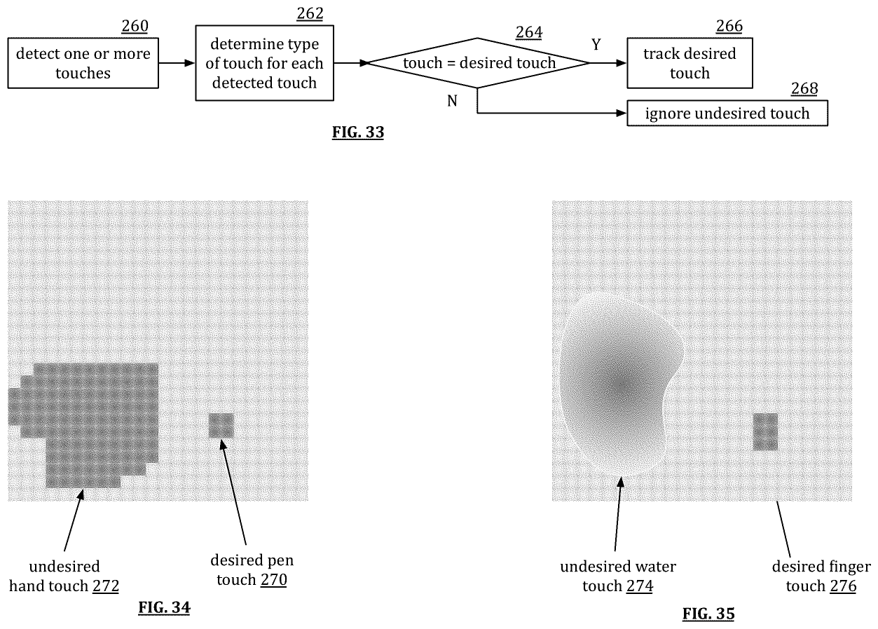

The method continues at step 106 where the processing module interprets the change in the impedance to indicate a touch of the touch screen display in an area corresponding to the electrode. For each change in impedance detected, the processing module indicates a touch. Further processing may be done to determine if the touch is a desired touch or an undesired touch. Such further processing will be discussed in greater detail with reference to one or more of FIGS. 33-35.

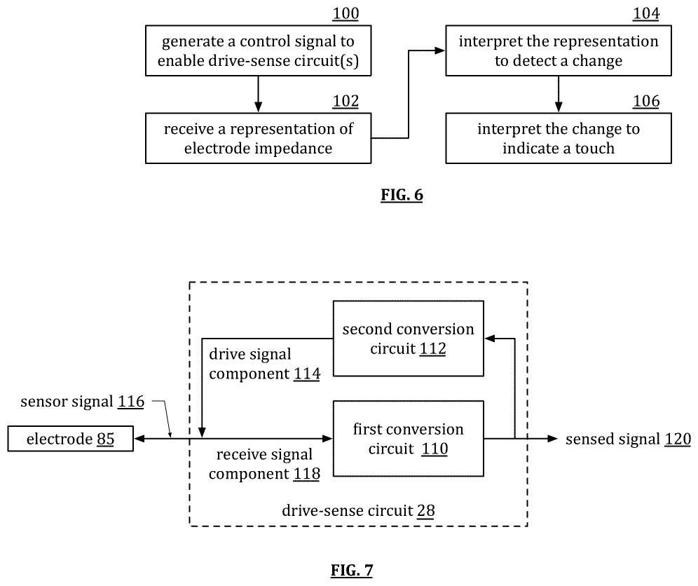

FIG. 7 is a schematic block diagram of an embodiment of a drive sense circuit 28 that includes a first conversion circuit 110 and a second conversion circuit 112. The first conversion circuit 110 converts a sensor signal 116 into a sensed signal 120. The second conversion circuit 112 generates the drive signal component 114 from the sensed signal 112. As an example, the first conversion circuit 110 functions to keep the sensor signal 116 substantially constant (e.g., substantially matching a reference signal) by creating the sensed signal 120 to correspond to changes in a receive signal component 118 of the sensor signal. The second conversion circuit 112 functions to generate a drive signal component 114 of the sensor signal based on the sensed signal 120 to substantially compensate for changes in the receive signal component 118 such that the sensor signal 116 remains substantially constant.

In an example, the drive signal 116 is provided to the electrode 85 as a regulated current signal. The regulated current (I) signal in combination with the impedance (Z) of the electrode creates an electrode voltage (V), where V=I*Z. As the impedance (Z) of electrode changes, the regulated current (I) signal is adjusted to keep the electrode voltage (V) substantially unchanged. To regulate the current signal, the first conversion circuit 110 adjusts the sensed signal 120 based on the receive signal component 118, which is indicative of the impedance of the electrode and change thereof. The second conversion circuit 112 adjusts the regulated current based on the changes to the sensed signal 120.

As another example, the drive signal 116 is provided to the electrode 85 as a regulated voltage signal. The regulated voltage (V) signal in combination with the impedance (Z) of the electrode creates an electrode current (I), where I=V/Z. As the impedance (Z) of electrode changes, the regulated voltage (V) signal is adjusted to keep the electrode current (I) substantially unchanged. To regulate the voltage signal, the first conversion circuit 110 adjusts the sensed signal 120 based on the receive signal component 118, which is indicative of the impedance of the electrode and change thereof. The second conversion circuit 112 adjusts the regulated voltage based on the changes to the sensed signal 120.

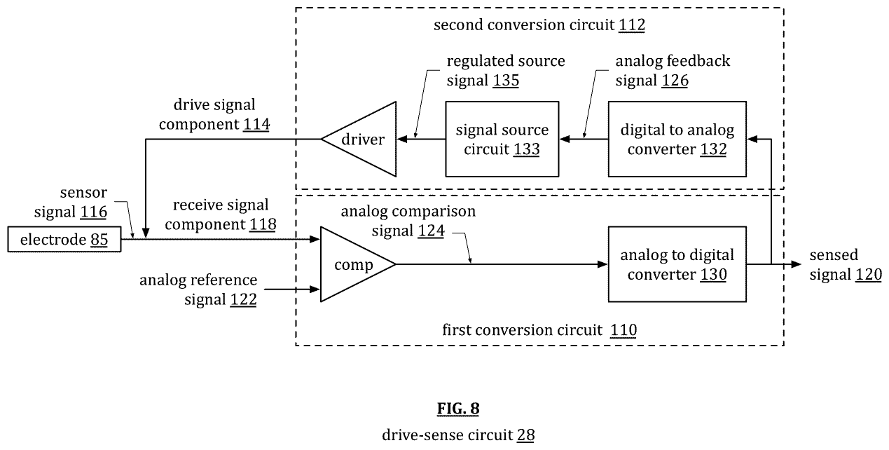

FIG. 8 is a schematic block diagram of another embodiment of a drive sense circuit 28 that includes a first conversion circuit 110 and a second conversion circuit 112. The first conversion circuit 110 includes a comparator (comp) and an analog to digital converter 130. The second conversion circuit 112 includes a digital to analog converter 132, a signal source circuit 133, and a driver.

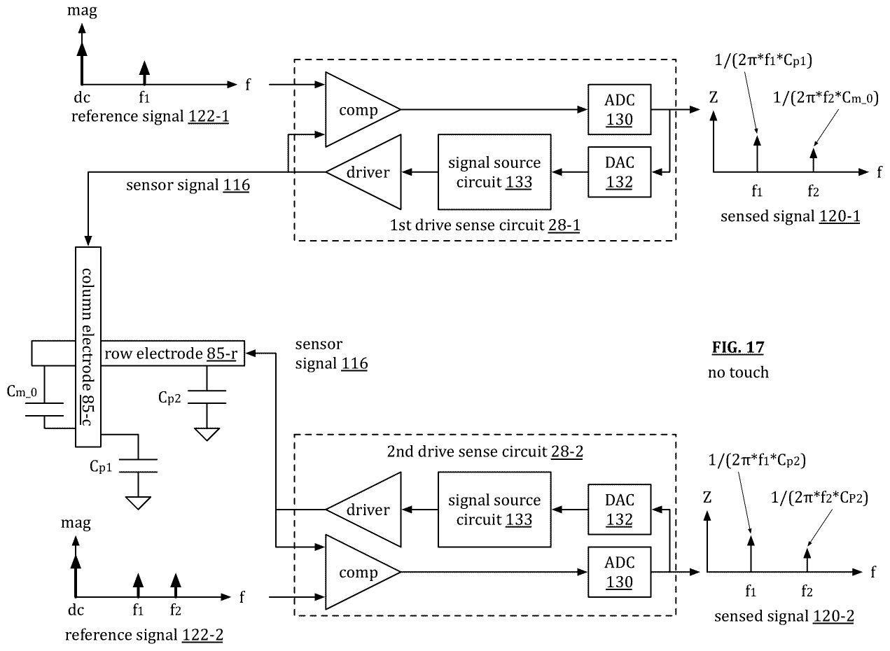

In an example of operation, the comparator compares the sensor signal 116 to an analog reference signal 122 to produce an analog comparison signal 124. The analog reference signal 124 includes a DC component and an oscillating component. As such, the sensor signal 116 will have a substantially matching DC component and oscillating component. An example of an analog reference signal 122 will be described in greater detail with reference to FIG. 15.

The analog to digital converter 130 converts the analog comparison signal 124 into the sensed signal 120. The analog to digital converter (ADC) 130 may be implemented in a variety of ways. For example, the (ADC) 130 is one of: a flash ADC, a successive approximation ADC, a ramp-compare ADC, a Wilkinson ADC, an integrating ADC, a delta encoded ADC, and/or a sigma-delta ADC. The digital to analog converter (DAC) 214 may be a sigma-delta DAC, a pulse width modulator DAC, a binary weighted DAC, a successive approximation DAC, and/or a thermometer-coded DAC.

The digital to analog converter (DAC) 132 converts the sensed signal 120 into an analog feedback signal 126. The signal source circuit 133 (e.g., a dependent current source, a linear regulator, a DC-DC power supply, etc.) generates a regulated source signal 135 (e.g., a regulated current signal or a regulated voltage signal) based on the analog feedback signal 126. The driver increases power of the regulated source signal 135 to produce the drive signal component 114.

FIG. 9A is a cross section schematic block diagram of an example of a touch screen display 83 with in-cell touch sensors, which includes lighting layers 77 and display with integrated touch sensing layers 79. The lighting layers 77 include a light distributing layer 87, a light guide layer 85, a prism film layer 83, and a defusing film layer 81. The display with integrated touch sensing layers 79 include a rear polarizing film layer 105, a glass layer 103, a rear transparent electrode layer with thin film transistors 101 (which may be two or more separate layers), a liquid crystal layer (e.g., a rubber polymer layer with spacers) 99, a front electrode layer with thin film transistors 97, a color mask layer 95, a glass layer 93, and a front polarizing film layer 91. Note that one or more protective layers may be applied over the polarizing film layer 91.

In an example of operation, a row of LEDs (light emitted diodes) projects light into the light distributing player 87, which projects the light towards the light guide 85. The light guide includes a plurality of holes that lets some light components pass at differing angles. The prism film layer 83 increases perpendicularity of the light components, which are then defused by the defusing film layer 81 to provide a substantially even back lighting for the display with integrated touch sense layers 79.

The two polarizing film layers 105 and 91 are orientated to block the light (i.e., provide black light). The front and rear electrode layers 97 and 101 provide an electric field at a sub-pixel level to orientate liquid crystals in the liquid crystal layer 99 to twist the light. When the electric field is off, or is very low, the liquid crystals are orientated in a first manner (e.g., end-to-end) that does not twist the light, thus, for the sub-pixel, the two polarizing film layers 105 and 91 are blocking the light. As the electric field is increased, the orientation of the liquid crystals change such that the two polarizing film layers 105 and 91 pass the light (e.g., white light). When the liquid crystals are in a second orientation (e.g., side by side), intensity of the light is at its highest point.

The color mask layer 95 includes three sub-pixel color masks (red, green, and blue) for each pixel of the display, which includes a plurality of pixels (e.g., 1440×1080). As the electric field produced by electrodes change the orientations of the liquid crystals at the sub-pixel level, the light is twisted to produce varying sub-pixel brightness. The sub-pixel light passes through its corresponding sub-pixel color mask to produce a color component for the pixel. The varying brightness of the three sub-pixel colors (red, green, and blue), collectively produce a single color to the human eye. For example, a blue shirt has a 12% red component, a 20% green component, and 55% blue component.

The in-cell touch sense functionality uses the existing layers of the display layers 79 to provide capacitance-based sensors. For instance, one or more of the transparent front and rear electrode layers 97 and 101 are used to provide row electrodes and column electrodes. Various examples of creating row and column electrodes from one or more of the transparent front and rear electrode layers 97 and 101 is discussed in some of the subsequent figures.

FIG. 9B is a schematic block diagram of an example of a transparent electrode layer 97 and/or 101 with thin film transistors (TFT). Sub-pixel electrodes are formed on the transparent electrode layer and each sub-pixel electrode is coupled to a thin film transistor (TFT). Three sub-pixels (R-red, G-green, and B-blue) form a pixel. The gates of the TFTs associated with a row of sub-electrodes are coupled to a common gate line. In this example, each of the four rows has its own gate line. The drains (or sources) of the TFTs associated with a column of sub-electrodes are coupled to a common R, B, or G data line. The sources (or drains) of the TFTs are coupled to its corresponding sub-electrode.

In an example of operation, one gate line is activated at a time and RGB data for each pixel of the corresponding row is placed on the RGB data lines. At the next time interval, another gate line is activated and the RGB data for the pixels of that row is placed on the RGB data lines. For 1080 rows and a refresh rate of 60 Hz, each row is activated for about 15 microseconds each time it is activated, which is 60 times per second. When the sub-pixels of a row are not activated, the liquid crystal layer holds at least some of the charge to keep an orientation of the liquid crystals.

FIG. 9C is a schematic block diagram of an example of a pixel with three sub-pixels (R-red, G-green, and B-blue). In this example, the front sub-pixel electrodes are formed in the front transparent conductor layer 97 and the rear sub-pixel electrodes are formed in the rear transparent conductor layer 101. Each front and rear sub-pixel electrode is coupled to a corresponding thin film transistor. The thin film transistors coupled to the top sub-pixel electrodes are coupled to a front (f) gate line and to front R, G, and B data lines. The thin film transistors coupled to the bottom sub-pixel electrodes are coupled to a rear (f) gate line and to rear R, G, and B data lines.

To create an electric field between related sub-pixel electrodes, a differential gate signal is applied to the front and rear gate lines and differential R, G, and B data signals are applied to the front and rear R, G, and B data lines. For example, for the red (R) sub-pixel, the thin film transistors are activated by the signal on the gate lines. The electric field created by the red sub-pixel electrodes is depending on the front and rear Red data signals. As a specific example, a large differential voltage creates a large electric field, which twists the light towards maximum light passing and increases the red component of the pixel.

The gate lines and data lines are non-transparent wires (e.g., copper) that are positioned between the sub-pixel electrodes such that they are hidden from human sight. The non-transparent wires may be on the same layer as the sub-pixel electrodes or on different layers and coupled using vias.

FIG. 9D is a schematic block diagram of another example of a pixel with three sub-pixels (R-red, G-green, and B-blue). In this example, the front sub-pixel electrodes are formed in the front transparent conductor layer 97 and the rear sub-pixel electrodes are formed in the rear transparent conductor layer 101. Each front sub-pixel electrode is coupled to a corresponding thin film transistor. The thin film transistors coupled to the top sub-pixel electrodes are coupled to a front (f) gate line and to front R, G, and B data lines. Each rear sub-pixel electrode is coupled to a common voltage reference (e.g., ground, which may be a common ground plane or a segmented common ground plane (e.g., separate ground planes coupled together to form a common ground plane)).

To create an electric field between related sub-pixel electrodes, a single-ended gate signal is applied to the front gate lines and a single-ended R, G, and B data signals are applied to the front R, G, and B data lines. For example, for the red (R) sub-pixel, the thin film transistors are activated by the signal on the gate lines. The electric field created by the red sub-pixel electrodes is depending on the front Red data signals.

FIG. 9E is a schematic block diagram of an example of sub-pixel electrodes of the front or back electrode layer 97 or 101 coupled together to form row electrodes of a touch screen sensor. In this example, 3 rows of sub-pixel electrodes are coupled together by conductors (e.g., wires, metal traces, vias, etc.) to form one row electrode, which is coupled to a drive sense circuit (DSC) 28. More or less rows of sub-pixel electrodes may be coupled together to form a row electrode.

FIG. 9F is a schematic block diagram of an example of sub-pixel electrodes front or back electrode layer 97 or 101 coupled together to form column electrodes of a touch screen sensor. In this example, 9 columns of sub-pixel electrodes are coupled together by conductors (e.g., wires, metal traces, vias, etc.) to form one column electrode, which is coupled to a drive sense circuit (DSC) 28. More or less columns of sub-pixel electrodes may be coupled together to form a column electrode.

With respect to FIGS. 9E and 9F, the row electrodes may be formed on one of the transparent conductor layers 97 or 101 and the column electrodes are formed on the other. In this instance, differential signaling is used for display functionality of sub-pixel electrodes and a common mode voltage is used for touch sensing on the row and column electrodes. This allows for concurrent display and touch sensing operations with negligible adverse effect on display operation.

FIG. 9G is a schematic block diagram of an example of sub-pixel electrodes coupled together to form row electrodes and column electrodes of a touch screen sensor on one of the transparent conductive layers 97 or 101. In this example, 5×5 sub-pixel electrodes are coupled together to form a square (or diamond, depending on orientation), or other geometric shape. The 5 by 5 squares are then cross coupled together to form a row electrode or a column electrode.

In this example, white sub-pixel sub-electrodes with a grey background are grouped to form a row electrode for touch sensing and the grey sub-pixels with the white background are grouped to form a column electrode. Each row electrode and column electrode is coupled to a drive sense circuit (DSC) 28. As shown, the row and column electrodes for touch sensing are diagonal. Note that the geometric shape of the row and column electrodes may be of a different configuration (e.g., zig-zag pattern, lines, etc.) and that the number of sub-pixel electrodes per square (or other shape) may include more or less than 25.

FIG. 9H is a schematic block diagram of an example of a segmented common ground plane forming row electrodes and column electrodes of a touch screen sensor on the rear transparent conductive layer 101. In this instance, each square (or other shape) corresponds to a segment of a common ground plane that services a group of sub-pixel electrodes on the front transparent layer 97. The squares (or other shape) are coupled together to form row electrodes and column electrodes. The white segmented common ground planes are coupled together to form column electrodes and the grey segmented common ground planes are coupled together to form row electrodes. By implementing the on-cell touch screen row and column electrodes in the common ground plane, display and touch sense functionalities may be concurrently executed with negligible adverse effects on the display functionality.

FIG. 9I is a schematic block diagram of another example of sub-pixel electrodes coupled together to form row and column electrodes of a touch screen sensor. In this example, a sub-pixel is represented as a capacitor, with the top plate being implemented in the front ITO layer 97 and the bottom plate being implemented in the back ITO layer 101, which is implemented as a common ground plan. The thin film transistors are represented as switches. In this example, 3×3 sub-pixel electrodes on the rear ITO layer are coupled together to form a portion of a row electrode for touch sensing or a column electrode for touch sensing. With each of the drive sense circuits 28 injecting a common signal for self-capacitance sensing, the common signal has negligible adverse effects on the display operation of the sub-pixels.

FIG. 9J is a cross section schematic block diagram of an example of a touch screen display 83-1 with on-cell touch sensors, which includes lighting layers 77 and display with integrated touch sensing layers 79. The lighting layers 77 include a light distributing layer 87, a light guide layer 85, a prism film layer 83, and a defusing film layer 81. The display with integrated touch sensing layers 79 include a rear polarizing film layer 105, a glass layer 103, a rear transparent electrode layer with thin film transistors 101 (which may be two or more separate layers), a liquid crystal layer (e.g., a rubber polymer layer with spacers) 99, a front electrode layer with thin film transistors 97, a color mask layer 95, a glass layer 93, a transparent touch layer 107, and a front polarizing film layer 91. Note that one or more protective layers may be applied over the polarizing film layer 91.

The lighting layer 77 and the display with integrated touch sensing layer 79-1 function as described with reference to FIG. 9A for generating a display. A difference lies in how on-cell touch sensing of this embodiment in comparison to the in-cell touch sensing of FIG. 9A. In particular, this embodiment includes an extra transparent conductive layer 107 to provide, or assist, with capacitive-based touch sensing. For example, the extra transparent conductive layer 107 includes row and column electrodes as shown in FIG. 9H. As another example, the extra transparent conductive layer 107 includes row electrodes or column electrodes and another one of the conductive layers 97 or 101 includes the other electrodes (e.g., column electrodes if the extra transparent layer includes row electrodes).

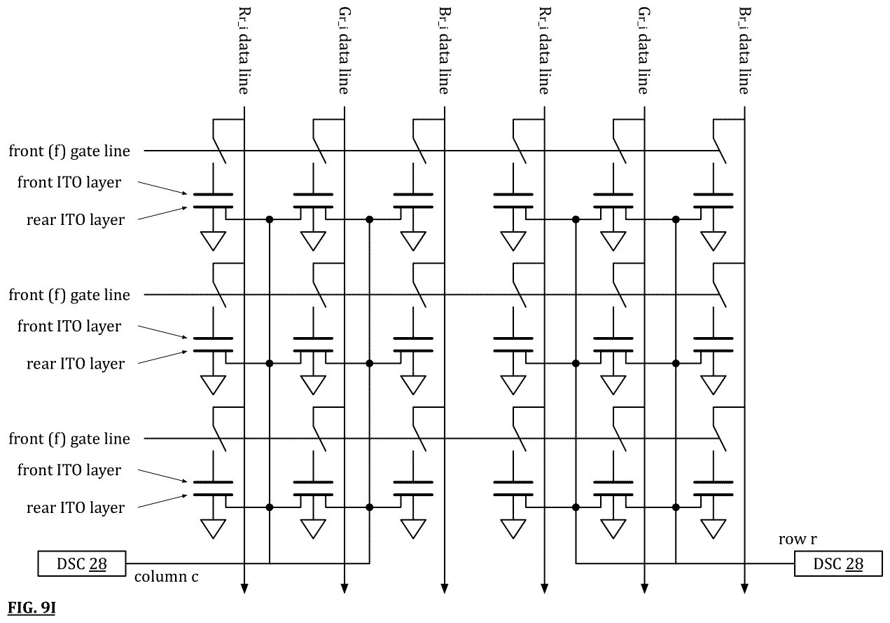

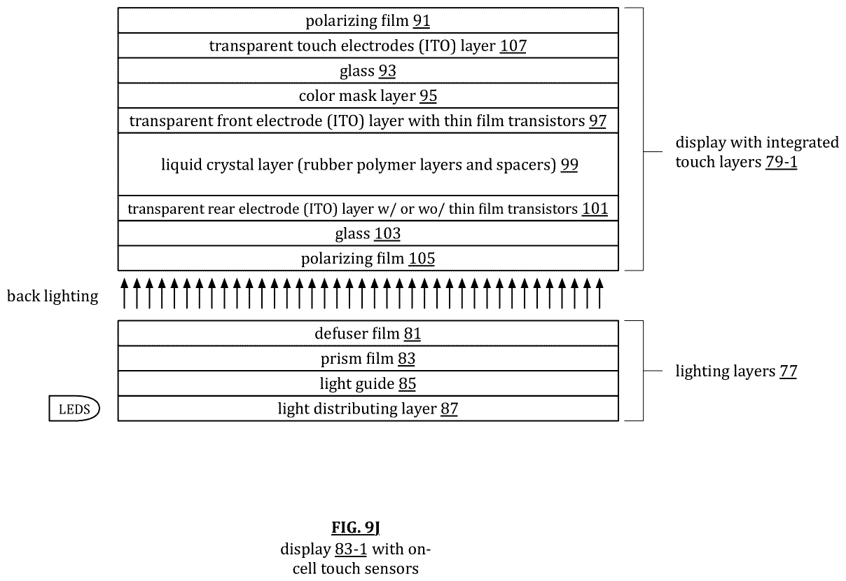

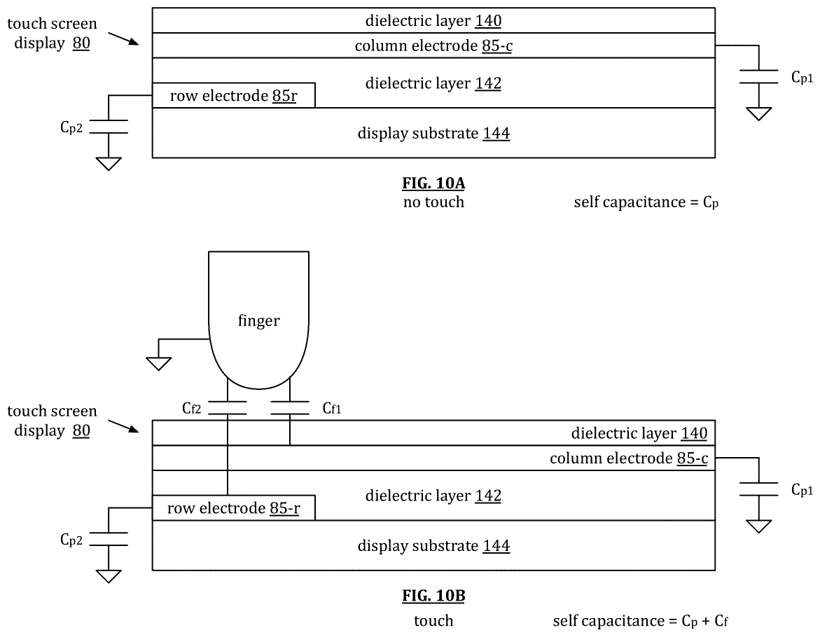

FIG. 10A is a cross section schematic block diagram of a touch screen display 80 without a touch of a finger or a pen. The cross section is taken parallel to a column electrode 85-c and a perpendicular to a row electrode 85-r. The column electrode 85-c is positioned between two dielectric layers 140 and 142. Alternatively, the column electrode 85-c is in the second dielectric layer 142. The row electrode 85-r is positioned in the second dielectric layer 142. Alternatively, the row electrode 85-r is positioned between the dielectric layer 142 and the display substrate 144. As another alternative, the row and column electrodes are in the same layer. In one or more embodiments, the row and column electrodes are formed as discussed in one or more of FIGS. 9A-9J.

Each electrode 85 has a self-capacitance, which corresponds to a parasitic capacitance created by the electrode with respect to other conductors in the display (e.g., ground, conductive layer(s), and/or one or more other electrodes). For example, row electrode 85-r has a parasitic capacitance Cₚ₂ and column electrode 85-c has a parasitic capacitance Cₚ₁. Note that each electrode includes a resistance component and, as such, produces a distributed R-C circuit. The longer the electrode, the greater the impedance of the distributed R-C circuit. For simplicity of illustration the distributed R-C circuit of an electrode will be represented as a single parasitic capacitance.

As shown, the touch screen display 80 includes a plurality of layers 140-144. Each illustrated layer may itself include one or more layers. For example, dielectric layer 140 includes a surface protective film, a glass protective film, and/or one or more pressure sensitive adhesive (PSA) layers. As another example, the second dielectric layer 142 includes a glass cover, a polyester (PET) film, a support plate (glass or plastic) to support, or embed, one or more of the electrodes 85-c and 85-r, a base plate (glass, plastic, or PET), and one or more PSA layers. As yet another example, the display substrate 144 includes one or more LCD layers, a back-light layer, one or more reflector layers, one or more polarizing layers, and/or one or more PSA layers.

FIG. 10B is a cross section schematic block diagram of a touch screen display 80, which is the same as in FIG. 9. This figure further includes a finger touch, which changes the self-capacitance of the electrodes. In essence, a finger touch creates a parallel capacitance with the parasitic self-capacitances. For example, the self-capacitance of the column electrode 85-c is Cₚ₁(parasitic capacitance)+C_{f1} (finger capacitance) and the self-capacitance of the row electrode 85-r is Cₚ₂+C_{f2}. As such, the finger capacitance increases the self-capacitance of the electrodes, which decreases the impedance for a given frequency. The change in impedance of the self-capacitance is detectable by a corresponding drive sense circuit and is subsequently processed to indicate a screen touch.

FIG. 11 is a cross section schematic block diagram of a touch screen display 80, which is the same as in FIG. 9. This figure further includes a mutual capacitance (C_{m_0}) between the electrodes when a touch is not present.

FIG. 12 is a cross section schematic block diagram of a touch screen display 80, which is the same as in FIG. 9. This figure further includes a mutual capacitance (C_{m_1}) between the electrodes when a touch is present. In this example, the finger capacitance is effectively in series with the mutual capacitance, which decreasing capacitance of the mutual capacitance. As the capacitance decreases for a given frequency, the impedance increases. The change in impedance of the mutual-capacitance is detectable by a corresponding drive sense circuit and is subsequently processed to indicate a screen touch. Note that, depending on the various properties (e.g., thicknesses, dielectric constants, electrode sizes, electrode spacing, etc.) of the touch screen display, the parasitic capacitances, the mutual capacitances, and/or the finger capacitance are in the range of a few pico-Farads to tens of nano-Farads. In equation form, the capacitance (C) equals:

$$C = ϵ \frac{A}{d}$$

where A is plate area, ϵ is the dielectric constant(s), and d is the distance between the plates.

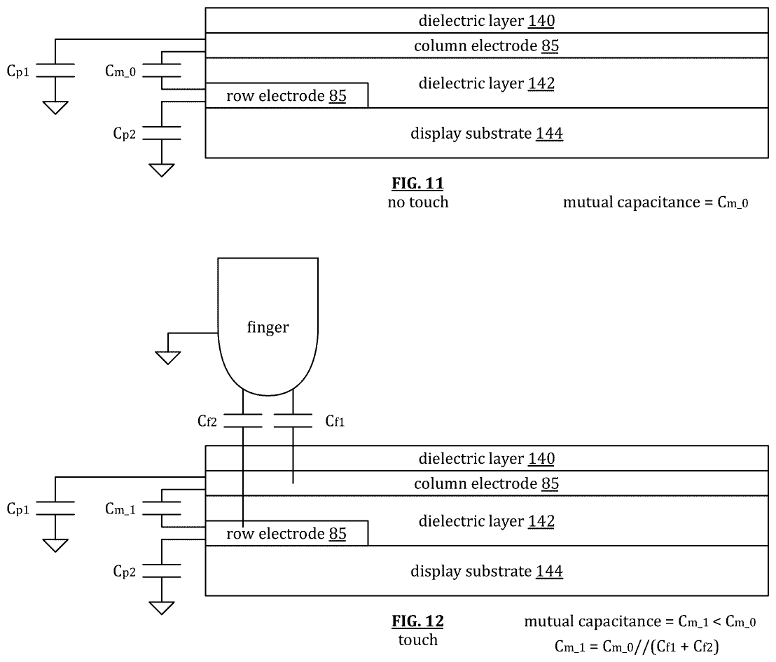

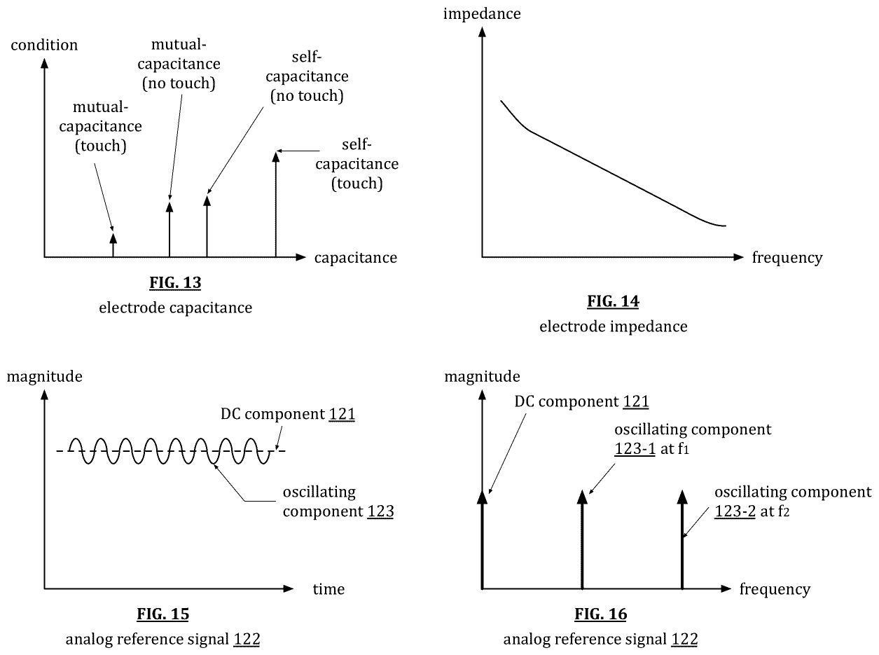

FIG. 13 is an example graph that plots condition verses capacitance for an electrode of a touch screen display. As shown, the mutual capacitance decreases with a touch and the self-capacitance increases with a touch. Note that the mutual capacitance and self-capacitance for a no-touch condition are shown to be about the same. This is done merely for ease of illustration. In practice, the mutual capacitance and self-capacitance may or may not be about the same capacitance based on the various properties of the touch screen display discussed above.

FIG. 14 is an example graph that plots impedance verses frequency for an electrode of a touch screen display. Since the impedance of an electrode is primarily based on its capacitance (self and/or mutual), as the frequency increases for a fixed capacitance, the impedance decreases based on ½πfC, where f is the frequency and C is the capacitance.

FIG. 15 is a time domain example graph that plots magnitude verses time for an analog reference signal 122. As discussed with reference to FIG. 8, the analog reference signal 122 (e.g., a current signal or a voltage signal) is inputted to a comparator and is compared to the sensor signal 116. The feedback loop of the drive sense circuit 28 functions to keep the senor signal 116 substantially matching the analog reference signal 122. As such, the sensor signal 116 will have a similar waveform to that of the analog reference signal 122.

In an example, the analog reference signal 122 includes a DC component 121 and/or one or more oscillating components 123. The DC component 121 is a DC voltage in the range of a few hundred milli-volts to tens of volts or more. The oscillating component 123 includes a sinusoidal signal, a square wave signal, a triangular wave signal, a multiple level signal (e.g., has varying magnitude over time with respect to the DC component), and/or a polygonal signal (e.g., has a symmetrical or asymmetrical polygonal shape with respect to the DC component).

In another example, the frequency of the oscillating component 123 may vary so that it can be tuned to the impedance of the sensor and/or to be off-set in frequency from other sensor signals in a system. For example, a capacitance sensor's impedance decreases with frequency. As such, if the frequency of the oscillating component is too high with respect to the capacitance, the capacitor looks like a short and variances in capacitances will be missed. Similarly, if the frequency of the oscillating component is too low with respect to the capacitance, the capacitor looks like an open and variances in capacitances will be missed.

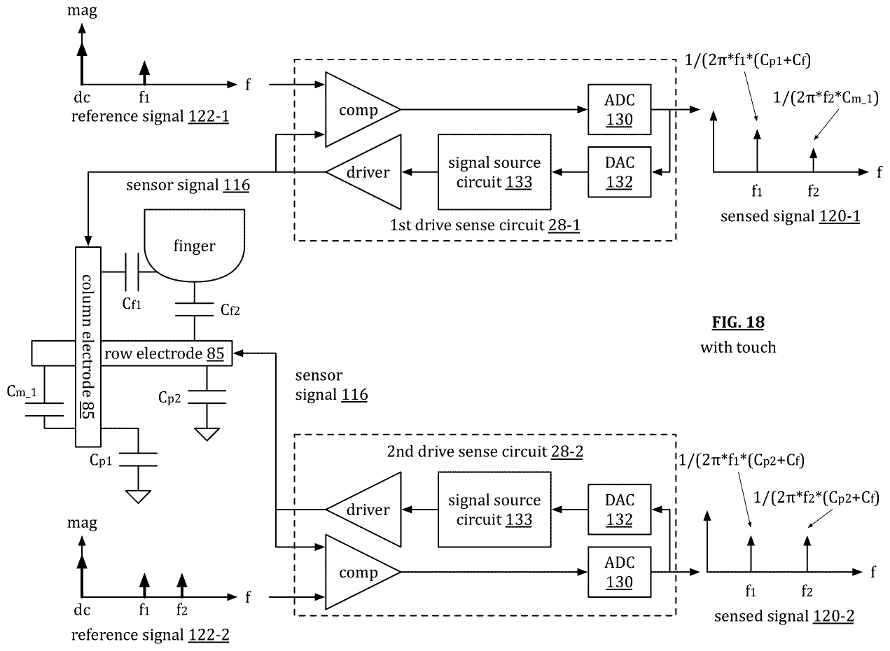

FIG. 16 is a frequency domain example graph that plots magnitude verses frequency for an analog reference signal 122. As shown, the analog reference signal 122 includes the DC component 121 at DC (e.g., 0 Hz or near 0 Hz), a first oscillating component 123-1 at a first frequency (f₁), and a second oscillating component 123-2 at a second frequency (f₂). In an example, the DC component is used to measure resistance of an electrode (if desired), the first oscillating component 123-1 is used to measure the impedance of self-capacitance, and the second oscillating component 123-2 is used to measure the impedance of mutual-capacitance. Note that the second frequency may be greater than the first frequency.

FIG. 17 is a schematic block diagram of an example of a first drive sense circuit 28-1 coupled to a first electrode 85-c and a second drive sense circuit 28-2 coupled to a second electrode 85-r without a touch proximal to the electrodes. Each of the drive sense circuits include a comparator, an analog to digital converter (ADC) 130, a digital to analog converter (DAC) 132, a signal source circuit 133, and a driver. The functionality of this embodiment of a drive sense circuit was described with reference to FIG. 8. For additional embodiments of a drive sense circuit see pending patent application entitled, “Drive Sense Circuit with Drive-Sense Line” having a filing date of Aug. 27, 2018, and an application number of Ser. No. 16/113,379.

As an example, a first reference signal 122-1 (e.g., analog or digital) is provided to the first drive sense circuit 28-1 and a second reference signal 122-2 (e.g., analog or digital) is provided to the second drive sense circuit 28-2. The first reference signal includes a DC component and/or an oscillating at frequency f₁. The second reference signal includes a DC component and/or two oscillating components: the first at frequency f₁ and the second at frequency f₂.

The first drive sense circuit 28-1 generates a sensor signal 116 based on the reference signal 122-1 and provides the sensor signal to the column electrode 85-c. The second drive sense circuit generates another sensor signal 116 based on the reference signal 122-2 and provides the sensor signal to the column electrode.

In response to the sensor signals being applied to the electrodes, the first drive sense circuit 28-1 generates a first sensed signal 120-1, which includes a component at frequency f₁ and a component a frequency f₂. The component at frequency f₁ corresponds to the self-capacitance of the column electrode 85-c and the component a frequency f₂ corresponds to the mutual capacitance between the row and column electrodes 85-c and 85-r. The self-capacitance is expressed as 1/(2πf₁Cₚ₁) and the mutual capacitance is expressed as 1/(2πf₂C_{m_0}).

Also, in response to the sensor signals being applied to the electrodes, the second drive sense circuit 28-1 generates a second sensed signal 120-2, which includes a component at frequency f₁ and a component a frequency f₂. The component at frequency f₁ corresponds to a shielded self-capacitance of the row electrode 85-r and the component a frequency f₂ corresponds to an unshielded self-capacitance of the row electrode 85-r. The shielded self-capacitance of the row electrode is expressed as 1/(2πf₁Cₚ₂) and the unshielded self-capacitance of the row electrode is expressed as 1/(2πf₂Cₚ₂).

With each active drive sense circuit using the same frequency for self-capacitance (e.g., f₁), the row and column electrodes are at the same potential, which substantially eliminates cross-coupling between the electrodes. This provides a shielded (i.e., low noise) self-capacitance measurement for the active drive sense circuits. In this example, with the second drive sense circuit transmitting the second frequency component, it has a second frequency component in its sensed signal, but is primarily based on the row electrode's self-capacitance with some cross coupling from other electrodes carrying signals at different frequencies. The cross coupling of signals at other frequencies injects unwanted noise into this self-capacitance measurement and hence it is referred to as unshielded.

FIG. 18 is a schematic block diagram of an example of a first drive sense circuit 28-1 coupled to a first electrode 85-c and a second drive sense circuit 28-2 coupled to a second electrode 85-r with a finger touch proximal to the electrodes. This example is similar to the one of FIG. 17 with the difference being a finger touch proximal to the electrodes (e.g., a touch that shadows the intersection of the electrodes or is physically close to the intersection of the electrodes). With the finger touch, the self-capacitance and the mutual capacitance of the electrodes are changed.

In this example, the impedance of the self-capacitance at f₁ of the column electrode 85-c now includes the effect of the finger capacitance. As such, the impedance of the self-capacitance of the column electrode equals 1/(2πf₁*(Cₚ₁+C_{f1})), which is included the sensed signal 120-1. The second frequency component at f₂ corresponds to the impedance of the mutual-capacitance at f₂, which includes the effect of the finger capacitance. As such, the impedance of the mutual capacitance equals 1/(2πf₂C_{m_1}), where C_{m_1}=(C_{m_0}*C_{f1})/(C_{m_0}+C_{f1}).

Continuing with this example, the first frequency component at f₁ of the second sensed signal 120-2 corresponds to the impedance of the shielded self-capacitance of the row electrode 85-r at f₁, which is affected by the finger capacitance. As such, the impedance of the capacitance of the row electrode 85-r equals 1/(2πf₁*(Cₚ₂+C_{f2})). The second frequency component at f₂ of the second sensed signal 120-2 corresponds to the impedance of the unshielded self-capacitance at f₂, which includes the effect of the finger capacitance and is equal to 1/(2πf₂*(Cₚ₂+C_{f2})).

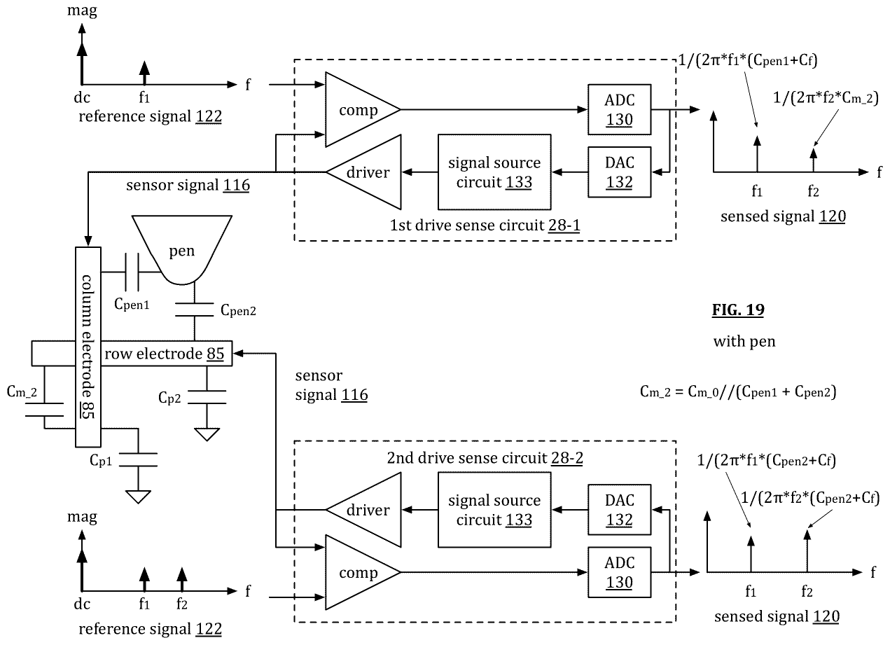

FIG. 19 is a schematic block diagram of an example of a first drive sense circuit 28-1 coupled to a first electrode 85-c and a second drive sense circuit 28-2 coupled to a second electrode 85-r with a pen touch proximal to the electrodes. This example is similar to the one of FIG. 17 with the difference being a pen touch proximal to the electrodes (e.g., a touch that shadows the intersection of the electrodes or is physically close to the intersection of the electrodes). With the pen touch, the self-capacitance and the mutual capacitance of the electrodes are changed based on the capacitance of the pen Cₚₑₙ₁ and Cₚₑₙ₂.

In this example, the impedance of the self-capacitance at f₁ of the column electrode 85-c now includes the effect of the pen's capacitance. As such, the impedance of the self-capacitance of the column electrode equals 1/(2πf₁*(Cₚ₁+Cₚₑₙ₁)), which is included the sensed signal 120-1. The second frequency component at f₂ corresponds to the impedance of the mutual-capacitance at f₂, which includes the effect of the pen capacitance. As such, the impedance of the mutual capacitance equals 1/(2πf₂C_{m_2}), where C_{m_2}=(C_{m_0}*Cₚₑₙ₂)/(C_{m_0}+Cₚₑₙ₁).

Continuing with this example, the first frequency component at f₁ of the second sensed signal 120-2 corresponds to the impedance of the shielded self-capacitance of the row electrode 85-r at f₃, which is affected by the pen capacitance. As such, the impedance of the shielded self-capacitance of the row electrode 85-r equals 1/(2πf₁*(Cₚ₂+Cₚₑₙ₂)). The second frequency component at f₂ of the second sensed signal 120-2 corresponds to the impedance of the unshielded self-capacitance at f₂, which includes the effect of the pen capacitance and is equal to 1/(2πf₂*(Cₚ₂+Cₚₑₙ₂)). Note that the pen capacitance is represented as two capacitances, but may be one capacitance value or a plurality of distributed capacitance values.

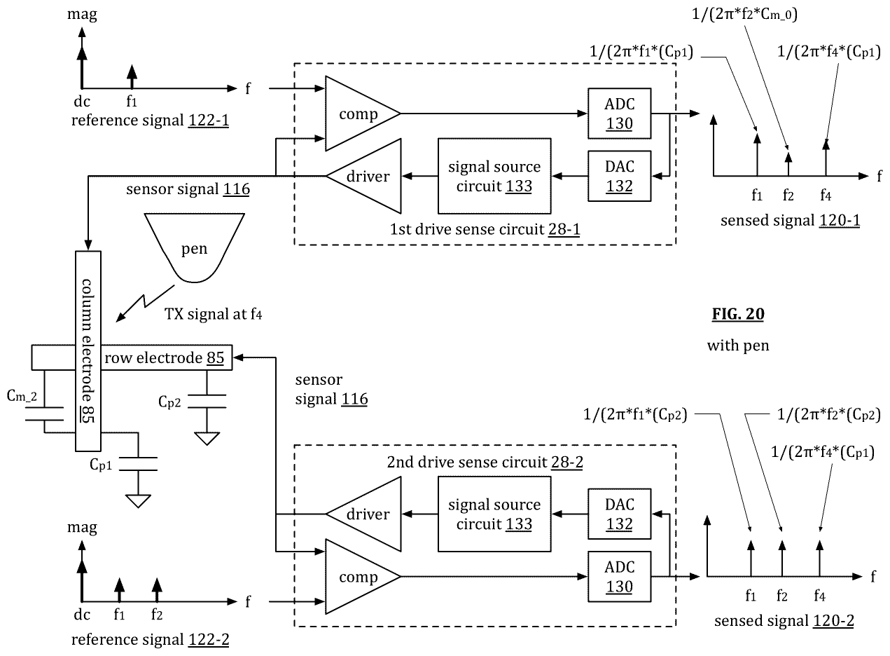

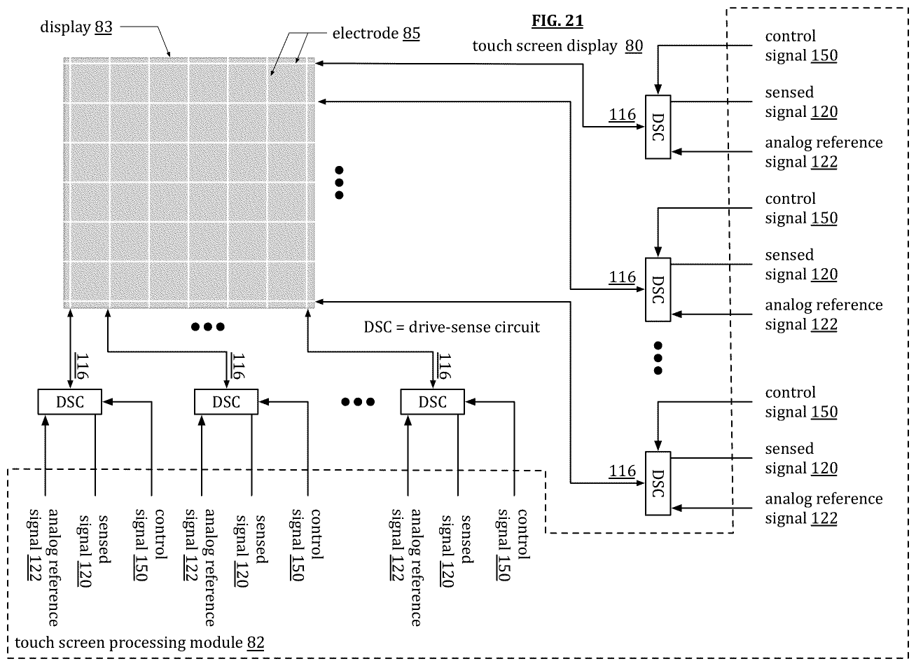

FIG. 20 is a schematic block diagram of an example of a first drive sense circuit 28-1 coupled to a first electrode 85-c and a second drive sense circuit 28-2 coupled to a second electrode 85-r with a pen proximal to the electrodes. Each of the drive sense circuits include a comparator, an analog to digital converter (ADC) 130, a digital to analog converter (DAC) 132, a signal source circuit 133, and a driver. The functionality of this embodiment of a drive sense circuit was described with reference to FIG. 8. The pen is operable to transmit a signal at a frequency of f4, which affects the self and mutual capacitances of the electrodes 85.

In this example, a first reference signal 122-1 is provided to the first drive sense circuit 28-1. The first reference signal includes a DC component and/or an oscillating component at frequency f₁. The first oscillating component at f₁ is used to sense impedance of the self-capacitance of the column electrode 85-c. The first drive sense circuit 28-1 generates a first sensed signal 120-1 that includes three frequency dependent components. The first frequency component at f₁ corresponds to the impedance of the self-capacitance at f₁, which equals 1/(2πf₁Cₚ₁). The second frequency component at f₂ corresponds to the impedance of the mutual-capacitance at f₂, which equals 1/(2πf₂C_{m_0}). The third frequency component at f4 corresponds to the signal transmitted by the pen.

Continuing with this example, a second reference signal 122-2 is provided to the second drive sense circuit 28-2. The second analog reference signal includes a DC component and/or two oscillating components: the first at frequency f₁ and the second at frequency f₂. The first oscillating component at f₁ is used to sense impedance of the shielded self-capacitance of the row electrode 85-r and the second oscillating component at f₂ is used to sense the unshielded self-capacitance of the row electrode 85-r. The second drive sense circuit 28-2 generates a second sensed signal 120-2 that includes three frequency dependent components. The first frequency component at f₁ corresponds to the impedance of the shielded self-capacitance at f₃, which equals 1/(2πf₁Cₚ₂). The second frequency component at f₂ corresponds to the impedance of the unshielded self-capacitance at f₂, which equals 1/(2πf₂Cₚ₂). The third frequency component at f₄ corresponds to signal transmitted by the pen.

As a further example, the pen transmits a sinusoidal signal having a frequency of f₄. When the pen is near the surface of the touch screen, electromagnetic properties of the signal increase the voltage on (or current in) the electrodes proximal to the touch of the pen. Since impedance is equal to voltage/current and as a specific example, when the voltage increases for a constant current, the impedance increases. As another specific example, when the current increases for a constant voltage, the impedance increases. The increase in impedance is detectable and is used as an indication of a touch.

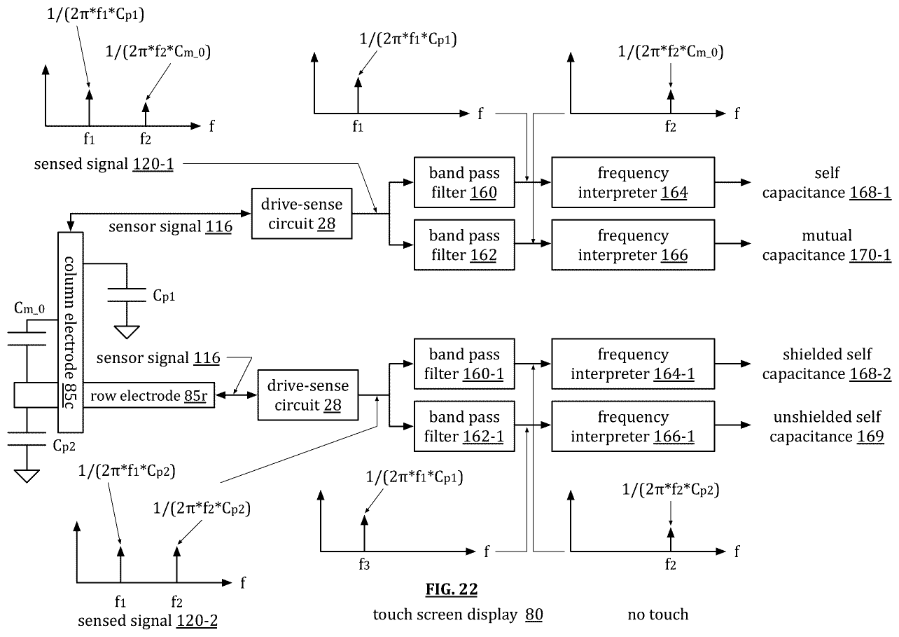

FIG. 21 is a schematic block diagram of another embodiment of a touch screen display 80 that includes the display 83, the electrodes 85, a plurality of drive sense circuits (DSC), and the touch screen processing module 82, which function as previously discussed. In addition, the touch screen processing module 82 generates a plurality of control signals 150 to enable the drive-sense circuits (DSC) to monitor the sensor signals 120 on the electrodes 85. For example, the processing module 82 provides an individual control signal 150 to each of the drive sense circuits to individually enable or disable the drive sense circuits. In an embodiment, the control signal 150 closes a switch to provide power to the drive sense circuit. In another embodiment, the control signal 150 enables one or more components of the drive sense circuit.

The processing module 82 further provides analog reference signals 122 to the drive sense circuits. In an embodiment, each drive sense circuit receives a unique analog reference signal. In another embodiment, a first group of drive sense circuits receive a first analog reference signal, and a second group of drive sense circuits receive a second analog reference signal. In yet another embodiment, the drive sense circuits receive the same analog reference signal. Note that the processing module 82 uses a combination of analog reference signals with control signals to ensure that different frequencies are used for oscillating components of the analog reference signal.

The drive sense circuits provide sensed signals 116 to the electrodes. The impedances of the electrodes affect the sensed signal, which the drive sense circuits sense via the received signal component and generate the sensed signal 120 therefrom. The sensed signals 120 are essentially representations of the impedances of the electrodes, which are provided to the touch screen processing module 82.

The processing module 82 interprets the sensed signals 122 (e.g., the representations of impedances of the electrodes) to detect a change in the impedance of one or more electrodes. For example, a finger touch increases the self-capacitance of an electrode, thereby decreasing its impedance at a given frequency. As another example, a finger touch decreases the mutual capacitance of an electrode, thereby increasing its impedance at a given frequency. The processing module 82 then interprets the change in the impedance of one or more electrodes to indicate one or more touches of the touch screen display 80.

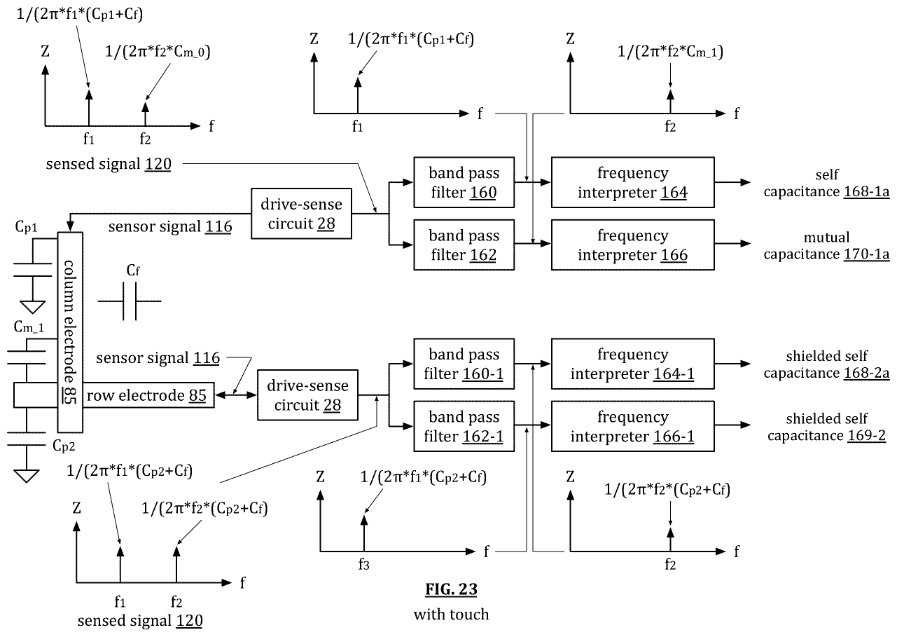

FIG. 22 is a schematic block diagram of a touchless example of a few drive sense circuits 28 and a portion of the touch screen processing module 82 of a touch screen display 80. The portion of the processing module 82 includes band pass filters 160, 162, 160-1, & 160-2, self-frequency interpreters 164 & 164-1, and 166 & 166-1. As previously discussed, a first drive sense circuit is coupled to column electrode 85c and a second drive sense circuit is coupled to a row electrode 85r.

The drive sense circuits provide sensor signals 116 to their respective electrodes 85 and produce therefrom respective sensed signals 120. The first sensed signal 120-1 includes a first frequency component at f₁ that corresponds to the self-capacitance of the column electrode 85c and a second frequency component at f₂ that corresponds to the mutual capacitance of the column electrode 85c. The second sensed signal 120-2 includes a first frequency component at f₁ that corresponds to the shielded self-capacitance of the row electrode 85r and/or a second frequency component at f₂ that corresponds to the unshielded self-capacitance of the row electrode 85r. In an embodiment, the sensed signals 120 are frequency domain digital signals.

The first bandpass filter 160 passes (i.e., substantially unattenuated) signals in a bandpass region (e.g., tens of Hertz to hundreds of thousands of Hertz, or more) centered about frequency f₁ and attenuates signals outside of the bandpass region. As such, the first bandpass filter 160 passes the portion of the sensed signal 120-1 that corresponds to the self-capacitance of the column electrode 85c. In an embodiment, the sensed signal 116 is a digital signal, thus, the first bandpass filter 160 is a digital filter such as a cascaded integrated comb (CIC) filter, a finite impulse response (FIR) filter, an infinite impulse response (IIR) filter, a Butterworth filter, a Chebyshev filter, an elliptic filter, etc.

The frequency interpreter 164 receives the first bandpass filter sensed signal and interprets it to render a self-capacitance value 168-1 for the column electrode. As an example, the frequency interpreter 164 is a processing module, or portion thereof, that executes a function to convert the first bandpass filter sensed signal into the self-capacitance value 168-1, which is an actual capacitance value, a relative capacitance value (e.g., in a range of 0-100), or a difference capacitance value (e.g., is the difference between a default capacitance value and a sensed capacitance value). As another example, the frequency interpreter 164 is a look up table where the first bandpass filter sensed signal is an index for the table.

The second bandpass filter 162 passes, substantially unattenuated, signals in a second bandpass region (e.g., tens of Hertz to hundreds of thousands of Hertz, or more) centered about frequency f₂ and attenuates signals outside of the bandpass region. As such, the second bandpass filter 160 passes the portion of the sensed signal 120-1 that corresponds to the mutual-capacitance of the column electrode 85c and the row electrode 85r. In an embodiment, the sensed signal 116 is a digital signal, thus, the second bandpass filter 162 is a digital filter such as a cascaded integrated comb (CIC) filter, a finite impulse response (FIR) filter, an infinite impulse response (IIR) filter, a Butterworth filter, a Chebyshev filter, an elliptic filter, etc.

The frequency interpreter 166 receives the second bandpass filter sensed signal and interprets it to render a mutual-capacitance value 170-1. As an example, the frequency interpreter 166 is a processing module, or portion thereof, that executes a function to convert the second bandpass filter sensed signal into the mutual-capacitance value 170-1, which is an actual capacitance value, a relative capacitance value (e.g., in a range of 0-100), and/or a difference capacitance value (e.g., is the difference between a default capacitance value and a sensed capacitance value). As another example, the frequency interpreter 166 is a look up table where the first bandpass filter sensed signal is an index for the table.

For the row electrode 85r, the drive-sense circuit 28 produces a second sensed signal 120-2, which includes a shielded self-capacitance component and/or an unshielded self-capacitance component. The third bandpass filter 160-1 is similar to the first bandpass filter 160 and, as such passes signals in a bandpass region centered about frequency f₁ and attenuates signals outside of the bandpass region. In this example, the third bandpass filter 160-1 passes the portion of the second sensed signal 120-2 that corresponds to the shielded self-capacitance of the row electrode 85r.

The frequency interpreter 164-1 receives the second bandpass filter sensed signal and interprets it to render a second and shielded self-capacitance value 168-2 for the row electrode. The frequency interpreter 164-1 may be implemented similarly to the first frequency interpreter 164 or an integrated portion thereof. In an embodiment, the second self-capacitance value 168-2 is an actual capacitance value, a relative capacitance value (e.g., in a range of 0-100), or a difference capacitance value (e.g., is the difference between a default capacitance value and a sensed capacitance value).

The fourth bandpass filter 162-2, if included, is similar to the second bandpass filter 162. As such, it passes, substantially unattenuated, signals in a bandpass region centered about frequency f₂ and attenuates signals outside of the bandpass region. In this example, the fourth bandpass filter 162-2 passes the portion of the second sensed signal 120-2 that corresponds to the unshielded self-capacitance of the row electrode 85r.

The frequency interpreter 166-1, if included, receives the fourth bandpass filter sensed signal and interprets it to render an unshielded self-capacitance value 168-2. The frequency interpreter 166-1 may be implemented similarly to the first frequency interpreter 166 or an integrated portion thereof. In an embodiment, the unshielded self-capacitance value 170-2 is an actual capacitance value, a relative capacitance value (e.g., in a range of 0-100), or a difference capacitance value (e.g., is the difference between a default capacitance value and a sensed capacitance value). Note that the unshielded self-capacitance may be ignored, thus band pass filter 162-1 and frequency interpreter 166-1 may be omitted.

FIG. 23 is a schematic block diagram of a finger touch example of a few drive sense circuits and a portion of the touch screen processing module of a touch screen display that is similar to FIG. 22, with the difference being a finger touch as represented by the finger capacitance Cf. In this example, the self-capacitance and mutual capacitance of each electrode is affected by the finger capacitance.

The effected self-capacitance of the column electrode 85c is processed by the first bandpass filter 160 and the frequency interpreter 164 to produce a self-capacitance value 168-1a. The mutual capacitance of the column electrode 85c and row electrode is processed by the second bandpass filter 162 and the frequency interpreter 166 to produce a mutual-capacitance value 170-1a.

The effected shielded self-capacitance of the row electrode 85r is processed by the third bandpass filter 160-1 and the frequency interpreter 164-1 to produce a self-capacitance value 168-2a. The effected unshielded self-capacitance of the row electrode 85r is processed by the fourth bandpass filter 162-1 and the frequency interpreter 166-1 to produce an unshielded self-capacitance value 170-2a.

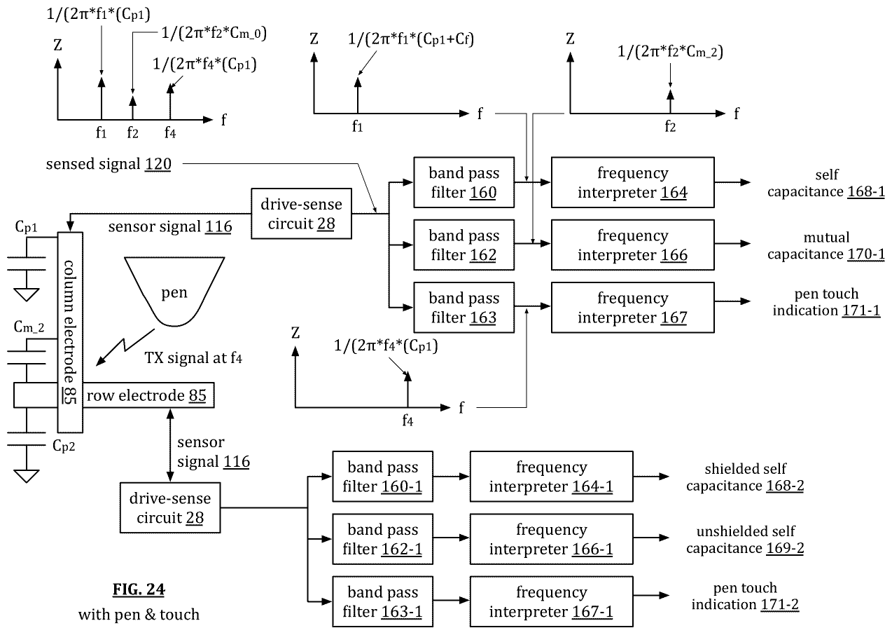

FIG. 24 is a schematic block diagram of a pen touch example of a few drive sense circuits and a portion of the touch screen processing module of a touch screen display that is similar to FIG. 22, with the difference being a pen touch as represented by the pen capacitance Cₚₑₙ. In this example, the self-capacitance and mutual capacitance of each electrode is affected by the pen capacitance.

The effected self-capacitance of the column electrode 85c is processed by the first bandpass filter 160 and the frequency interpreter 164 to produce a self-capacitance value 168-1a. The effected mutual capacitance of the column electrode 85c and row electrode 85r is processed by the second bandpass filter 162 and the frequency interpreter 166 to produce a mutual-capacitance value 170-1a.

The effected shielded self-capacitance of the row electrode 85r is processed by the third bandpass filter 160-1 and the frequency interpreter 164-1 to produce a shielded self-capacitance value 168-2a. The effected unshielded self-capacitance of the row electrode 85r is processed by the fourth bandpass filter 162-1 and the frequency interpreter 166-1 to produce an unshielded self-capacitance value 170-2a.

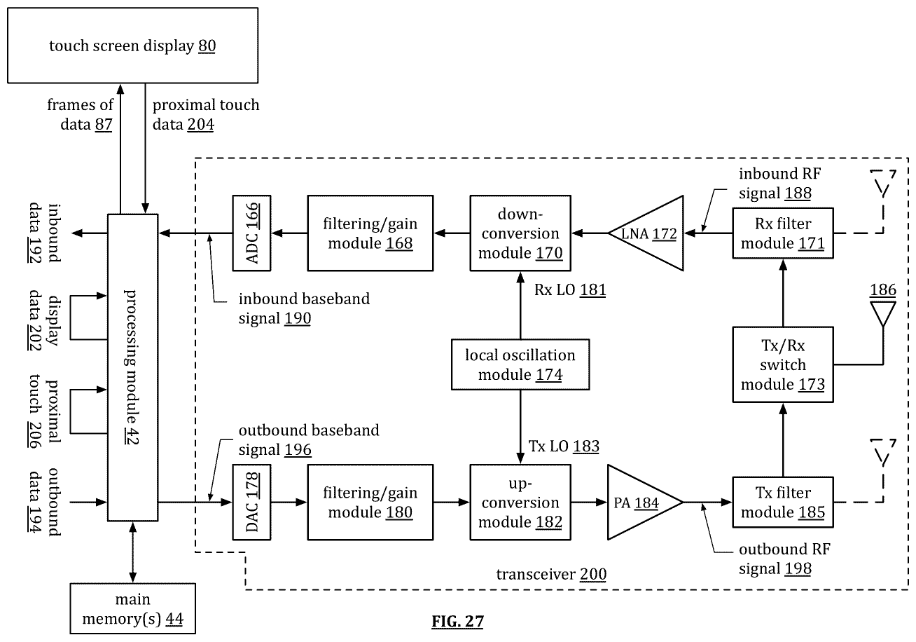

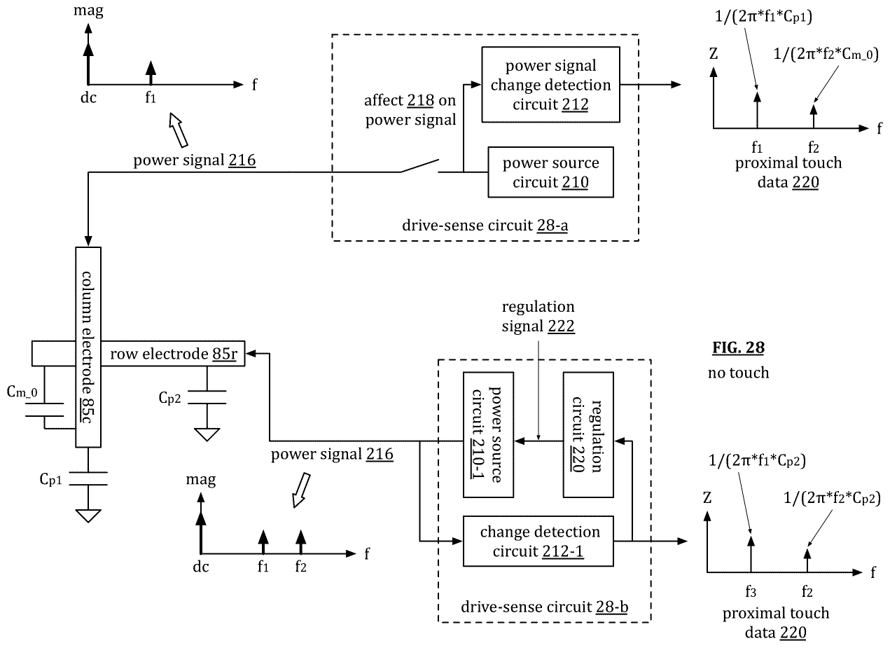

FIG. 25 is a schematic block diagram of an embodiment of a computing device 14-a having touch screen display 80-a. The computing device 14-a is a cell phone, a personal video device, a tablet, or the like and the touch screen display has a screen size that is equal to or less than 15 inches. The computing device 14-a includes a processing module 42-a, main memory 44-a, and a transceiver 200. An embodiment of the transceiver 200 will be discussed with reference to FIG. 27. The processing module 42-a and the main memory 44-a are similar to the processing module 42 and the main memory 44 of the computing device 14 of FIG. 2.

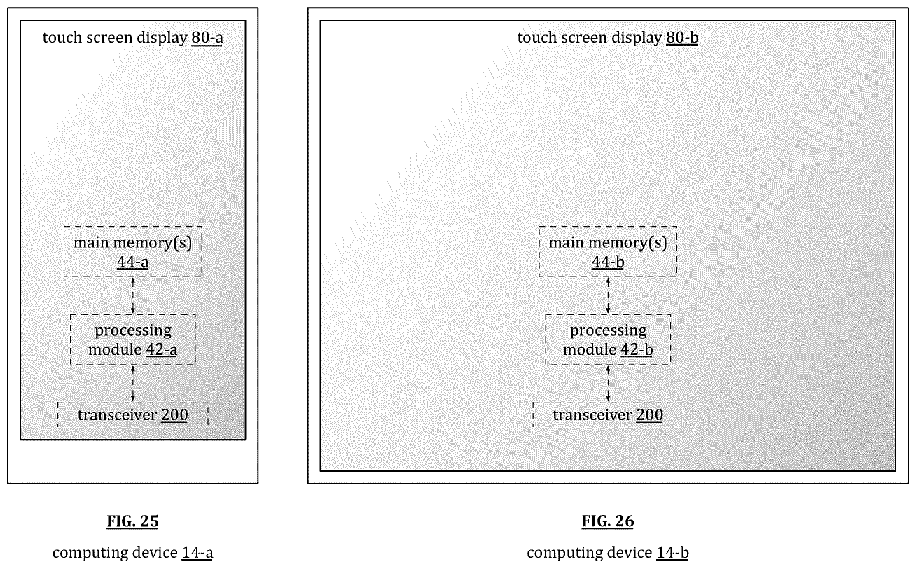

FIG. 26 is a schematic block diagram of another embodiment of a computing device 14-b having touch screen display 80-b. The computing device 14-b is a computer, an interactive display, a large tablet, or the like and the touch screen display 80-b has a screen size that is greater than 15 inches. The computing device 14-b includes a processing module 42-b, main memory 44-b, and a transceiver 200. An embodiment of the transceiver 200 will be discussed with reference to FIG. 27. The processing module 42-b and the main memory 44-b are similar to the processing module 42 and the main memory 44 of the computing device 14 of FIG. 2.

FIG. 27 is a schematic block diagram of another embodiment of a computing device 14-a and/or 14-b that includes the processing module 42 (e.g., a and/or b), the main memory 44 (e.g., a and/or b), the touch screen display 80 (e.g., a and/or b), and the transceiver 200. The transceiver 200 includes a transmit/receive switch module 173, a receive filter module 171, a low noise amplifier (LNA) 172, a down conversion module 170, a filter/gain module 168, an analog to digital converter (ADC) 166, a digital to analog converter (DAC) 178, a filter/gain module 170, an up-conversion module 182, a power amplifier (PA) 184, a transmit filter module 185, one or more antennas 186, and a local oscillation module 174. In an alternate embodiment, the transceiver 200 includes a transmit antenna and a receiver antenna (as shown using dashed lines) and omit the common antenna 186 and the transmit/receive (Tx/Rx) switch module 173.

In an example of operation using the common antenna 186, the antenna receives an inbound radio frequency (RF) signal, which is routed to the receive filter module 171 via the Tx/Rx switch module 173 (e.g., a balun, a cross-coupling circuit, etc.). The receive filter module 171 is a bandpass or low pass filter that passes the inbound RF signal to the LNA 172, which amplifies it.

The down conversion module 170 converts the amplified inbound RF signal into a first inbound symbol stream corresponding to a first signal component (e.g., RX 1adj) and into a second inbound symbol stream corresponding to the second signal component (e.g., RX 2adj). In an embodiment, the down conversion module 170 mixes in-phase (I) and quadrature (Q) components of the amplified inbound RF signal (e.g., amplified RX 1adj and RX 2adj) with in-phase and quadrature components of receiver local oscillation 181 to produce a mixed I signal and a mixed Q signal for each component of the amplified inbound RF signal. Each pair of the mixed I and Q signals are combined to produce the first and second inbound symbol streams. In this embodiment, each of the first and second inbound symbol streams includes phase information (e.g., +/−Δθ [phase shift] and/or θ(t) [phase modulation]) and/or frequency information (e.g., +/−Δf [frequency shift] and/or f(t) [frequency modulation]). In another embodiment and/or in furtherance of the preceding embodiment, the inbound RF signal includes amplitude information (e.g., +/−ΔA [amplitude shift] and/or A(t) [amplitude modulation]).

The filter/gain module 168 filters the down-converted inbound signal, which is then converted into a digital inbound baseband signal 190 by the ADC 166. The processing module 42 converts the inbound symbol stream(s) into inbound data 192 (e.g., voice, text, audio, video, graphics, etc.) in accordance with one or more wireless communication standards (e.g., GSM, CDMA, WCDMA, HSUPA, HSDPA, WiMAX, EDGE, GPRS, IEEE 802.11, Bluetooth, ZigBee, universal mobile telecommunications system (UMTS), long term evolution (LTE), IEEE 802.16, evolution data optimized (EV-DO), etc.). Such a conversion may include one or more of: digital intermediate frequency to baseband conversion, time to frequency domain conversion, space-time-block decoding, space-frequency-block decoding, demodulation, frequency spread decoding, frequency hopping decoding, beamforming decoding, constellation demapping, deinterleaving, decoding, depuncturing, and/or descrambling. Note that the processing module converts a single inbound symbol stream into the inbound data for Single Input Single Output (SISO) communications and/or for Multiple Input Single Output (MISO) communications and converts the multiple inbound symbol streams into the inbound data for Single Input Multiple Output (SIMO) and Multiple Input Multiple Output (MIMO) communications.

In an example, the inbound data 192 includes display data 202. For example, the inbound RF signal 188 includes streaming video over a wireless link. As such, the inbound data 192 includes the frames of data 87 of the video file, which the processing module 42 provides to the touch screen display 80 for display. The processing module 42 further processes proximal touch data 204 (e.g., finger or pen touches) of the touch screen display 80. For example, a touch corresponds to a command that is to be wirelessly sent to the content provider of the streaming wireless video.

In this example, the processing module interprets the proximal touch data 204 to generate a command (e.g., pause, stop, etc.) regarding the streaming video. The processing module processes the command as outbound data 194 e.g., voice, text, audio, video, graphics, etc.) by converting it into one or more outbound symbol streams (e.g., outbound baseband signal 196) in accordance with one or more wireless communication standards (e.g., GSM, CDMA, WCDMA, HSUPA, HSDPA, WiMAX, EDGE, GPRS, IEEE 802.11, Bluetooth, ZigBee, universal mobile telecommunications system (UMTS), long term evolution (LTE), IEEE 802.16, evolution data optimized (EV-DO), etc.). Such a conversion includes one or more of: scrambling, puncturing, encoding, interleaving, constellation mapping, modulation, frequency spreading, frequency hopping, beamforming, space-time-block encoding, space-frequency-block encoding, frequency to time domain conversion, and/or digital baseband to intermediate frequency conversion. Note that the processing module converts the outbound data into a single outbound symbol stream for Single Input Single Output (SISO) communications and/or for Multiple Input Single Output (MISO) communications and converts the outbound data into multiple outbound symbol streams for Single Input Multiple Output (SIMO) and Multiple Input Multiple Output (MIMO) communications.

The DAC 178 converts the outbound baseband signal 196 into an analog signal, which is filtered by the filter/gain module 180. The up-conversion module 182 mixes the filtered analog outbound baseband signal with a transmit local oscillation 183 to produce an up-converted signal. This may be done in a variety of ways. In an embodiment, in-phase and quadrature components of the outbound baseband signal are mixed with in-phase and quadrature components of the transmit local oscillation to produce the up-converted signal. In another embodiment, the outbound baseband signal provides phase information (e.g., +/−Δθ [phase shift] and/or θ(t) [phase modulation]) that adjusts the phase of the transmit local oscillation to produce a phase adjusted up-converted signal. In this embodiment, the phase adjusted up-converted signal provides the up-converted signal. In another embodiment, the outbound baseband signal further includes amplitude information (e.g., A(t) [amplitude modulation]), which is used to adjust the amplitude of the phase adjusted up converted signal to produce the up-converted signal. In yet another embodiment, the outbound baseband signal provides frequency information (e.g., +/−Δf [frequency shift] and/or f(t) [frequency modulation]) that adjusts the frequency of the transmit local oscillation to produce a frequency adjusted up-converted signal. In this embodiment, the frequency adjusted up-converted signal provides the up-converted signal. In another embodiment, the outbound baseband signal further includes amplitude information, which is used to adjust the amplitude of the frequency adjusted up-converted signal to produce the up-converted signal. In a further embodiment, the outbound baseband signal provides amplitude information (e.g., +/−ΔA [amplitude shift] and/or A(t) [amplitude modulation) that adjusts the amplitude of the transmit local oscillation to produce the up-converted signal.

The power amplifier 184 amplifies the up-converted signal to produce an outbound RF signal 198. The transmit filter module 185 filters the outbound RF signal 198 and provides the filtered outbound RF signal to the antenna 186 for transmission, via the transmit/receive switch module 173. Note that processing module may produce the display data from the inbound data, the outbound data, application data, and/or system data.

FIG. 28 is a schematic block diagram of another example of a first drive sense circuit 28-a coupled to a column electrode 85c and a second drive sense circuit 28-b coupled to a row electrode 85r without a touch proximal to the electrodes. The first drive sense circuit 28-a includes a power source circuit 210 and a power signal change detection circuit 212. The second drive sense circuit 28-b includes a power source circuit 210-1, a power signal change detection circuit 212-1, and a regulation circuit 220.

The power source circuit 210 of the first drive sense circuit 28-a is operably coupled to the column electrode 85c and, when enabled (e.g., from a control signal from the processing module 42, power is applied, a switch is closed, a reference signal is received, etc.) provides a power signal 216 to the column electrode 85c. The power source circuit 210 may be a voltage supply circuit (e.g., a battery, a linear regulator, an unregulated DC-to-DC converter, etc.) to produce a voltage-based power signal, a current supply circuit (e.g., a current source circuit, a current mirror circuit, etc.) to produce a current-based power signal, or a circuit that provides a desired power level to the sensor and substantially matches impedance of the sensor. The power source circuit 110 generates the power signal 116 to include a DC (direct current) component and/or an oscillating component.

When receiving the power signal 216, the impedance of the electrode affects 218 the power signal. When the power signal change detection circuit 212 is enabled, it detects the affect 218 on the power signal as a result of the impedance of the electrode. For example, the power signal is a 1.5 voltage signal and, under a first condition, the sensor draws 1 milliamp of current, which corresponds to an impedance of 1.5 K Ohms. Under a second condition, the power signal remains at 1.5 volts and the current increases to 1.5 milliamps. As such, from condition 1 to condition 2, the impedance of the electrode changed from 1.5 K Ohms to 1 K Ohms. The power signal change detection circuit 212 determines the change and generates a sensed signal, or proximal touch data 220 therefrom.

The power source circuit 210-1 of the second drive sense circuit 28-b is operably coupled to the row electrode 85r and, when enabled (e.g., from a control signal from the processing module 42, power is applied, a switch is closed, a reference signal is received, etc.) provides a power signal 216 to the electrode 85r. The power source circuit 210-1 may be implemented similarly to power source circuit 210 and generates the power signal 216 to include a DC (direct current) component and/or an oscillating component.

When receiving the power signal 216, the impedance of the row electrode 85r affects the power signal. When the change detection circuit 212-1 is enabled, it detects the affect on the power signal as a result of the impedance of the electrode 85r. The change detection circuit 210-1 is further operable to generate a sensed signal 120, or proximal touch data 220, that is representative of change to the power signal based on the detected effect on the power signal.

The regulation circuit 152, when its enabled, generates regulation signal 22 to regulate the DC component to a desired DC level and/or regulate the oscillating component to a desired oscillating level (e.g., magnitude, phase, and/or frequency) based on the sensed signal 120. The power source circuit 210-1 utilizes the regulation signal 222 to keep the power signal 216 at a desired setting regardless of the impedance changes of the electrode 85r. In this manner, the amount of regulation is indicative of the affect the impedance of the electrode has on the power signal.

In an example, the power source circuit 210-1 is a DC-DC converter operable to provide a regulated power signal 216 having DC and AC components. The change detection circuit 212-1 is a comparator and the regulation circuit 220 is a pulse width modulator to produce the regulation signal 222. The comparator compares the power signal 216, which is affected by the electrode, with a reference signal that includes DC and AC components. When the impedance is at a first level, the power signal is regulated to provide a voltage and current such that the power signal substantially resembles the reference signal.

When the impedance changes to a second level, the change detection circuit 212-1 detects a change in the DC and/or AC component of the power signal 216 and generates the sensed signal 120, which indicates the changes. The regulation circuit 220 detects the change in the sensed signal 120 and creates the regulation signal 222 to substantially remove the impedance change effect on the power signal 216. The regulation of the power signal 216 may be done by regulating the magnitude of the DC and/or AC components, by adjusting the frequency of AC component, and/or by adjusting the phase of the AC component.

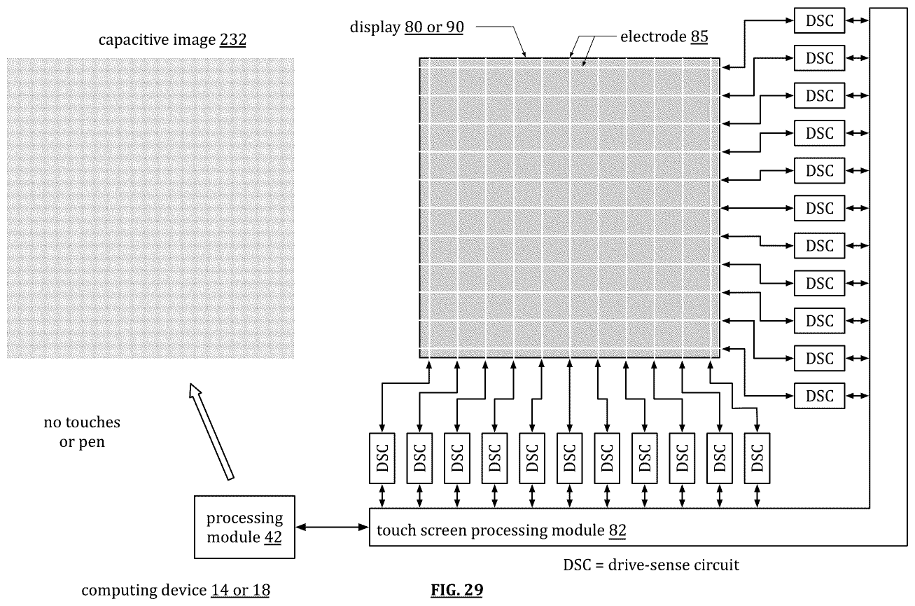

FIG. 29 is a schematic block diagram of an example of a computing device 14 or 18 that includes the components of FIG. 2 and/or FIG. 3. Only the processing module 42, the touch screen processing module 82, the display 80 or 90, the electrodes 85, and the drive sense circuits (DSC) are shown.

In an example of operation, the touch screen processing module 82 receives sensed signals from the drive sense circuits and interprets them to identify a finger or pen touch. In this example, there are no touches. The touch screen processing module 82 provides touch data (which includes location of touches, if any, based on the row and column electrodes having an impedance change due to the touch(es)) to the processing module 42.

The processing module 42 processes the touch data to produce a capacitive image 232 of the display 80 or 90. In this example, there are no touches, so the capacitive image 232 is substantially uniform across the display. The refresh rate of the capacitive image ranges from a few frames of capacitive images per second to a hundred or more frames of capacitive images per second. Note that the capacitive image may be generated in a variety of ways. For example, the self-capacitance and/or mutual capacitance of each touch cell (e.g., intersection of a row electrode with a column electrode) is represented by a color. When the touch cells have substantially the same capacitance, their representative color will be substantially the same. As another example, the capacitance image is topological mapping of differences between the capacitances of the touch cells.

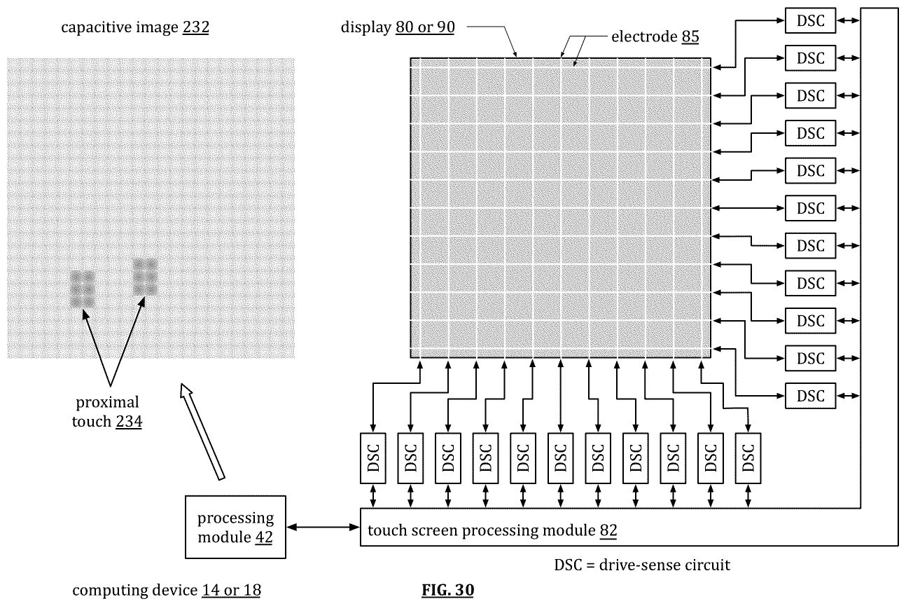

FIG. 30 is a schematic block diagram of another example of a computing device that is substantially similar to the example of FIG. 29 with the exception that the touch data includes two touches. As such, the touch data generated by the touch screen processing module 82 includes the location of two touches based on effected rows and columns. The processing module 42 processes the touch data to determine the x-y coordinates of the touches on the display 80 or 90 and generates the capacitive image, which includes the touches.

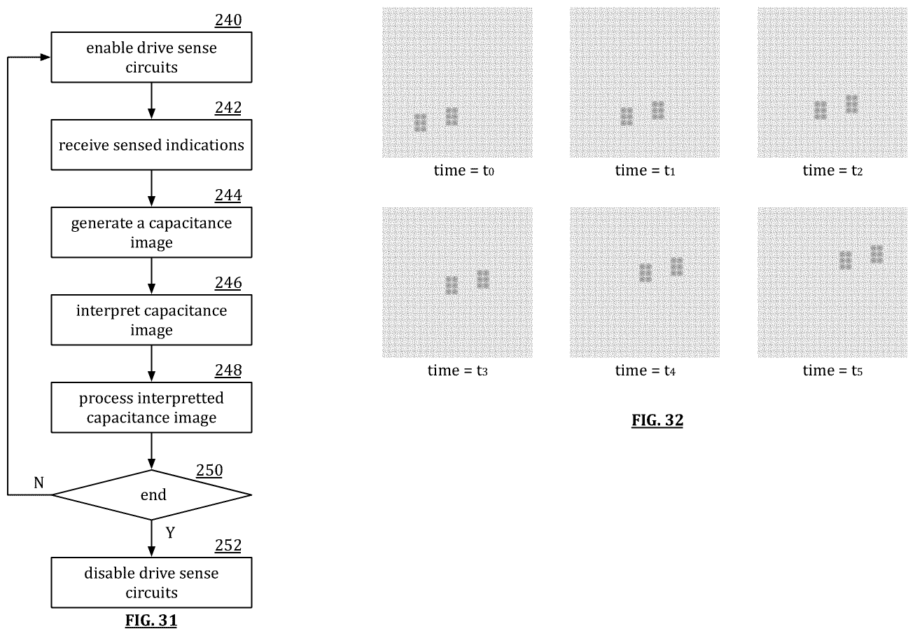

FIG. 31 is a logic diagram of an embodiment of a method for generating a capacitive image of a touch screen display that is executed by the processing module 42 and/or 82. The method begins at step 240 where the processing module enables (for continuous or periodic operation) the drive-sense circuits to provide a sensor signals to the electrodes. For example, the processing module 42 and/or 82 provides a control signal to the drive sense circuits to enable them. The control signal allows power to be supplied to the drive sense circuits, to turn-on one or more of the components of the drive sense circuits, and/or close a switch coupling the drive sense circuits to their respective electrodes.

The method continues at step 242 where the processing module receives, from the drive-sense circuits, sensed indications regarding (self and/or mutual) capacitance of the electrodes. The method continues at step 244 where the processing module generates a capacitive image of the display based on the sensed indications. As part of step 244, the processing module stores the capacitive image in memory. The method continues at step 246 where the processing module interprets the capacitive image to identify one or more proximal touches (e.g., actual physical contact or near physical contact) of the touch screen display.

The method continues at step 248 where the processing module processes the interpreted capacitance image to determine an appropriate action. For example, if the touch(es) corresponds to a particular part of the screen, the appropriate action is a select operation. As another example, of the touches are in a sequence, then the appropriate action is to interpret the gesture and then determine the particular action.

The method continues at step 250 where the processing module determines whether to end the capacitance image generation and interpretation. If so, the method continues to step 252 where the processing module disables the drive sense circuits. If the capacitance image generation and interpretation is to continue, the method reverts to step 240.

FIG. 32 is a schematic block diagram of an example of generating capacitive images over a time period. In this example, two touches are detected at time t0 and move across and upwards through the display over times t1 through t5. The movement corresponds to a gesture or action. For instance, the action is dragging a window across and upwards through the display.

FIG. 33 is a logic diagram of an embodiment of a method for identifying desired and undesired touches using a capacitive image that is executed by processing module 42 and/or 82. The method starts are step 260 where the processing module detects one or more touches. The method continues at step 262 where the processing module determines the type of touch for each detected touch. For example, a desired touch is a finger touch or a pen touch. As a further example, an undesired touch is a water droplet, a side of a hand, and/or an object.

The method continues at step 264 where the processing module determines, for each touch, whether it is a desired or undesired touch. For example, a desired touch of a pen and/or a finger will have a known effect on the self-capacitance and mutual-capacitance of the effected electrodes. As another example, an undesired touch will have an effect on the self-capacitance and/or mutual-capacitance outside of the known effect of a finger and/or a pen. As another example, a finger touch will have a known and predictable shape, as will a pen touch. An undesired touch will have a shape that is different from the known and desired touches.

If the touch is desired, the method continues at step 266 where the processing module continues to monitor the desired touch. If the touch is undesired, the method continues at step 268 where the processing module ignores the undesired touch.

FIG. 34 is a schematic block diagram of an example of using capacitive images to identify desired and undesired touches. In this example, the desired pen touch 270 will be processed and the undesired hand touch 272 will be ignored.

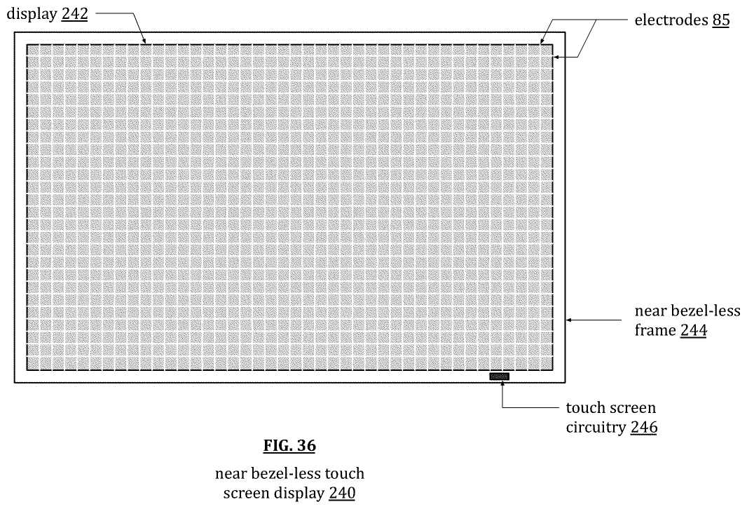

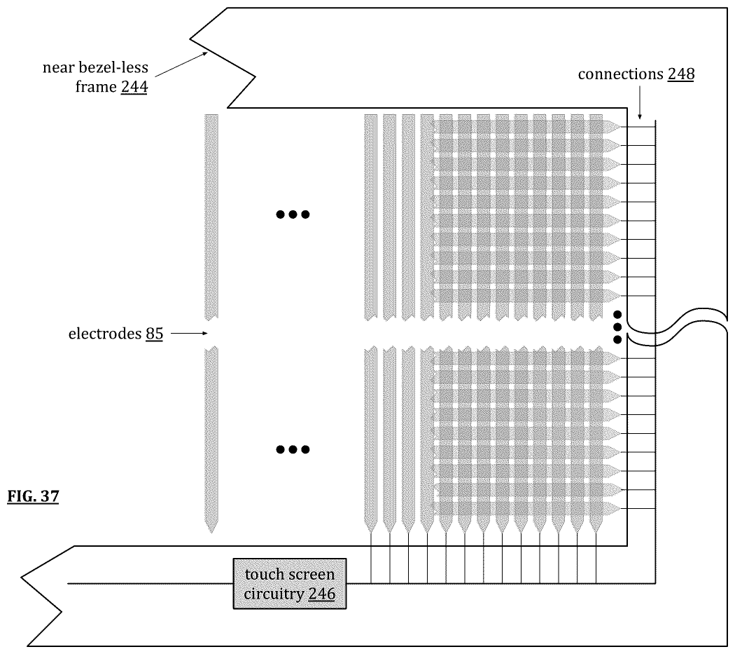

FIG. 35 is a schematic block diagram of another example of using capacitive images to identify desired and undesired touches. In this example, the desired finger touch 276 will be processed and the undesired water touch 274 will be ignored. The undesired water touch 274 would not produce a change to the self-capacitance of the effected electrodes since the water does not have a path to ground and the same frequency component is used for self-capacitance for activated electrodes.

FIG. 36 is a schematic block diagram of an embodiment of a near bezel-less touch screen display 240 that includes a display 242, a near bezel-less frame 244, touch screen circuit 246, and a plurality of electrodes 85. The touch screen display 240 is a large screen with a diagonal dimension of 32 inches or more. The near bezel-less frame 244 has a visible width with respect to the display of one inch or less. In an embodiment, the width of the near bezel-less frame 244 is 12 inch or less on two or more sides. The display 242 has properties in accordance with the table of paragraph 107.

An issue with a large display and very small bezel of the frame 244 is running leads to the electrodes 85 from the touch screen circuitry 246. The connecting leads, which are typically conventional wires, need to be located with the frame 244 or they will adversely affect the display. The larger the display, the more electrodes and the more leads that connect to them. To get the connecting leads to fit within the frame, they need to be tightly packed together (i.e., very little space between them). This creates two problems for conventional touch screen circuitry: (1) with conventional low voltage signaling to the electrodes (e.g., signals swinging from rail to rail of the power supply voltage, which is at least 1 volt and typically greater than 1.5), electromagnetic cross-coupling between the leads causing interference between the signal; and (2) the tight coupling of the leads increases the parasitic capacitance of each lead, which increases the power requirements. With conventional touch screen circuitry, the larger the screen, the more cross-coupling interference and more power is required. Because of these issues, display sizes for touch screen displays have been effectively limited to smaller display sizes (e.g., less than 32 inches).

With the touch screen circuitry 246 disclosed herein, effective and efficient large touch screen displays can be practically realized. For instance, the touch screen circuitry 246 uses very low voltage signaling (e.g., 25-250 milli-volt RMS of the oscillating component of the sensor signal or power signal), which reduces power requirements and substantially reduces adverse effects of cross-coupling between the leads. For example, when the oscillating component is a sinusoidal signal at 25 milli-volt RMS and each electrode (or at least some of them) are driven by oscillating components of different frequencies, the cross-coupling is reduced and, what cross-coupled does exist, is easily filtered out. Continuing with the example, with a 25 milli-voltage signal and increased impedance of longer electrodes and tightly packed leads, the power requirement is dramatically reduced. As a specific example, for conventional touch screen circuitry operating with a power supply of 1.5 volts and the touch screen circuitry 246 operating with 25 milli-volt signaling, the power requirements are reduced by as much as 60 times.

In an embodiment, the near bezel-less touch screen display 240 includes the display 242, the near bezel-less frame 244, electrodes 85, and the touch screen circuitry 246, which includes drive sense circuits (DSC) and a processing module. The display 242 is operable to render frames of data into visible images. The near bezel-less frame 244 at least partially encircles the display 242. In this example, the frame 244 fully encircles the frame and the touch screen circuitry 246 is positioned in the bezel area to have about the same number of electrode connections on each side of it. In FIG. 40, as will be subsequently discussed, the frame 244 partially encircles the display 242.

The drive-sense circuits are coupled to the electrodes via connections, which are substantially within the near bezel-less frame. The connections include wires and connectors, which are achieved by welds, crimping, soldering, male-female connectors, etc. The drive-sense circuits are operable to provide and monitor sensor signals of the electrodes 85 to detect impedance and impedance changes of the electrodes. The processing module processes the impedances of the electrodes to determine one or more touches on the touch screen display 240.

In the present FIG. 36, the electrodes 85 are shown in a first arrangement (e.g., as rows) and a second arrangement (e.g., as columns). Other patterns for the electrodes may be used to detect touches to the screen. For example, the electrodes span only part of the way across the display and other electrodes span the remaining part of the display. As another example, the electrodes are patterned at an angle different than 90 degrees with respect to each other.

FIG. 37 is a schematic block diagram that further illustrates an embodiment of a near bezel-less touch screen display 242. As shown, the touch screen circuit 246 is coupled to the electrodes 85 via a plurality of connectors 248. The electrodes are arranged in rows and columns, are constructive of a transparent conductive material (e.g., ITO) and distributed throughout the display 242. The larger the touch screen display, the more electrodes are needed. For example, a touch screen display includes hundreds to hundreds of thousands, or more, of electrodes.

The connections 248 and the touch screen circuitry 246 are physically located with the near bezel-less frame 244. The more tightly packed the connectors, the thinner the bezel can be. A drive sense circuit of the touch screen circuitry 246 is coupled to an individual electrode 85. Thus, if there are 10,000 electrodes, there are 10,000 drive sense circuits and 10,000 connections. In an embodiment, the connections 248 include traces on a multi-layer printed circuit board, where the traces are spaced at a few microns or less. As another example, the spacing between the connections is a minimum spacing needed to ensure that the insulation between the connections does not break down. Note that the touch screen circuitry 246 may be implemented in multiple integrated circuits that are distributed about the frame 244.

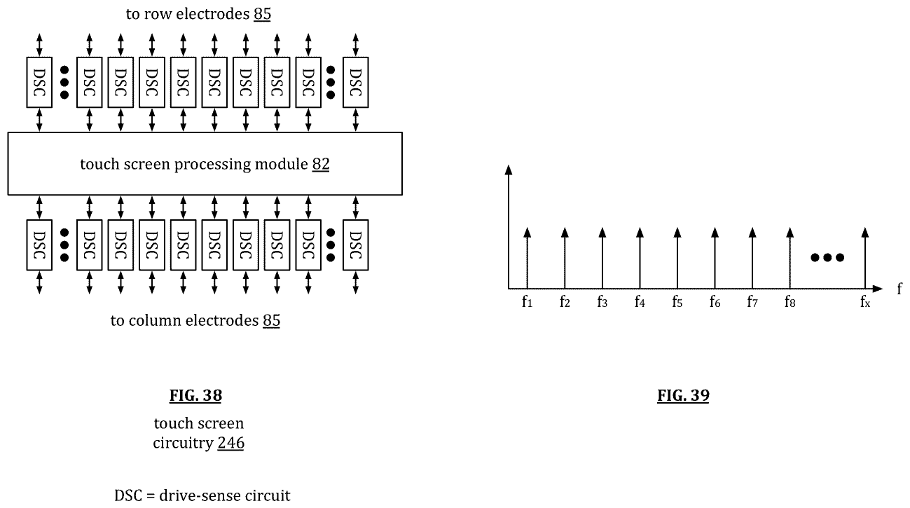

FIG. 38 is a schematic block diagram of an embodiment of touch screen circuitry 246 that includes a touch screen processing module 82 and a plurality of drive sense circuits (DSC). Some of the drive sense circuits are coupled to row electrodes and other drive sense circuits are coupled to column electrodes. The touch screen circuitry 246 may be implemented in one or more integrated circuits. For example, the touch screen processing module 82 and a certain number (e.g., a hundred to thousands) of drive sense circuits are implemented one a single die. An integrated circuit may include one or more of the dies. Thus, depending on the number of electrodes in the touch screen display, one or more dies in one or more integrated circuits is needed.

When more than a single die is used, the touch screen circuitry 246 includes more than one processing module 82. In this instance, the processing modules 82 on different dies function as peer processing modules, in that, they communicate with their own drive sense circuits and process the data from the drive sense circuits and then coordinate to provide the process data upstream for further processing (e.g., determining whether touches have occurred, where on the screen, is the touch a desired touch, and what does the touch mean). The upstream processing may be done by another processing module (e.g., processing module 42), as a distributed function among the processing modules 82, and/or by a designed processing module of the processing modules 82.

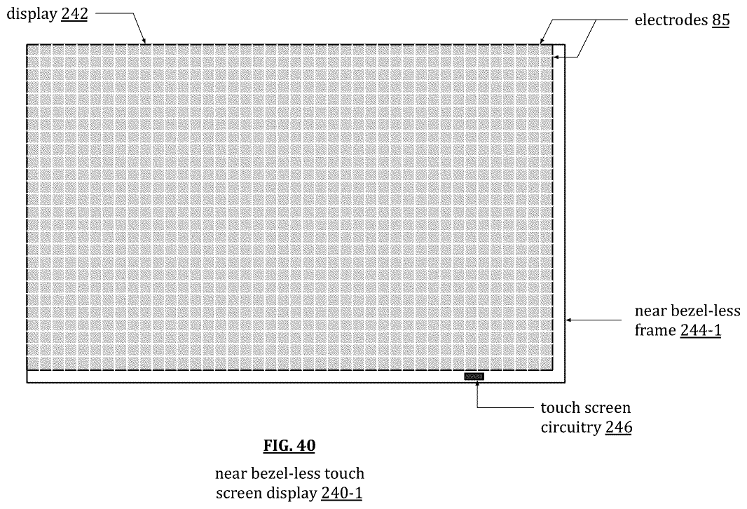

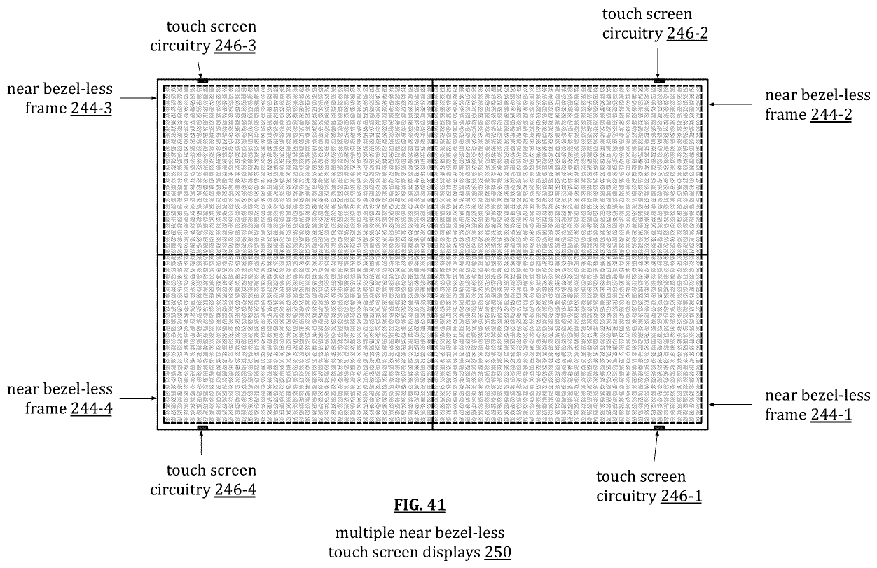

FIG. 39 is a schematic block diagram of an example of frequencies for the various analog reference signals for the drive-sense circuits. As mentioned above, to reduce the adverse effects of cross-coupling, the drive sense circuits use a common frequency component for self-capacitance measurements and uses different frequencies components for mutual capacitance measurements. In this example, there are x number of equally-spaced different frequencies. The frequency spacing is dependent on the filtering of the sensed signals. For example, the frequency spacing is in the range of 10 Hz to 10's of thousands of Hz. Note that the spacing between the frequencies does not need to be equal or that every frequency needs to be used. Further note that, for very large touch screen displays having tens to hundreds of thousands of electrodes, a frequency reuse pattern may be used.

FIG. 40 is a schematic block diagram of another embodiment of a near bezel-less touch screen display 240-1 that includes the display 242, the electrodes 85, the touch screen display circuitry 246, and a near bezel-less frame 244-1. In this embodiment, the frame 244-1 is on two sides of the display 242; the other two sides are bezel-less. The functionality of the display 242, the electrodes 85, the touch screen display circuitry 246 are as previously discussed.

FIG. 41 is a schematic block diagram of another embodiment of multiple near bezel-less touch screen displays 250 that includes a plurality of near bezel-less touch screen displays 240-1. Each of the near bezel-less touch screen displays 240-1 have two sides that are bezel-less and two sides that include a near bezel-less frame. The location of the two bezel-less sides can vary such that the displays 240-1 can be positioned to create one large multiple touch screen display 250.

In an alternate embodiment, a near bezel-less touch screen display includes three sides that are bezel-less and one side that includes a near bezel-less frame. The side having the near bezel-less frame is variable to allow different combinations of the near bezel-less touch screen displays to create a large multiple touch screen display.

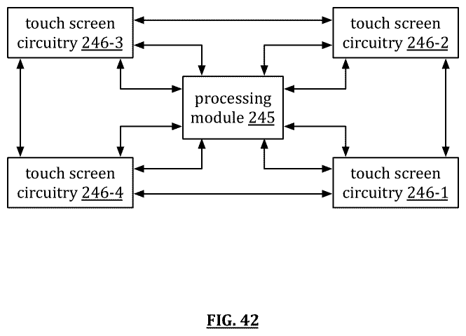

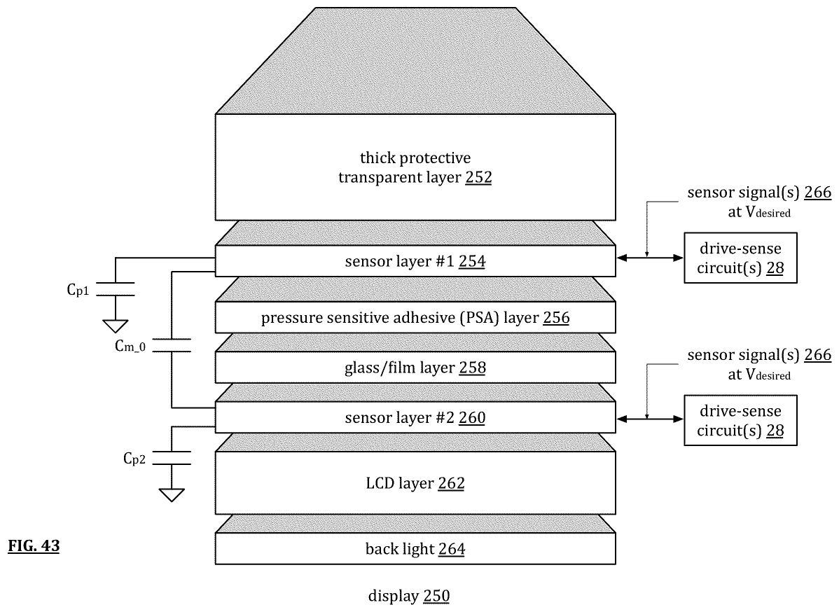

FIG. 42 is a schematic block diagram of an embodiment of the touch screen circuitry 246 and one or more processing modules for the multiple near bezel-less touch screen displays of FIG. 41. Each of the displays 240-1 includes touch screen circuitry 246-1 through 246-4, which are coupled together and to a centralized processing module 245. Each of the touch screen circuitry 246-1 through 246-4 interacts with the electrodes of its touch screen display 240-1 to produce capacitance information (e.g., self-capacitance, mutual capacitance, change in capacitance, location of the cells having a capacitance change, etc.).

The centralized processing module 245 processes the capacitance information form the touch screen circuitry 246-1 through 246-4 to determine location of a touch, or touches, meaning of the touch(es), etc. In an embodiment, the centralized processing module 245 is processing module 42. In another embodiment, the centralized processing module 245 is one of the processing modules of the touch screen circuitry 246-1 through 246-4. In yet another embodiment, the centralized processing module 245 includes two or more of the processing modules of the touch screen circuitry 246-1 through 246-4 functioning as a distributed processing module.

FIG. 43 is a cross section schematic block diagram of an example of a touch screen display 80 having a thick protective transparent layer 252. The display 80 further includes a first sensor layer 254, one or more pressure sensitive adhesive (PSA) layers 256, a glass/film layer 258, a second sensor layer 260, an LCD layer 262, and a back-light layer 264. A first group of drive sense circuits 28 is coupled to the first sensor layer 254 and a second group of drive sense circuits 28 is coupled to the second sensor layer 260.

The thick protective transparent layer 252 includes one or more layers of glass, film, etc. to protect the display 250 from damaging impacts (e.g., impact force, impact pressure, etc.). In many instances, the thicker the protective transparent layer 252 is, the more protection it provides. For example, the protective transparent layer 252 is at least a ¼ inch thick and, in some applications, is thicker than 1 inch or more.

The protective transparent layer 252 acts as a dielectric for finger capacitance and/or for pen capacitance. The material, or materials, comprising the protective transparent layer 252 will have a dielectric constant (e.g., 5-10 for glass). The capacitance (finger or pen) is then at least partially based on the dielectric constant and thickness of the protective transparent layer 252. In particular, the capacitance (C) equals:

$$C = ϵ \frac{A}{d}$$

where A is plate area, ϵ is the dielectric constant(s), and d is the distance between the plates, which includes the thickness of the protective layer 252.

As such, the thicker the protective transparent layer, the smaller the capacitance (finger and/or pen). As the capacitance decreases, its effect on the self-capacitance of the sensor layers and the effect on the mutual capacitance between the sensor layer is reduced. Accordingly, the drive sense circuits 28 provide the sensor signals 266 at a desired voltage level, which increases as the finger and/or pen capacitance decreases due to the thickness of the protective transparent layer 252. In an embodiment, the first sensor layer includes a plurality of column electrodes, and the second sensor layer includes a plurality of row electrodes.

There are a variety of ways to implement a touch sensor electrode. For example, the sensor electrode is implemented using a glass-glass configuration. As another example, the sensor electrode is implemented using a glass-film configuration. Other examples include a film-film configuration, a 2-sided film configuration, a glass and 2-sided film configuration, or a 2-sided glass configuration.

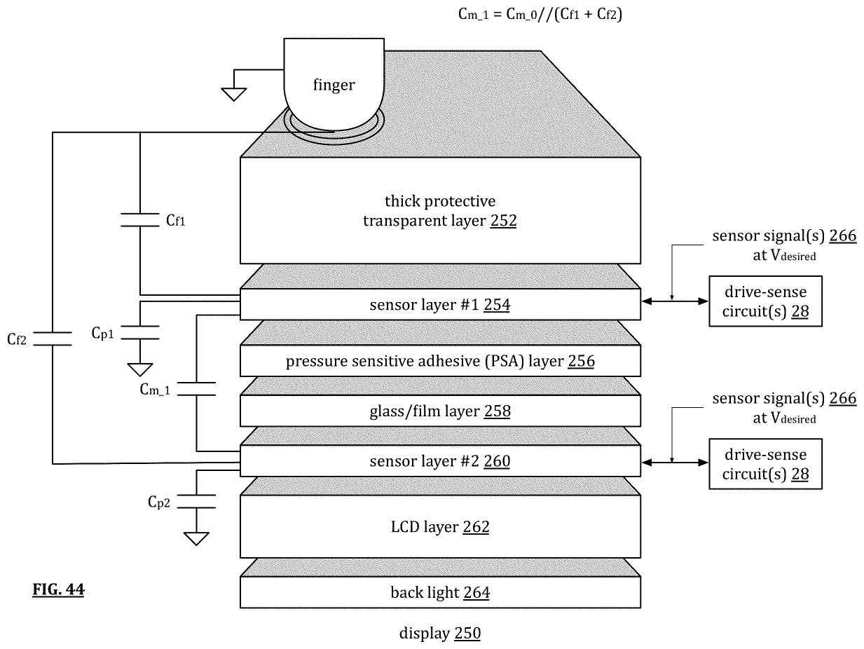

FIG. 44 is a cross section schematic block diagram that is similar to FIG. 43, with the exception that this figure includes a finger touch. The finger touch provides a finger capacitance with respect the sensor layers 254 and 260. As is shown, the finger capacitance includes a first capacitance component from the finger to the first sensor layer (C_{f1}) and a second capacitance component from the finger to the second sensor layer (C_{f2}). As previously discussed, the finger capacitance is effectively in parallel with the self-capacitances (Cₚ₀ and Cₚ₁) of the sensor layers, which increases the effective self-capacitance and decreases impedance at a given frequency. As also previously discussed, the finger capacitance is effectively in series with the mutual-capacitance (C_{m_0}) of the sensor layers, which decreases the effective mutual-capacitance (C_{m_1}) and increases impedance at a given frequency.

Thus, the smaller the finger capacitance due to a thicker protective layer 252, the less effect it has on the self-capacitance and mutual-capacitance. This can be better illustrated with reference to FIGS. 45-50.

FIG. 45 is a schematic block diagram of an electrical equivalent circuit of two drive sense circuits coupled to two electrodes without a finger touch. The drive sense circuits are represented as dependent current sources, the self-capacitance of a first electrode is referenced as Cₚ₁, the self-capacitance of the second electrode is referenced as Cₚ₂, and the mutual capacitance between the electrodes is referenced as C_{m_0}. In this example, the current source of the first drive sense circuit is providing a controlled current (I at f1) that includes a DC component and an oscillating component, which oscillates at frequency f1. The current source of the second drive sense circuit is providing a controlled current (I at f1 and at f2) that includes a DC component and two oscillating components at frequency f1 and frequency f2.

The first controlled current (I at f1) has one component: i1_{Cp1} and the second controlled current (I at f1 and f2) has two components: i1+2_{Cp2} and i2_{cm_0}. The current ratio between the two components for a controlled current is based on the respective impedances of the two paths.

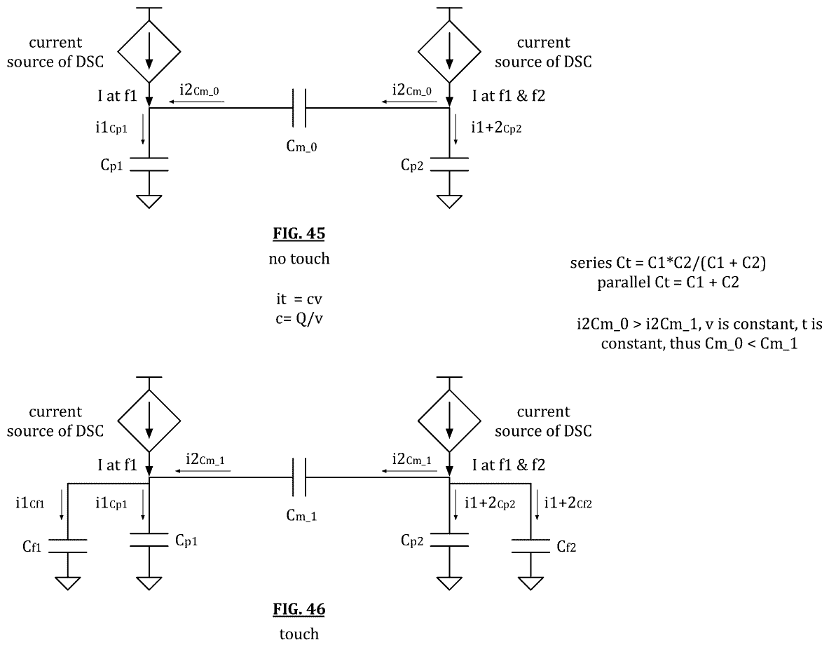

FIG. 46 is a schematic block diagram of an electrical equivalent circuit of two drive sense circuits coupled to two electrodes as shown in FIG. 45, but this figure includes a finger touch. The finger touch is represented by the finger capacitances (C_{f1} and C_{f2}), which are in parallel with the self-capacitance (Cₚ₁ and Cₚ₂). The dependent current sources are providing the same levels of current as in FIG. 45 (I at f1 and I at f1 and f2).

In this example, however, more current is being directed towards the self-capacitance in parallel with the finger capacitance than in FIG. 45. Further, less current is being directed towards the mutual capacitance (C_{m_1}) (i.e., taking charge away from the mutual capacitance, where C=Q/V). With the self-capacitance effectively having an increase in capacitance due to the finger capacitance, its impedance decreases and, with the mutual-capacitance effectively having a decrease in capacitance, its impedance increases.

The drive sense circuits can detect the change in the impedance of the self-capacitance and of the mutual capacitance when the change is within the sensitivity of the drive sense circuits. For example, V=I*Z, I*t=C*V, and Z=½πfC (where V is voltage, I is current, Z is impedance, t is time, C is capacitance, and f is the frequency), thus V=I*½πfC. If the change between C is small, then the change in V will be small. If the change in V is too small to be detected by the drive sense circuit, then a finger touch will go undetected. To reduce the chance of missing a touch due to a thick protective layer, the voltage (V) and/or the current (I) can be increased. As such, for small capacitance changes, the increased voltage and/or current allows the drive sense circuit to detect a change in impedance. As an example, as the thickness of the protective layer increases, the voltage and/or current is increased by 2 to more than 100 times.

FIG. 47 is a schematic block diagram of an electrical equivalent circuit of a drive sense circuit coupled to an electrode without a finger touch. This is similar to FIG. 45, but for just one drive sense circuit and one electrode. Thus, the current source of the first drive sense circuit is providing a controlled current (I at f1) that includes a DC component and an oscillating component, which oscillates at frequency f1, and the first controlled current (I at f1) has two components: i1_{Cp1} and i1_{Cf1}.

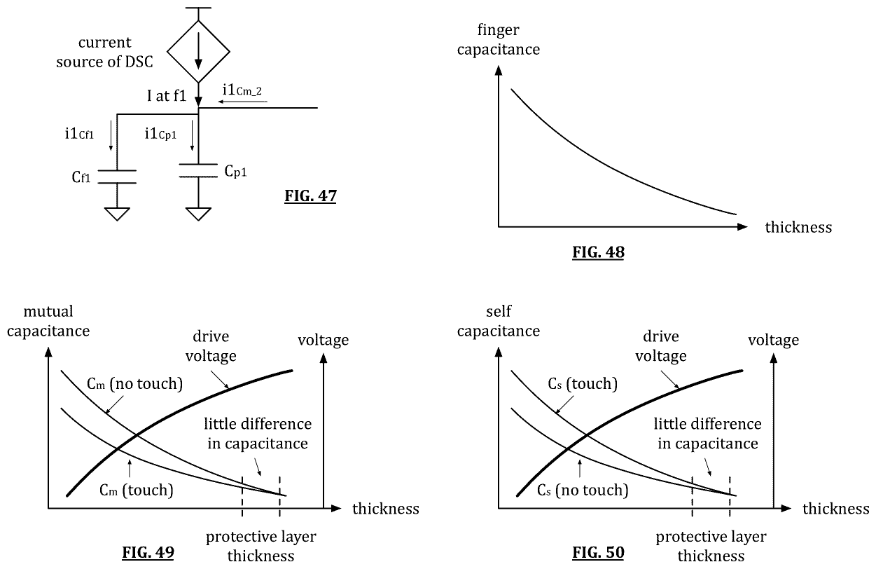

FIG. 48 is an example graph that plots finger capacitance verses protective layer thickness of a touch screen display 250. As shown, as the thickness increases, the finger capacitance decreases. This effects changes in the mutual-capacitance as shown in FIG. 49 and in self-capacitance as shown in FIG. 50.

FIG. 49 is an example graph that plots mutual capacitance verses protective layer thickness and drive voltage verses protective layer thickness of a touch screen display 150. As shown, as the thickness increases, the difference between the mutual capacitance without a touch and mutual capacitance with a touch decreases. In order for the decreasing difference to be detected, the voltage (or current) sourced to the electrode increases substantially inversely proportion to the decrease in finger capacitance.

FIG. 50 is an example graph that plots self-capacitance verses protective layer thickness and drive voltage verses protective layer thickness of a touch screen display 150. As shown, as the thickness increases, the difference between the self-capacitance without a touch and self-capacitance with a touch decreases. In order for the decreasing difference to be detected, the voltage (or current) sourced to the electrode increases substantially inversely proportion to the decrease in finger capacitance.

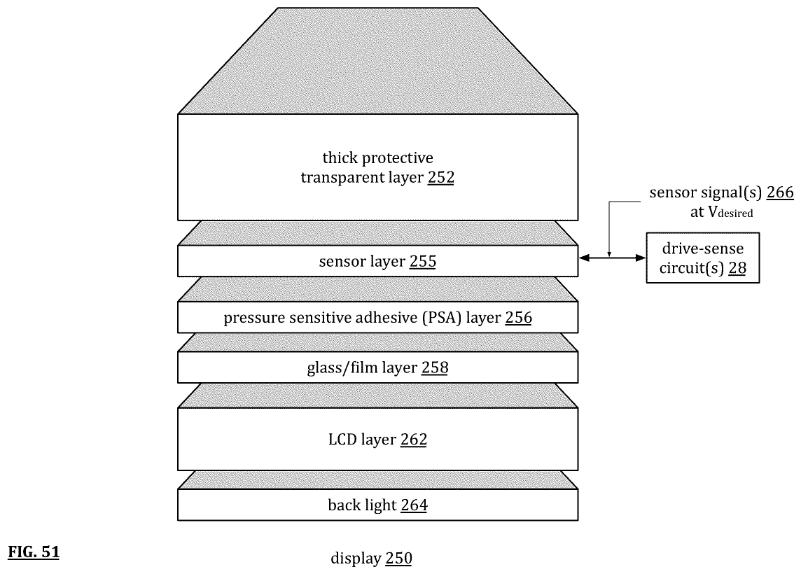

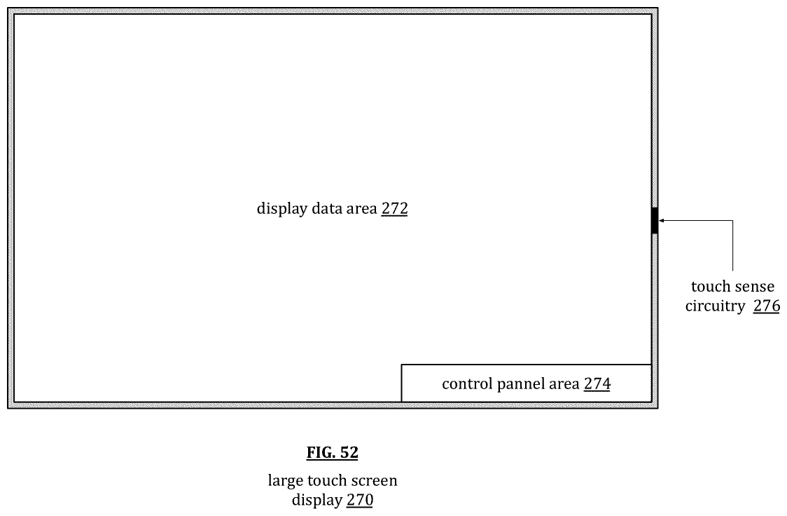

FIG. 51 is a cross section schematic block diagram of another example of a touch screen display 250 having a thick protective transparent layer 252. This embodiment is similar to the embodiment of FIG. 43 with the exception that this embodiment includes a single sensor layer 255. The sensor layer 255 may be implemented in a variety of ways. For example, the sensor layer 255 includes a plurality of capacitor sensors. As another example, the sensor layer includes a voltage applied to the corners of the layer to detect touches (i.e., surface capacitance touch sensor).

FIG. 52 is a schematic block diagram of an embodiment of a large touch screen display 270 with an on-screen control panel area 274, a display data area 272, and touch sense circuitry 276. The display 270 has properties in accordance with the table of paragraph 107 and has a variety of applications. For example, the large touch screen display 270 is utilized as a touch screen white board. As another example, the large touch screen display is used as a menu for selecting a variety of service options and/or shopping options at a service center (e.g., a store, a mall, etc.).

The control panel area 274 is a virtual control panel and may be located anywhere on the display 270. When the control panel is active, it appears in the control panel area 274 and provides for a variety of control functions, which include, but are not limited to, store, change colors, change an application, start, stop, pause, fast-forward, highlight, etc. When the control panel is not active, the control panel area 274 becomes part of the display area.

The display data area 272 displays frames of data. The frames of data include frames of a video, independent frames of images, jump from one image to another, white board drawings, each edit creates a new frame, time interval of data capture on white board for a frame of data, have a background for white board, etc.

The touch screen circuitry 276 is physically positioned in the bezel area of the display 270 (i.e., in the frame). The touch screen circuitry 276, and its physical position in the bezel area of the display, are as previously discussed with reference to one or more of FIGS. 36-42.

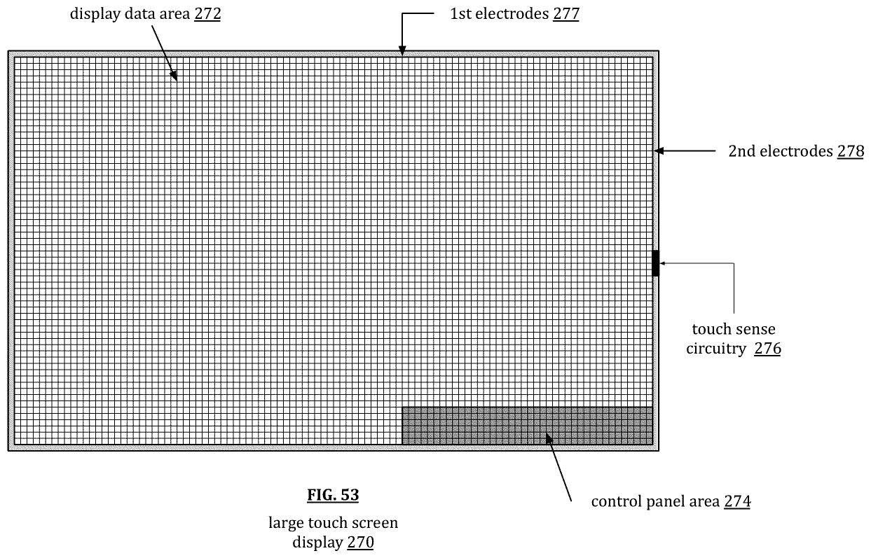

FIG. 53 is a schematic block diagram of another embodiment of a large touch screen display 270 with an on-screen control panel area 274, the display data area 272, the touch screen circuitry 276, a first plurality of electrodes 277, and a second plurality of electrodes 278. The electrodes 277 are arranged in a first orientation (e.g., as columns) throughout the display 270 and electrodes 278 are arranged in a second orientation (e.g., as rows) throughout the display 270.

The touch sense circuitry 276 includes first drive sense circuits, second drive sense circuits, and a processing module. The first drive-sense circuits provide a first sensor signals to the first electrodes 277 and generate therefrom first sensed signals. The second drive-sense circuits provide second sensor signals to the second electrodes 278 and generate therefrom second sensed signals. The processing module receives the first and second sensed signals to determine one or more touches of the display 270.

In a control mode (e.g., the control panel area is activated), the processing module creates display data and control panel data and produce, therefrom, a frame of data. The display data is created to be displayed in the display data area 272 and the control panel data is to be simultaneously displayed in the control panel area 274. The processing module associates a first group of row and column electrodes with the control panel data area. The processing module interprets receive signals components of the sensors signals of the control panel electrodes to identify a proximal touch of the control panel data area and executed a corresponding function and/or command.

The processing module associates a second group of column and row electrodes with the display data area. The processing module interprets receive signals components of the sensors signals of the second group of electrodes to identify a proximal touch within the display data area. Note that the rendering of data in the display data area, rendering of data in the control panel area, sensing a touch in the display data area, sensing a touch in the control panel area, executing a command and/or function associated with a touch in the display data area, and/or executing a control function associated with a touch in the control panel area are done currently. As such, there is no alternating operation between sensing a touch and displaying data.

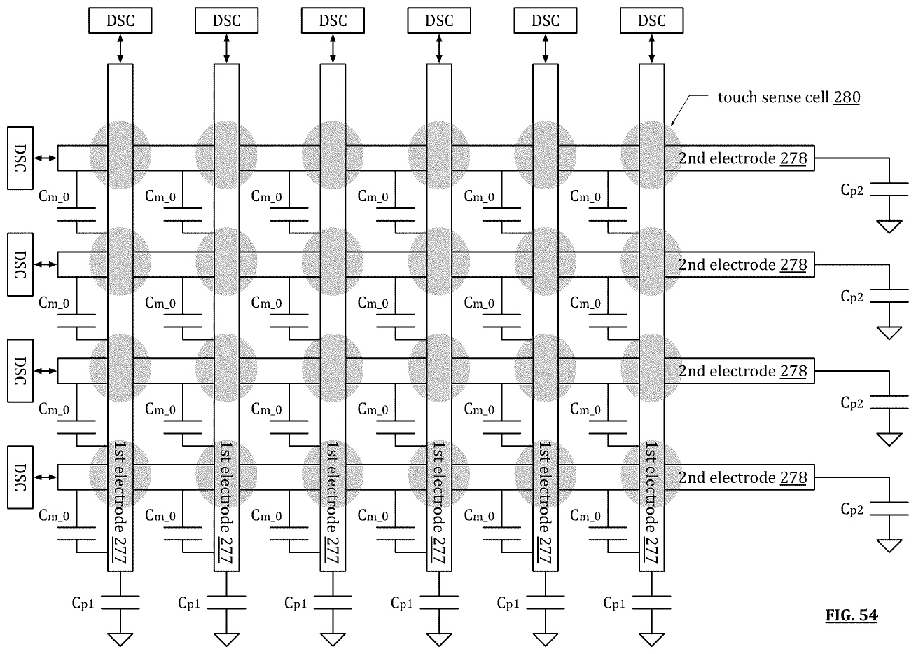

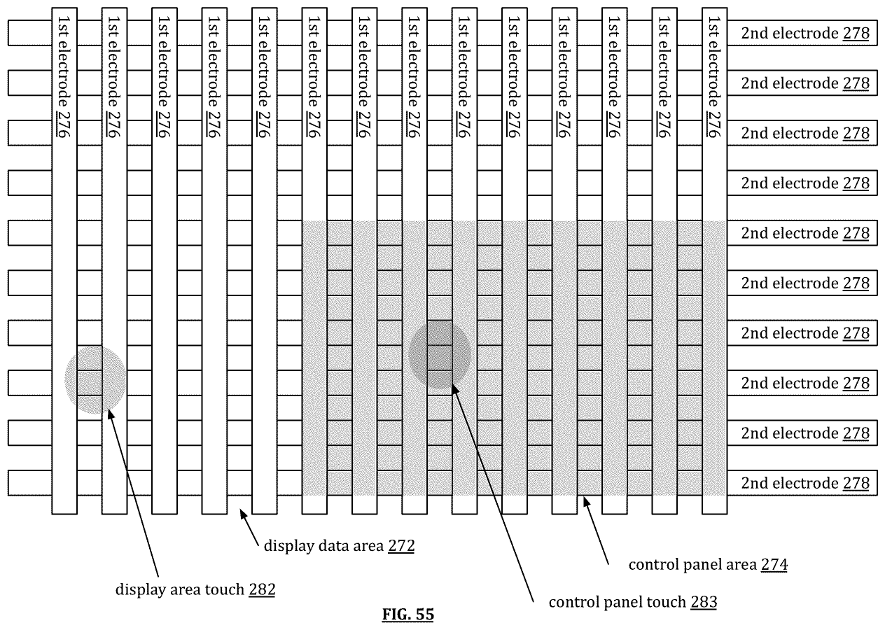

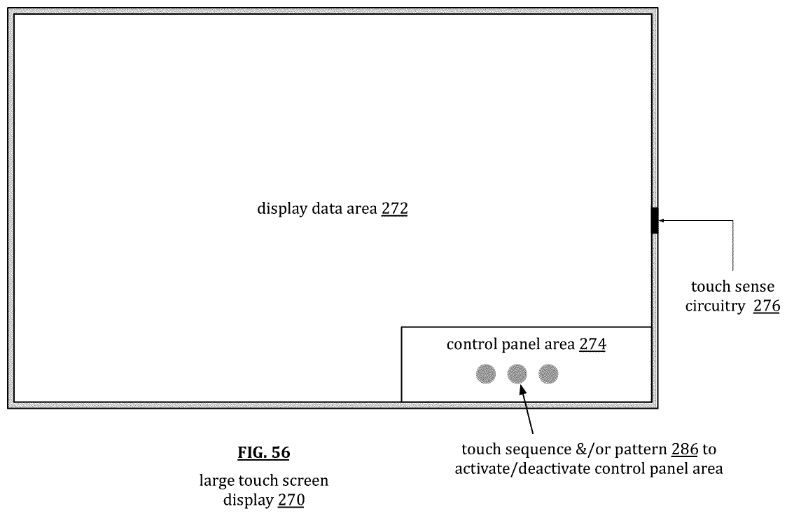

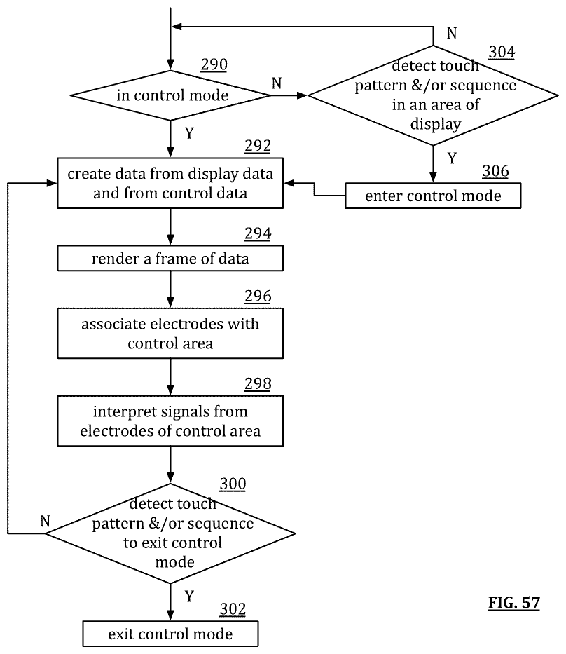

FIG. 54 is a schematic block diagram of an embodiment of a plurality of electrodes creating a plurality of touch sense cells 280 within a display. In this embodiment, a few second electrodes 278 are perpendicular and on a different layer of the display than a few of the first electrodes 277. For each crossing of a first electrode and a second electrode, a touch sense cell 280 is created. At each touch sense cell 280, a mutual capacitance (C_{m_0}) is created between the crossing electrodes. Each electrode also includes a self-capacitance (Cₚ), which is shown as a single parasitic capacitance, but, in some instances, is a distributed R-C circuit.

A drive sense circuit (DSC) is coupled to a corresponding one of the electrodes. The drive sense circuits (DSC) provides sensor signals to the electrodes and determines the loading on the sensors signals of the electrodes. When no touch is present, each touch cell 280 will have a similar mutual capacitance and each electrode of a similar length will have a similar self-capacitance. When a touch is applied on or near a touch sense cell 280, the mutual capacitance of the cell will decrease (creating an increased impedance) and the self-capacitances of the electrodes creating the touch sense cell will increase (creating a decreased impedance). Between these impedance changes, the processing module can detect the location of a touch, or touches.

FIG. 55 is a similar diagram to FIG. 54 with the exceptions that some of the first and second electrodes are within the control panel area 274, other electrodes are in the display data area 272, there is a touch 282 in the display data area, and there is a touch 283 in the control panel area. In this example, the touches are determined by the decreased mutual capacitance of the nearby touch sense cells and by the increased self-capacitance of the effect electrodes. The processing module, knowing which electrodes and hence which touch sense cells are part of the control panel area 274, can readily determine that touch 283 is in the control panel area and that touch 282 is in the display data area 272.

FIG. 56 is a schematic block diagram of an example of activating or deactivating an on-screen control panel on a large touch screen display 270. As in FIG. 52, the display 270 includes the display data area 272, the control panel area 274, and the touch sense circuitry 276. In this example, a touch sequence and/or a touch pattern 286 within the control panel area 274 is used to activate and/or deactivate the control panel. As a specific example, a three-finger touch making an X or a plus sign is the pattern to activate and/or deactivate the control panel. As another specific example, four consecutive touches in the same position on the display is a sequence to activate and/or deactivate the control panel. In an alternate embodiment, any area of the display is useable to activate and/or deactivate the control panel.

FIG. 57 is a logic diagram of an example of utilizing an on-screen control panel of a large touch screen display that is executable by a processing module (e.g., 42 and/or 82). The method begins at step 190 where the processing module determines whether the display 270 is in a control mode (e.g., the control panel is enabled and is visible within the control panel area). If not, the method continues at step 304 where the processing module determines whether a unique touch pattern and/or sequence is detected on the display. If not, the method repeats at step 290.

If the unique touch pattern and/or sequence is detected, the method continues at step 306 where the processing module enters the control mode. In the control mode, the method continues at step 292 where the processing module generates display data and control data. The method continues at step 294 where the processing module generates one or more frames of data from the display data and the control data.

The method continues at step 296 where the processing module associates electrodes with the display data area and the control panel area. The method continues at step 298 where the processing module interprets signals from drive sense circuits coupled to the electrodes that are associated with the control panel area. When a touch is detected in the control panel area, the processing module processes it as a control function or command. When a touch is detected in the display data area, the processing module processes it as a data function or command. For example, the control panel area functions like a mouse or touch pad.

The method continues at step 300 where the processing module determines whether a touch pattern and/or sequence is detected to exit the control mode. If not, the method repeats at step 292. If an exit pattern and/or sequence is detected, the method continues at step 302 where the processing module exits the control mode. When not in the control mode, the entire display is treated as part of the display data area.

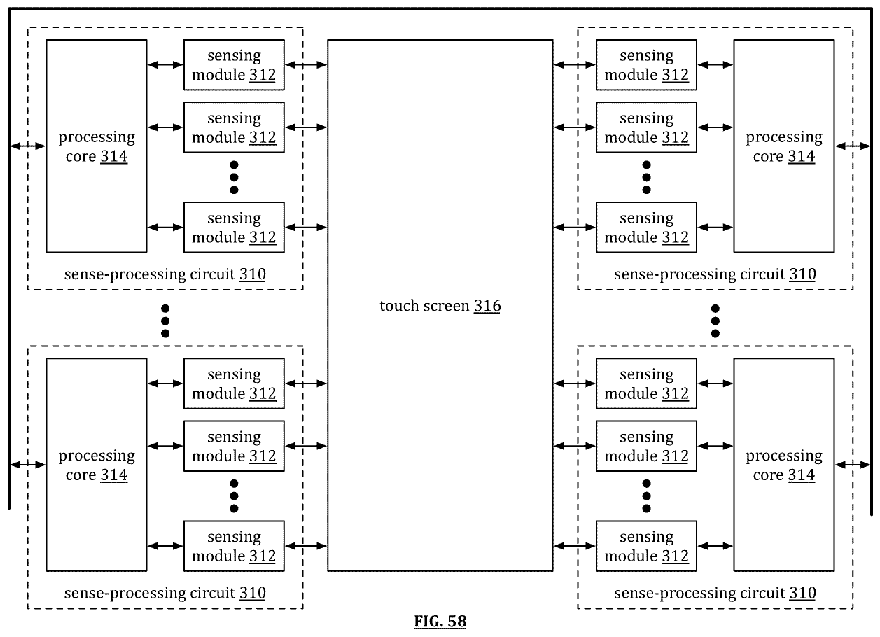

FIG. 58 is a schematic block diagram of an embodiment of a scalable touch screen display that includes a touch screen 316 and a plurality of sense-processing circuits 310. A sense-processing circuit 310 includes a plurality of sensing modules 312 and a processing core 314. The touch screen 316 includes a plurality of electrodes (e.g., rows and columns) that are in-cell and/or on-cell with a display.

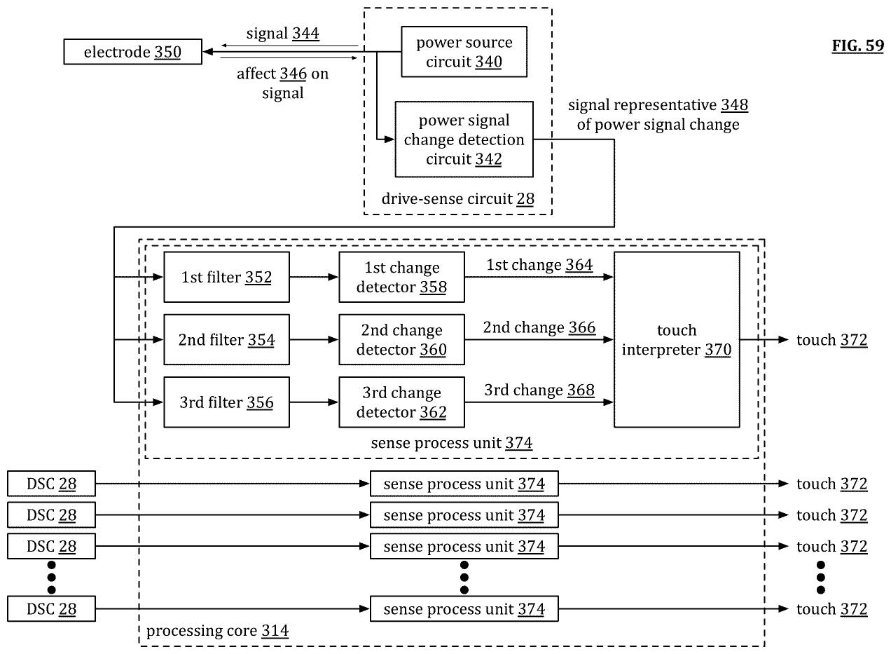

The sensing modules 312 of each of the sense-processing circuits 310 is coupled to an electrode, or sensor, of the touch screen 316. The processing cores 314 are coupled together via a wired and/or wireless communication bus. Specific embodiments of the sensing modules and the processing cores will be described in greater detail with reference to FIG. 59.

A sense-processing circuit 310 includes a number of sensing modules 312 (e.g., from less than 100 to more than 1,000). Each sense-processing circuit 310 is identical, thus making scaling for large scale touch screen displays commercially viable. For instance, a sense-processing circuit 310 is implemented on a die. An integrated circuit (IC) includes one or more of the sense-processing circuit dies. As such, one or more ICs with one or more dies can be used to provide the touch sense circuitry of a display.

FIG. 59 is a schematic block diagram of an embodiment of a sense-processing circuit 310 that includes a drive sense circuit 28 as a sensing module 312 and a sense process unit 314 implemented within the processing core 314. The processing core 314 includes a processing module, memory, and a communication interface. The communication interface allows the processing core to communicate with other processing cores and/or with processing modules (e.g., 42) of the display and/or of a computing device. For example, the communication interface is one of a PCI connection, a USB connection, a Bluetooth connection, etc.

The drive sense circuit 28 includes a power source circuit 340 and a power signal change detection circuit 342. The power source circuit 340 is operably coupled to the electrode 350 and, when enabled (e.g., from a control signal from the processing core, power is applied, a switch is closed, a reference signal is received, etc.) provides a signal 344 to the electrode 350. The power source circuit 340 may be a voltage supply circuit (e.g., a battery, a linear regulator, an unregulated DC-to-DC converter, etc.) to produce a voltage-based power signal, a current supply circuit (e.g., a current source circuit, a current mirror circuit, etc.) to produce a current-based power signal, or a circuit that provide a desired power level to the sensor and substantially matches impedance of the sensor. The power source circuit 340 generates the signal 344 to include a DC (direct current) component and/or an oscillating component.

When receiving the signal 344, the impedance of the electrode affects 346 the signal. When the power signal change detection circuit 342 is enabled, it detects the impedance effect 346 on the signal. For example, the signal is a 1.5 voltage signal and, when there is no touch, the electrode draws 1 micro-amp of current, which corresponds to an impedance of 1.5 M Ohms. When a touch is present, the signal remains at 1.5 volts and the current increases to 1.5 micro-amps. As such, the impedance of the electrode changed from 1.5 M Ohms to 1 M Ohms. The power signal change detection circuit 112 determines this change and generates a representative signal 348 of the change to the power signal.

The processing core 314 is configured to include, for each sense process unit 374, a first filter 352, a second filter 354, a third filter 356, a first change detector 358, a second change detector 360, a third change detector 362, and a touch interpreter 370. The first filter 352 is operable to produce a first filtered signal of the signal 348 representation corresponding to self-capacitance of the sensed electrode. The second filter 354 produces a second filtered signal of the signal 348 representation corresponding to mutual capacitance of the sensed electrode. The third filter produces a third filtered signal of the signal 348 representation corresponding to a pen touch of the sensed electrode.

The first change detector 358 determines whether the self-capacitance of the sensed electrode has changed to produce a first change 364. The second change detector 360 determines whether the mutual-capacitance of the sensed electrode has changed to produce a second change 366. The third change detector 362 determines whether the pen-capacitance of the sensed electrode has changed to produce a third change 368.

The touch interpreter 372 determines whether the sensed electrode is experiences a touch based on the first, second, and or third changes. For example, if the touch interpreter 372 determines that the self-capacitance of the sensed electrode has increased, the touch interpreter 372 indicates that the sensed electrode is affected by a touch (e.g., a finger touch). As another example, if the touch interpreter 372 determines that the mutual-capacitance of the sensed electrode has decreased, the touch interpreter 372 indicates that the sensed electrode is affected by a touch (e.g., a finger touch). As yet another example, if the touch interpreter 372 determines that the pen-capacitance of the sensed electrode has increased, the touch interpreter 372 indicates that the sensed electrode is affected by a pen touch.

The other drive-sense circuits 28 in combination with the other sense processing units 374 function as described above for their respective electrodes. The processing core 314 provides the touch information 372 to a processing module, to another sense-processing circuit 310, and/or to itself for further processing to equate the touch information to a particular location on the display and meaning of the touch.

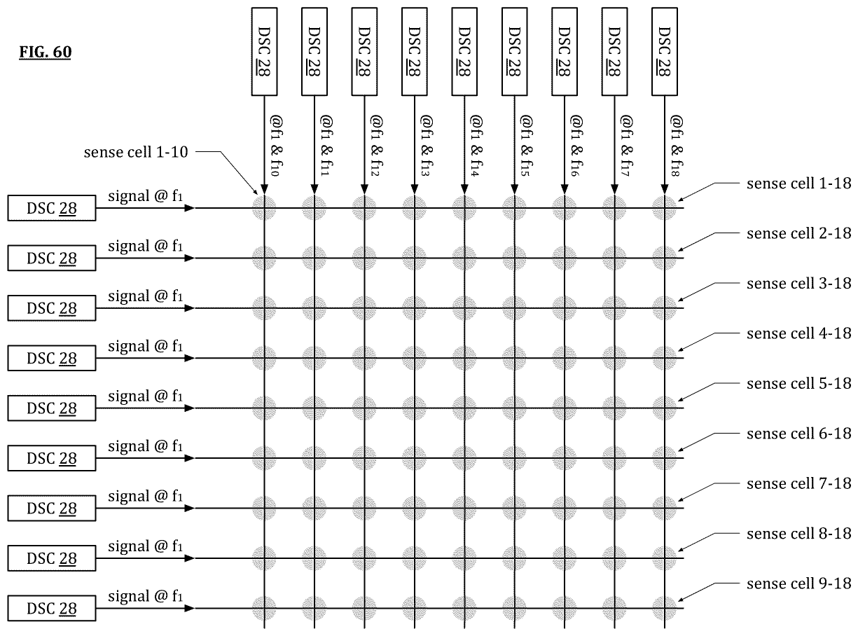

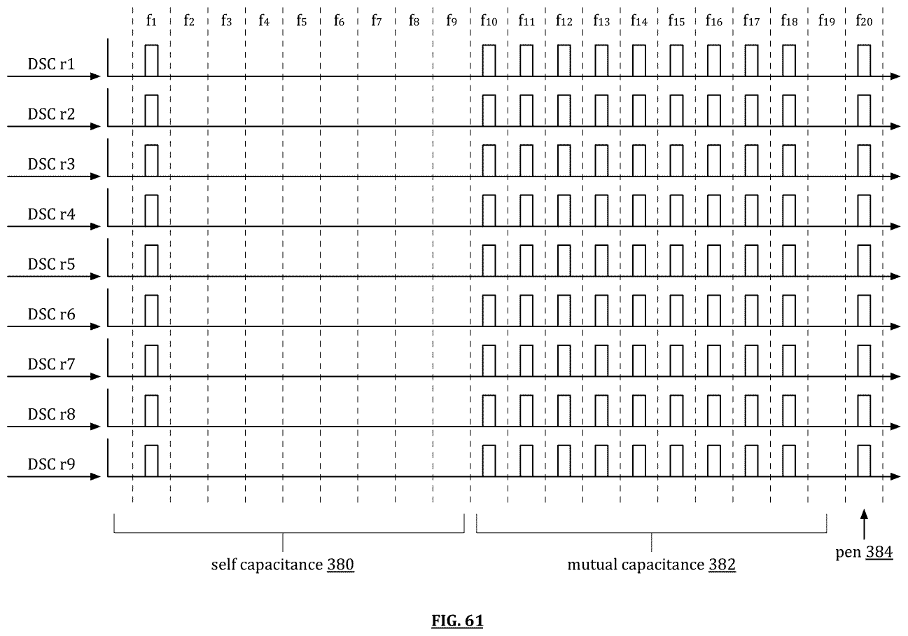

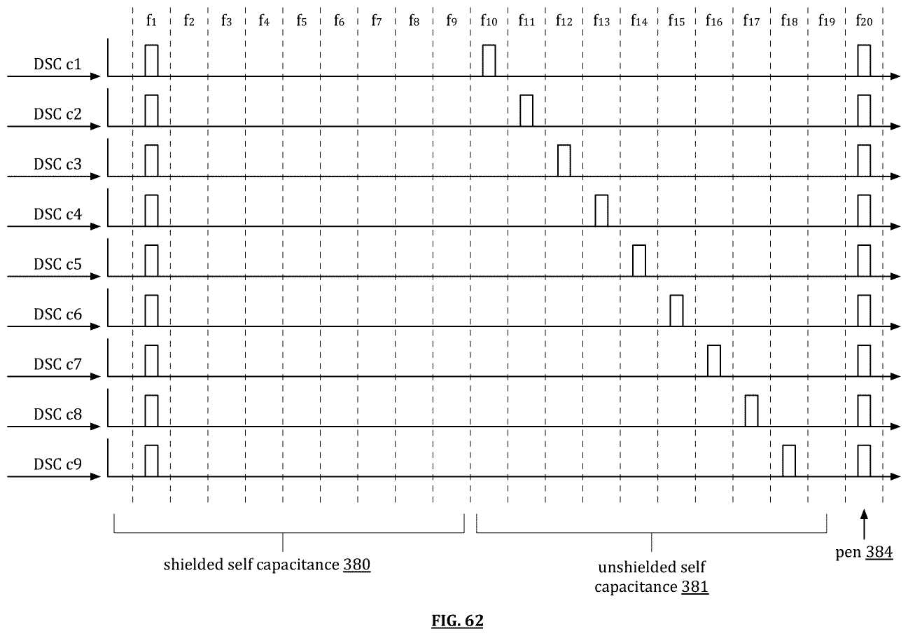

FIG. 60 is a schematic block diagram of an example of frequency dividing for reference signals for drive-sense circuits 28 of a touch screen display. In this example, a few row electrodes and a few column electrodes are shown. Each electrode is coupled to a drive sense circuit (DSC) 28. The crossover of a row electrode with a column electrode creates a sense cell. In this example, there are nine row electrodes and nine column electrodes, creating 81 sense cells. To allow for simultaneous self-capacitance sensing and mutual sensing of the electrodes, the drive sense circuits use different frequencies to simulate the electrodes.

For self-capacitance, all of the drive sense circuits use the f₁ frequency component. This creates near zero potential difference between the electrodes, thereby eliminating cross coupling between the electrodes. In this manner, the self-capacitance measurements made by the drive sense circuits are effectively shielded (i.e., low noise, yielding a high signal to noise ratio).

For mutual capacitance, the column electrodes also transmit a frequency component at another frequency. For example, the first column DSC 28 transmits it signal with frequency components at f1 and at f10; the second column DSC 28 transmits it signal with frequency components at f1 and at f11; the third column DSC 28 transmits it signal with frequency components at f1 and at f12; and so on. The additional frequency components (f10-f18) allow the row DSCs 28 to determine mutual capacitance at the sense cells.

For example, the first row DSC 28 senses its self-capacitance via its transmitted signal with the f₁ frequency component and determines the mutual capacitance of the sense cells 1-10, 1-11, 1-12, 1-13, 1-14, 1-15, 1-16, 1-17, and 1-18. As a specific example, for sense cell 1-10, the first row DSC 28 determines the mutual capacitance between the first row electrode and the first column electrode based on the frequency f10; determines the mutual capacitance between the first row electrode and the second column electrode based on the frequency f11; determines the mutual capacitance between the first row electrode and the third column electrode based on the frequency f12; and so on.

FIG. 61 is a schematic block diagram of an example of bandpass filtering for the frequency dividing of the reference signals for drive-sense circuits affiliated with the row electrodes of FIG. 60. In this example, the filtering in the sense process unit 374 of the processing core 314 affiliated with the row drive sense circuits has bandpass filters to detect signals at f₁, f10-f18, and f20 384 (f₁ for self-capacitance, f10-f18 for mutual capacitance, and f20 for a pen transmit signal).

As shown, frequency f₁ corresponds to the self-capacitance 380 of the row electrodes and frequencies f10-f18 correspond to mutual capacitance 382 of the row electrodes and their corresponding intersecting column electrodes. With concurrent sensing of self-capacitance and mutual capacitance, multiple touches are detectable with a high degree of accuracy.

FIG. 62 is a schematic block diagram of another example of bandpass filtering for the frequency dividing of the reference signals for drive-sense circuits affiliated with the column electrodes of FIG. 60. In this example, the filtering in the sense process unit 374 of the processing core 314 affiliated with the drive sense circuits has bandpass filters to detect signals at f1-f9, f10, and f20 384 (for a pen transmit signal).

As shown, frequency f1 corresponds to the shielded self-capacitance 380 of the column electrodes and frequencies f10-f18 correspond to unshielded self-capacitance 381 of the column electrodes. With concurrent sensing of self-capacitance and mutual capacitance, multiple touches are detectable with a high degree of accuracy. Note that there are a variety of combinations for sensing and filtering based on FIGS. 60-62. For example, only self-capacitance of the electrodes could be used to detect location of touches. As another example, the column DCSs could sense and processing the mutual capacitance. As another example, the unshielded self-capacitance is processed to determine levels of interference between the electrodes.

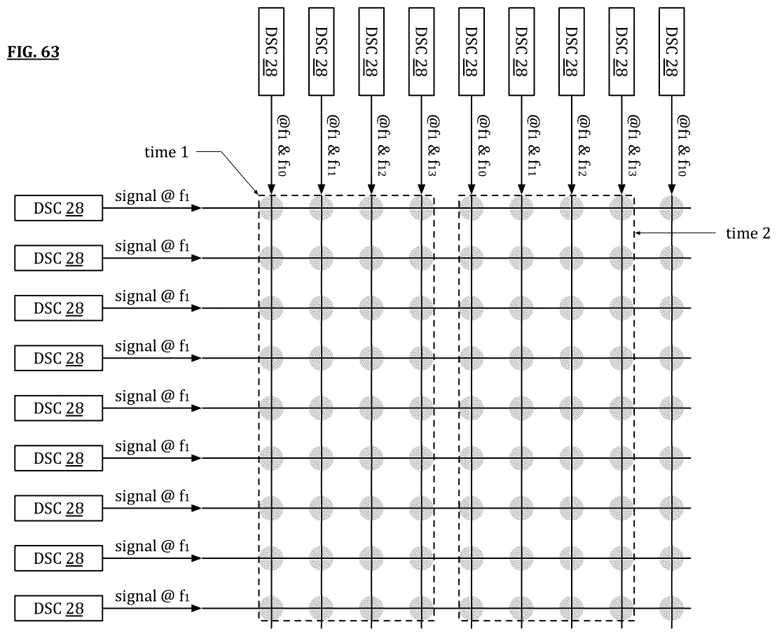

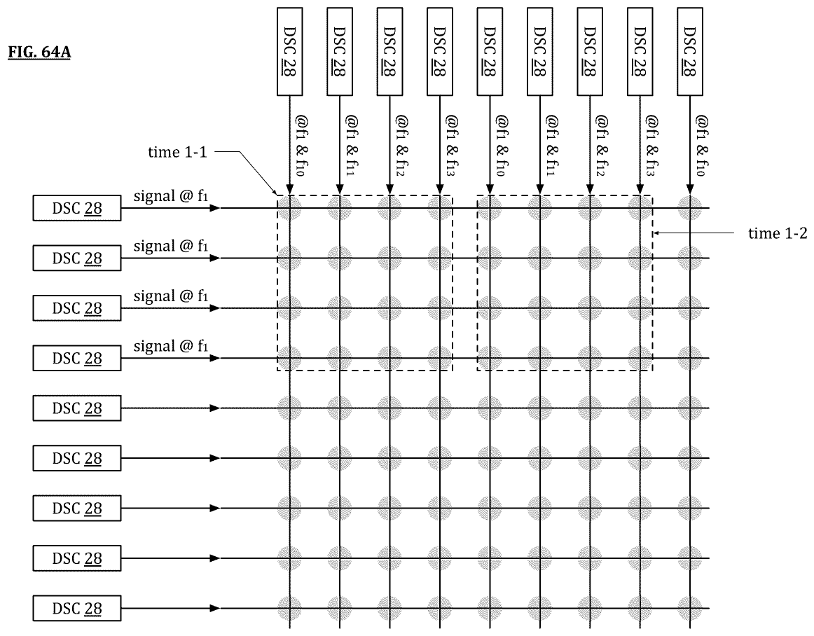

FIG. 63 is a schematic block diagram of an example of frequency and time dividing for reference signals for drive-sense circuits 28 of a touch screen display. In this example, a few row electrodes and a few column electrodes are shown. Each electrode is coupled to a drive sense circuit (DSC) 28. The crossover of a row electrode with a column electrode creates a sense cell. In this example, there are nine row electrodes and nine column electrodes, creating 81 sense cells. To allow for time-frequency division self-capacitance sensing and mutual sensing of the electrodes, the drive sense circuits affiliated with column electrodes use the same frequency f1 for self-capacitance and use a set of different frequencies (f10-f13) at different times (time 1, time 2) for mutual capacitance. The drive sense circuits affiliated with row electrodes use the same frequency (f1) for each of the different times.

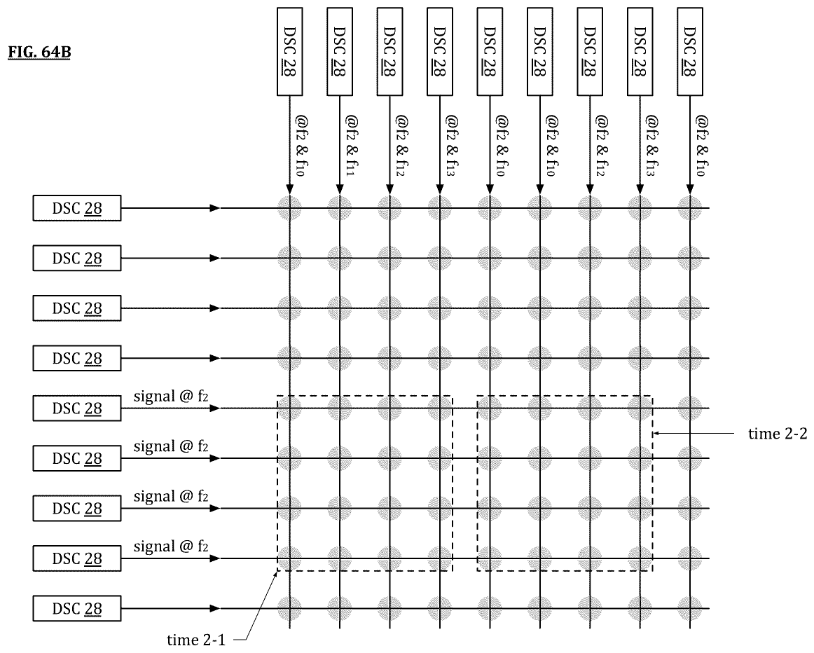

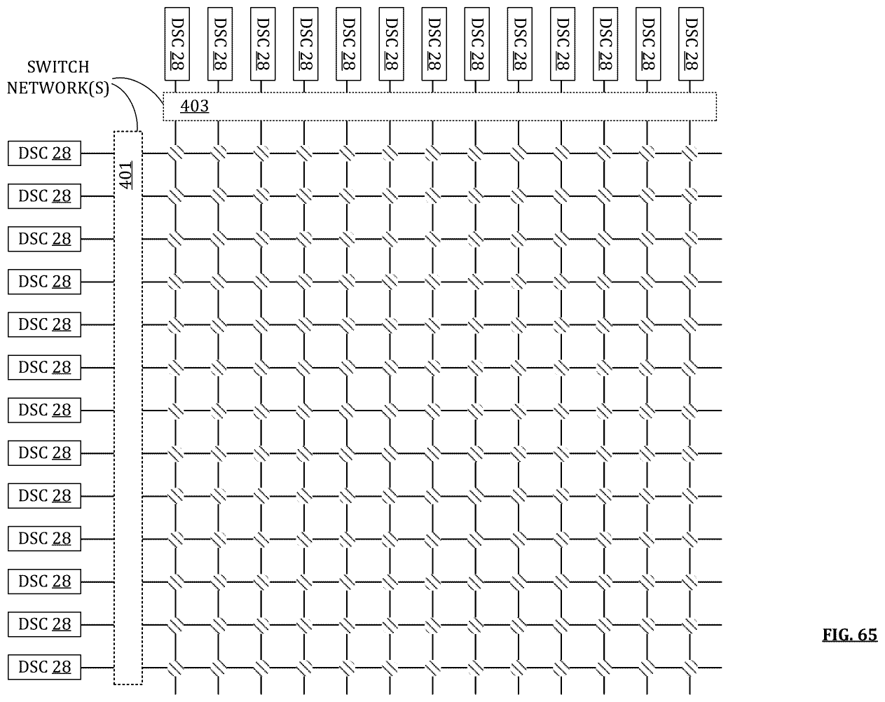

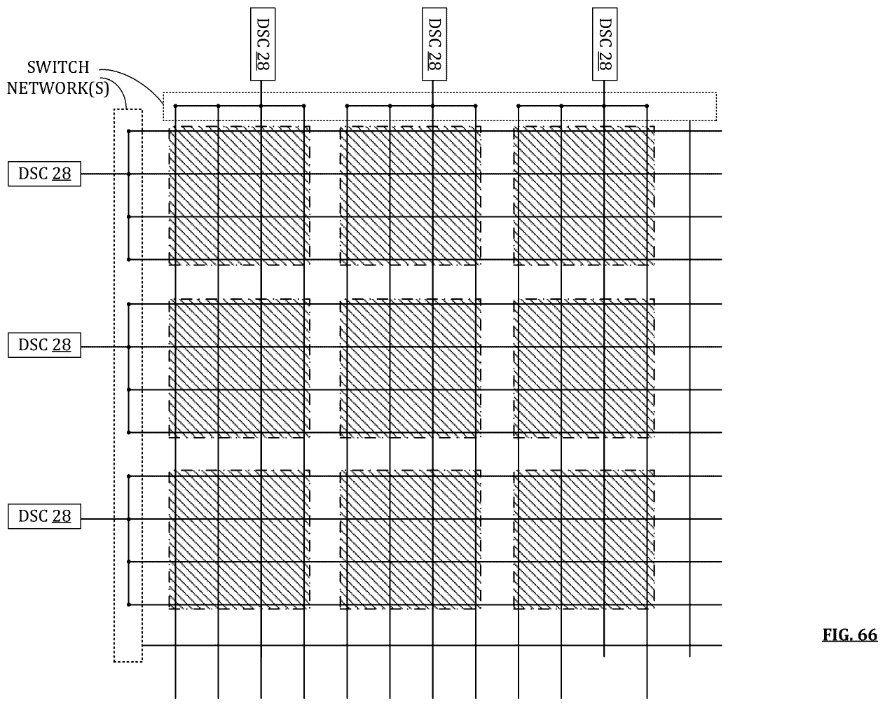

FIGS. 64A and 64B are a schematic block diagram of an example of frequency and time dividing for reference signals for drive-sense circuits (DSCs) 28 of a touch screen display. In this example, a few row electrodes and a few column electrodes are shown. Each electrode is coupled to a drive sense circuit (DSC) 28. The crossover of a row electrode with a column electrode creates a sense cell. In this example, there are nine row electrodes and nine column electrodes, creating 81 sense cells. To allow for time-frequency division self-capacitance sensing and mutual sensing of the electrodes, the drive sense circuits are grouped. Each group uses the same frequency f1 for self-capacitance and uses a set of frequencies f10-f13 for mutual capacitance but at different times.

For example, during time 1-1, the drive sense circuits affiliated with the first four row electrodes 1-4 use frequency f1 for self-capacitance and drive sense circuits affiliated with the first four column electrodes 1-4 use frequency f1 for self-capacitance and frequencies f10-f13 for mutual capacitance. As another example, during time 1-2, the drive sense circuits affiliated with the first four row electrodes 1-4 use frequency f1 for self-capacitance and the drive sense circuits affiliated with the second four column electrodes 5-8 use frequency f1 for self-capacitance and frequencies f5-f8 mutual capacitance.

Continuing with the example in FIG. 64B, during time 2-1, the drive sense circuits affiliated with the second four row electrodes 1-4 use frequency f1 for self-capacitance and drive sense circuits affiliated with the second four column electrodes 5-8 use frequency f1 for self-capacitance and frequencies f10-f13 for mutual capacitance. As another example, during time 2-2, the drive sense circuits affiliated with the second four row electrodes 5-8 use frequency f1 for self-capacitance and the drive sense circuits affiliated with the second four column electrodes 5-8 use frequency f1 for self-capacitance and frequencies f5-f8 mutual capacitance.

Referring next to FIG. 65, a touch screen device employing switch networks to selectively couple row and column electrodes to particular drive-sense circuits of a touch screen display to achieve a highest touch resolution of the touch screen display is shown. In the illustrated embodiment, the touch screen device includes row electrodes and column electrodes arranged in a perpendicular crossing pattern to form a grid of touch sense cells 280, and each of the row and column electrodes are selectively coupled via switch networks 401 and 403 to particular DSCs. In at least one embodiment, each of the touch sense cells 280 correspond to smallest size electrode pads used to sense a proximate touch. Because the grid uses all of the touch sense cells 280, the illustrated embodiment corresponds to a highest touch resolution of the touch screen device. This highest touch resolution can, but does not necessarily, correspond to the display resolution of the touch screen device. For example, in embodiments where the number of the touch sense cells 280 is coextensive with the number of pixels (or sub-pixels) of a touch screen display, the touch resolution can be said to match the display resolution. However, in some embodiments the number of the touch sense cells 280 is not the same as the number of pixels (or sub-pixels) used to display rendered images. In that case, the touch resolution can be different from the display resolution. In various embodiments, even if the number of touch sense cells 280 is the same as the number of pixels (or sub-pixels) included in the touch screen display, the positions of the touch sense cells 280 need not exactly correspond to the positions of the pixels (or sub-pixels).

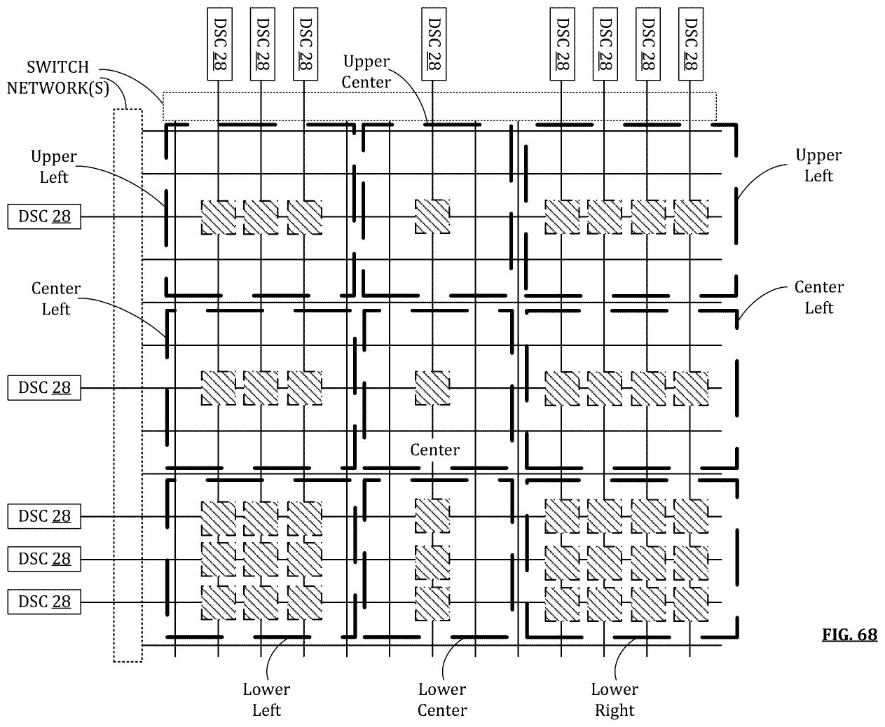

Referring next to FIG. 66, a touch screen device employing switch networks to selectively couple multiple row and column electrodes to a single drive-sense circuit of a touch screen display to achieve a lesser touch resolution of the touch screen display. In the illustrated embodiment, a group of 4 row electrodes are coupled to each DSC. Similarly, a group of 4 column electrodes are coupled to each DSC. As illustrated in FIG. 66, an area including 4 row electrodes and 4 column electrodes forms a touch sensing unit, sometimes referred to as an electrode pad. Assuming, for purposes of this example, that each location at which a row electrode crosses a column electrode forms a touch sense cell, each electrode pad in the illustrated embodiment is made up of 16 touch sense cells selectively coupled together. By coupling 16 touch sense cells together, the touch resolution of the embodiment shown in FIG. 66 is reduced, as compared to the touch resolution achieved when each of the 16 touch sense cells is used individually.

Consider the following example involving both FIG. 65 and FIG. 66. In FIG. 65, a touch that affects only a single touch sense cell will cause the DSCs coupled to the row and column lines forming that single touch sense cell to generate appropriate outputs. DSCs coupled to the neighboring row and column lines will not produce an output, because those sense cells are unaffected by the touch in this example. In FIG. 66, DSCs are coupled to multiple touch sense cells, thus, a touch on any one touch sense cell of a group of 16 touch sense cells that are coupled together will be indistinguishable from a touch registered by any of the other touch sense cells in that same group. Thus, the touch resolution shown in FIG. 66 can be considered to be 16× less than the touch resolution shown in FIG. 65.

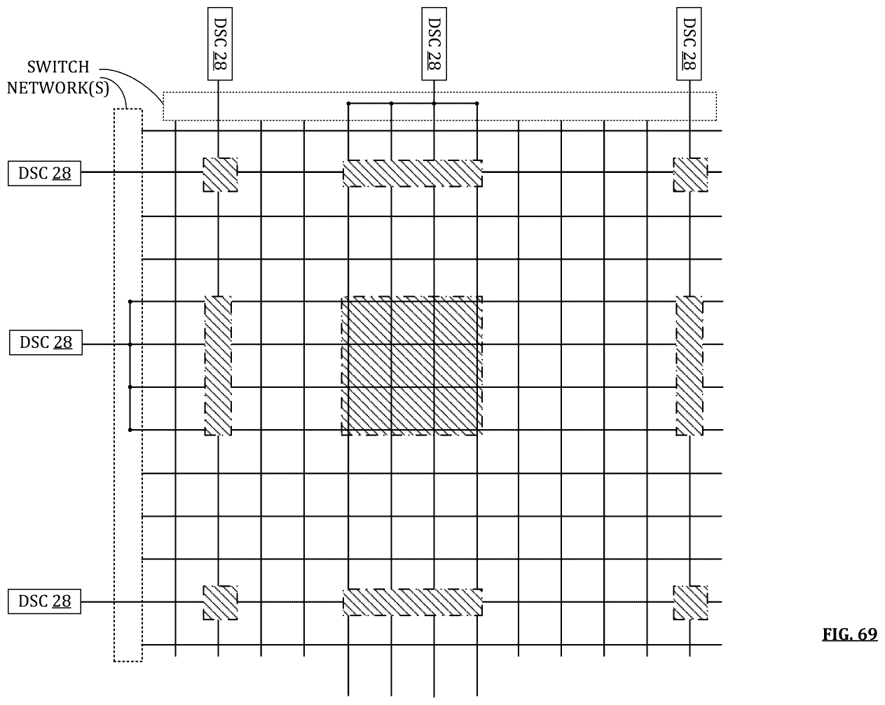

Referring next to FIG. 67, a touch screen device employing switch networks to selectively couple fewer than all row and column electrodes to selected drive-sense circuits of a touch screen display to achieve a lesser touch resolution of the touch screen display will be discussed. The touch screen device in FIG. 67, like the touch screen devices illustrated in FIGS. 65 and 66, include row and column electrodes selectively coupled to particular DSCs. The hashed boxes in FIG. 67 correspond to a smallest electrode pad, for example a touch sense cell illustrated in FIG. 65, or a group of interconnected touch sense cells as shown in FIG. 66.

Assume for purposes of this example that the hashed boxes in FIG. 67 correspond to single touch sense cells. Every third row electrode is coupled to a single DSC and every third column electrode is coupled to a single DSC. Any remaining row electrodes, column electrodes, and DSCs remain unused. Note that for clarity of illustration, unused DSCs are not illustrated. Because only every third row and column electrode are coupled to DSCs, the configuration illustrated in FIG. 67 will use only every third touch sense cell for sensing a touch, while the configuration illustrated in FIG. 65 uses every touch sense cell for sensing touch. Consequently, the touch resolution of the touch screen display illustrated in FIG. 67 can be said to be ⅓ the touch resolution of the touch screen display illustrated in FIG. 65.

Referring next to FIG. 68, a touch screen device employing switch networks to selectively couple fewer than all row and column electrodes to selected drive-sense circuits in different portions of the touch screen to achieve different touch resolutions in different parts of the touch screen display. The embodiment illustrated in FIG. 68 operates in a similar manner to the embodiment shown in FIG. 67, but instead of uniformly selecting every third row and column electrodes to be coupled to selected DSCs, different numbers of touch sense cells, e.g. smallest electrode pads, are used in different portions of the touch screen, to provide varying touch resolutions for different screen portions.

In the illustrated example, the upper-left, center-left portion, and the lower-center portions of the touch screen can be said to have the same touch resolution, because all three portions use 3 touch sense cells for touch sensing. The upper right and center right portion can be said to have the same touch resolution because they each employ 4 touch sense cells to sense touch. The upper-center and center portions can be said to have the same touch resolution because they each use a single touch sense cell for sensing touch. The lower-left portion uses 9 touch sense cells for sensing touch, and the lower-right portion uses 12 touch sense cells to sense touch. Thus, relative to each other, the lower-right portion has the highest touch resolution. The lower-left portion has the next highest touch resolution. The upper-right and center-right portions have an intermediate touch resolution. The upper-left, center-left, and lower-center portions have a low touch resolution, and the upper center and center areas have the lowest touch resolution.

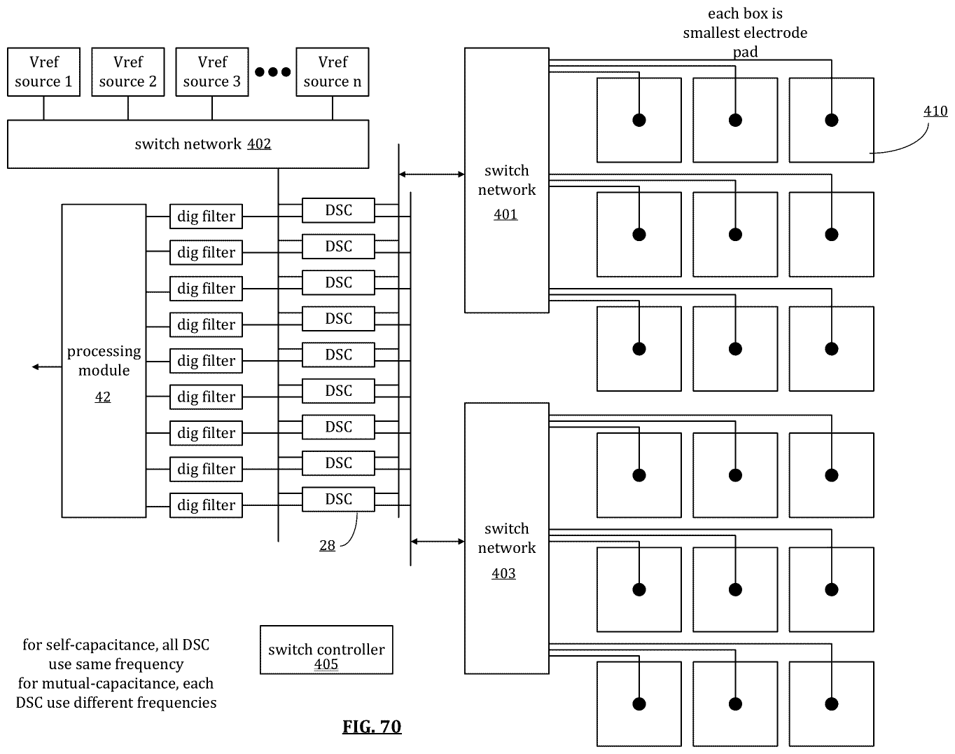

Referring next to FIG. 69, a touch screen device employing switch networks to selectively couple fewer than all row and column electrodes to selected drive-sense circuits in some portions of the touch screen, and selectively couple multiple row and column electrodes to single drive-sense circuits to achieve different touch sensitivities or resolutions in different parts of the touch screen display will be discussed. The switch networks shown in FIG. 69 couple a single column electrode to a single DSC in the left and right portions of the touch screen display, and couples 4 column electrodes to a single DSC in the center of the touch screen display. Similarly, the switch networks couple a single row electrode to a single DSC in the upper and lower portions of the display, while coupling 4 row electrodes to a single DSC in the center portion of the display.

Each of the four corners of the display use a single touch sense cell for sensing touch. Each of the center-side portions use a single electrode pad consisting of 4 coupled touch sense cells. The center portion of the display also uses a single electrode pad, although this electrode pad consists of 16 coupled touch sense cells. In at least one embodiment, the larger electrode pad used in the center portion of the display provides an advantage in touch sensitivity over the smaller electrode pads in each of the four corners. An increased touch sensitivity can allow the presence of a touch to be detected more easily, even if determining the exact location of the touch remains unchanged.

In at least one embodiment, a large electrode pad can be configured by coupling multiple row and/or column electrodes together. This large electrode pad can be used to sense an approaching touch. Once an approaching touch is detected, the size of the electrode pads in that screen portion can be reduced by controlling the switch networks to couple fewer row and or column electrodes per DSC in that portion of the screen, so that touch resolution is increased. As used herein, touch resolution includes the ability to accurately detect the location of a touch in relation to the touch screen display.

Referring next to FIG. 70 a touch screen device capable of coupling electrode pads to drive-sense circuits will be discussed. The touch screen device of FIG. 70 includes a processing module 42, digital filters such as cascaded integrated comb (CIC) filters, finite impulse response (FIR) filters, infinite impulse response (IIR) filters, Butterworth filters, Chebyshev filters, elliptic filters, etc., multiple drive sense circuits (DSCs) 28, voltage reference sources 1-n to be used by the DSCs 28 to detect touches, electrode pads 410, reference voltage switch network 402, first switch network 401, second switch network 403, and switch controller 405.

Switch controller 405 includes processing circuitry, one or more inputs that couple switch controller 405 to one or more external processors, from which information associated with the touch resolution of one or more areas of a display, and an output coupled to first switch network 401 and second switch network 403. First switch network 401 and second switch network 403 can be implemented using analog or digital multiplexers, discrete transistor switches, or the like.

First switch network 401 and second switch network 403 operate under control of switch controller 405 to selectively couple particular electrode pads to particular DSCs to vary a touch resolution and/or touch sensitivity of one or more portions of a touch screen display. Although FIG. 70 specifically illustrates first switch network 401 and second switch network 403 coupling electrode pads to particular DSCs, coupling the electrode pads together can be considered forming a row or column electrode from multiple electrode pads and then coupling that row or electrode pad to the DSC. In some embodiments, this process is performed in a single switching stage, while in other embodiments multiple switching stages can be employed. For example, a first switching stage can form the smallest electrode pad, a second switching stage can form the row or column electrodes, and a third switching stage can be used to couple the row or column electrodes to particular DSCs. Formation of the smallest electrode pad, linking of the smallest electrode pads into a row or column electrode, and selection of which row or column electrodes to couple to a particular DSC, alone or in combination, can be used to alter a touch resolution of one or more portions of a touch screen display. FIGS. 65-69 illustrate various switching implementations that can be used, alone or in combination, to achieve a desired touch resolution.

Once first and second switch networks configure the touch display to achieve a target touch resolution by selectively coupling one or more electrode pads to a DSC, reference voltage switch network 402 can be used to couple appropriate reference voltages through the DSC to the electrode pads. The reference voltages are used to detect a proximal touch by detecting changes in impedance caused by capacitive interaction of the detected touch with the electrode pads. The DSC generates signals indicative of the touch, processes them through the digital filters, and provides them to the processing module, which determines what action to take, if any, based on the detected touch. The underlying generation and handling of the DCS signals have already been discussed in detail with respect to previous figures.

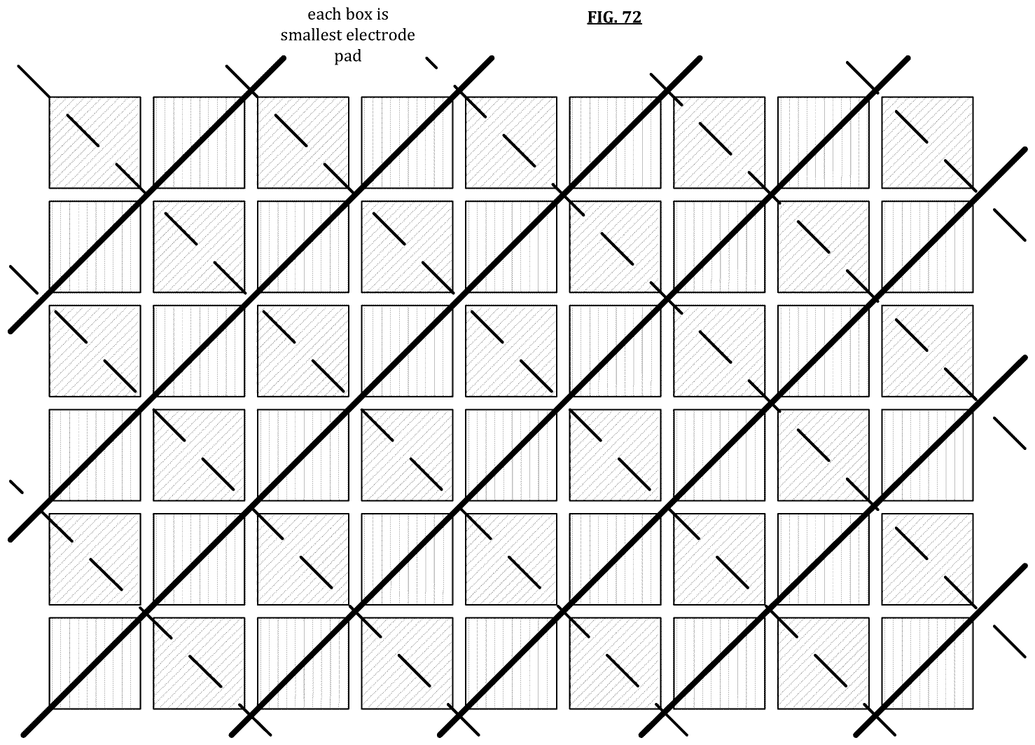

Referring next to FIG. 71, grouping of sub-pixel electrodes to form highest resolution electrode pads will be discussed. Each of the individual boxes represents a sub-pixel electrode, such as the sub-pixel electrodes illustrated in FIG. 9C or 9D. The sub-pixel electrodes are illustrated in groups, with each group representing a smallest electrode pad. In the illustrated embodiment, the smallest electrode pad includes a group of 18 sub-pixel electrodes, but the actual number of sub-pixel electrodes included in the smallest electrode pad for any particular implementation may be different, and can range from millimeters (or larger) in size to as small as a single sub-pixel electrode.

In some embodiments, the size of the smallest electrode pad is fixed, for example by permanently coupling a given number of sub-pixel electrodes together via a semiconductor trace or other conductor. In some embodiments employing a fixed-size smallest electrode pad, size of the smallest electrode pad can be selected based on size of the touch screen, based on an intended use of the touch screen, based on a display resolution of the touch screen, based on a type manufacturing process used to form the sub-pixel electrodes, or the like. For example, in some embodiments employing a fixed-size electrode pad, a smallest electrode pad of a 50 inch, lower display resolution touch display may include an 8×8 array of sub-pixel electrodes coupled together, while the smallest electrode pad of an 8 inch, higher display resolution touch display may include a 2×2 array of sub-pixel electrodes coupled together.

In other implementations, the size of the smallest electrode pad can be adjusted by selectively coupling different combinations of sub-pixel electrodes together using a switch network. For example, a touch screen can be dynamically configured to use a smaller electrode pad during periods of use when knowing a precise location of a touch is imperative, and later configured to use a larger electrode pad when sensing the precise location of a touch is less important than sensing the presence of a touch. Regardless of whether the smallest electrode pad is fixed or variable, different sizes of electrode pads can be used for different portions of a touch screen.

In various embodiments, the smallest electrode pad serves as an upper limit on touch resolution, or granularity. For example, in some embodiments, if a smallest electrode pad is 1 square millimeter, a touch completely within the upper left corner of that 1 square millimeter will effectively be indistinguishable from another touch in the bottom right corner of that same 1 square millimeter, unless that touch also affects an adjacent smallest electrode pad. In many cases, a touch will affect multiple adjacent smallest electrode pads, but even in those cases the size of the smallest electrode pad will affect the touch resolution of the touch screen, with smaller smallest size electrode pads providing greater touch resolution.

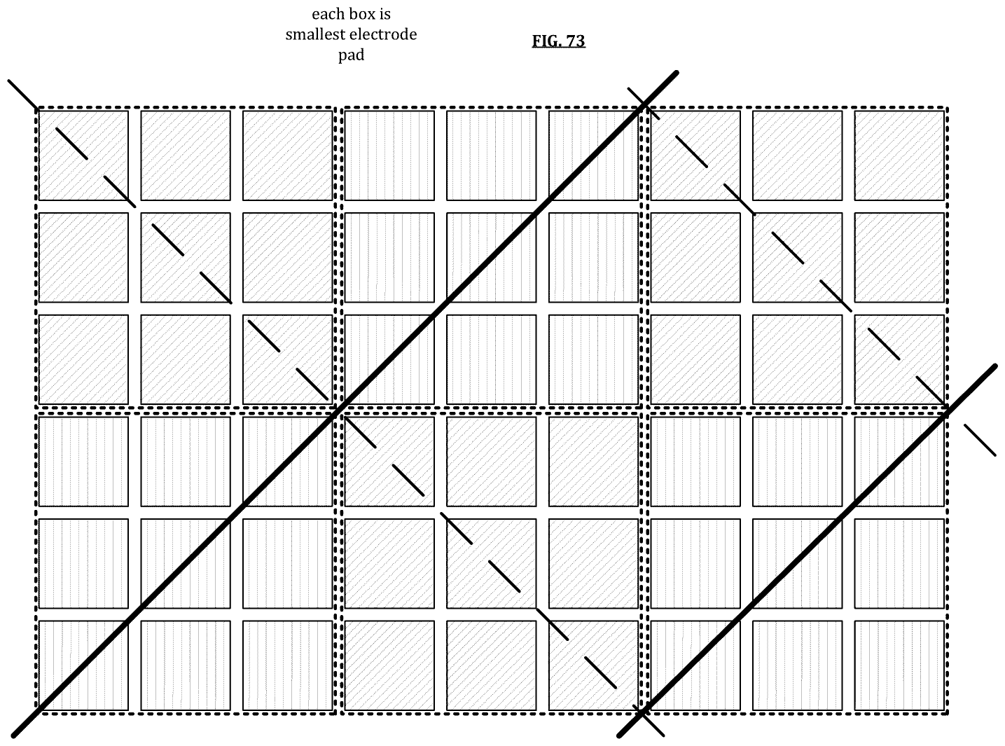

In various embodiments, in addition to, or instead of, allowing a size of the smallest electrode pad to be varied, the way in which the electrode pads are coupled together can be used to adjust the touch resolution of one or more portions of a touch screen. Consider, for example, FIG. 72 grouping electrode pads to form row and column electrodes having a pitch consistent with a highest touch resolution will be discussed. As previously discussed with respect to FIG. 70, one or more switch networks operating under control of a switch controller can be used to selectively couple multiple electrode pads together to form a row or column electrode, and then couple that row or column electrode to a particular DSC. FIG. 72 shows multiple smallest electrode pads being coupled together to form row electrodes (dashed lines) and column electrodes (solid lines). In at least one embodiment, coupling these smallest electrode pads together is accomplished by electrically coupling each of the electrode pads included in row or column electrode to the same DSC. In this way, a single switching stage can be used both to form the row and column electrodes, and to selectively couple the row and column electrodes to achieve a desired touch resolution.

In the embodiment illustrated in FIG. 72, the row and column electrodes have a pitch, or spacing, that uses all of the smallest electrode pads, thereby establishing a highest touch resolution.

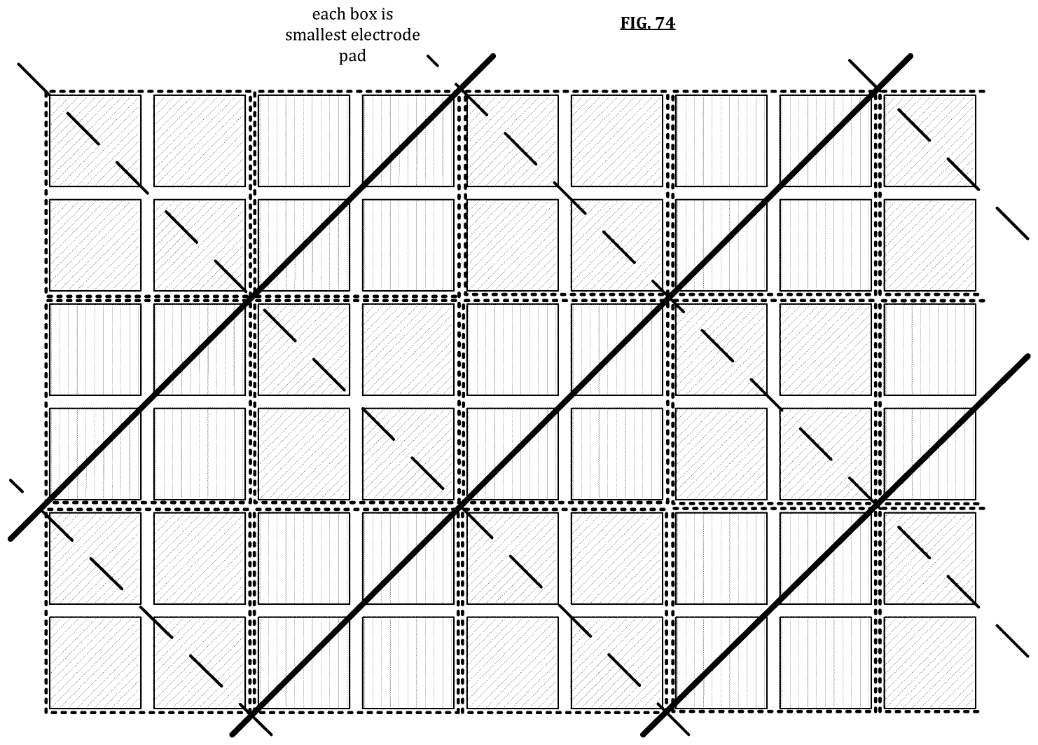

Referring next to FIG. 73 a grouping of large electrode pads to form row and column electrodes having a pitch consistent with a lesser touch resolution will be discussed. The touch resolution shown in FIG. 73 is considered lesser than the touch resolution illustrated in FIG. 72, because in FIG. 72, each of the smallest electrode pads was used to form the row and column electrodes. But in FIG. 73, the smallest electrode pads are coupled into larger electrode pads including 9 smallest electrode pads, and those larger electrode pads are used as the building blocks for the row and column electrodes. Thus, in FIG. 73 there are only 2 row electrodes and 2 column electrodes used to cover a 9×6 screen area, whereas in FIG. 72 there are 7 row electrodes and 7 column electrodes used to cover the same area. The larger pitch, i.e., distance between row or column electrodes, will result in a lower touch resolution.

Referring next to FIG. 74 a grouping of intermediate sized electrode pads to form row and column electrodes having a pitch consistent with an intermediate touch resolution will be discussed. In FIG. 74, 4 of the smallest electrode pads are included in each of the electrode pads used to form the row and column electrodes. The configuration illustrated in FIG. 74 results in 3 row electrodes and 3 column electrodes being used to sense touch in a 9×6 area of the touch display.

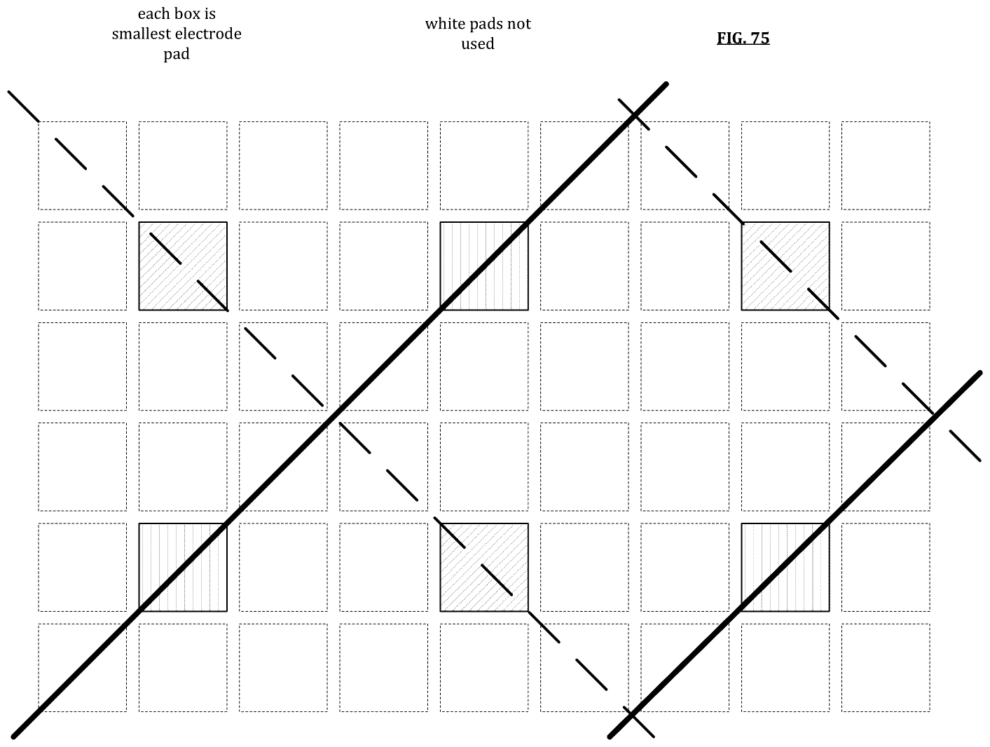

Referring next to FIG. 75 a grouping of electrode pads with two unused electrode pads between each electrode pads connected to form row and column electrodes having a pitch consistent with a low touch resolution will be discussed. In FIG. 75, a low touch resolution is obtained by leaving some of the smallest electrode pads unused, instead of grouping multiple smallest electrode pads together. The result is that two row electrodes and two column electrodes are used to sense touch in a 9×6 area of the display. This configuration may, in some embodiments, be considered to yield the same touch resolution as illustrated in FIG. 73, but with a potentially lesser touch sensitivity.

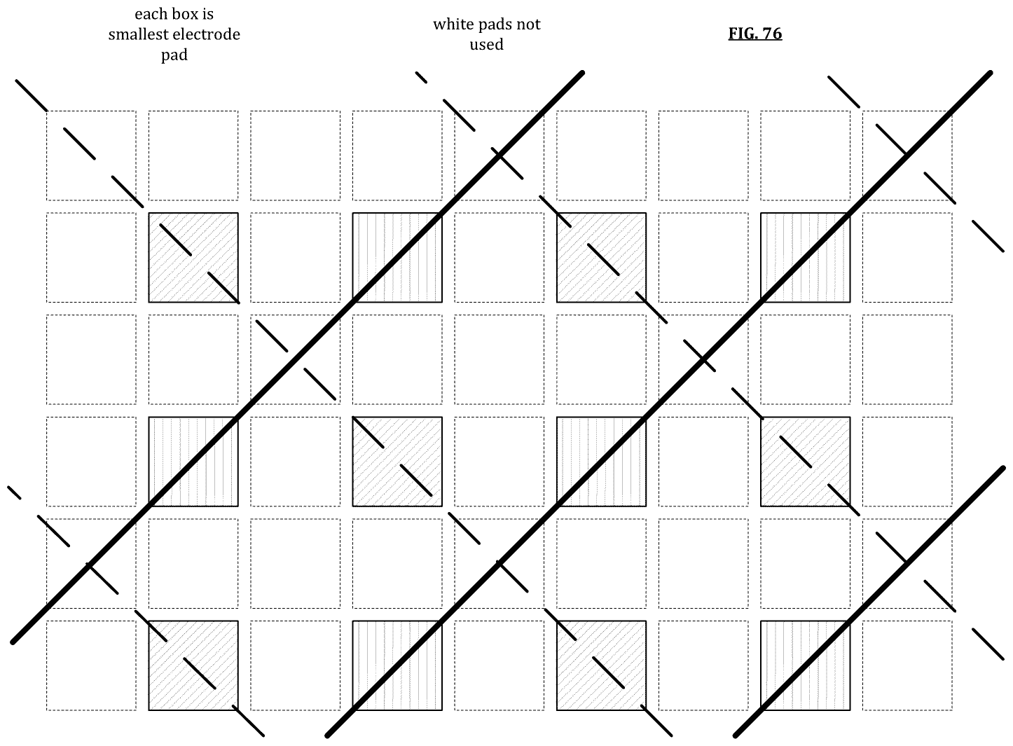

Referring next to FIG. 76 a grouping of electrode pads, with one unused electrode pad between electrode pads connected to form row and column electrodes having a pitch consistent with a medium touch resolution will be discussed. In FIG. 76, a medium touch resolution is obtained by leaving some of the smallest electrode pads unused, instead of grouping multiple smallest electrode pads together. The result is that three row electrodes and three column electrodes are used to sense touch in a 9×6 area of the display. This configuration may, in some embodiments, be considered to yield the same touch resolution as illustrated in FIG. 74, but with a potentially lesser touch sensitivity.

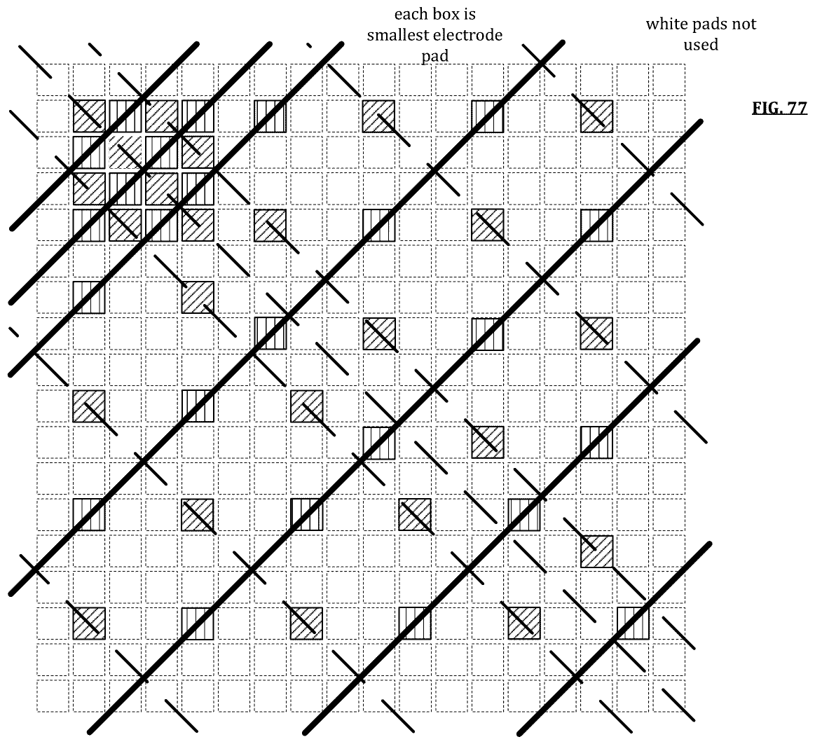

Referring next to FIG. 77 a touch screen display configured to have different touch resolutions in different portions of the screen by selectively coupling electrode pads to form row and column electrodes with different pitches in different portions of the screen. For example, the pitch between the column and row electrodes in the upper left portion of the screen is set to the minimum pitch, resulting in the highest touch resolution, by coupling each of the smallest electrode pads to form the row and column electrodes in that portion of the screen. By contrast, other portions of the screen have less dense row and column electrodes, because some of the smallest electrode pads remain unused when forming the row and column electrodes for those screen portions.

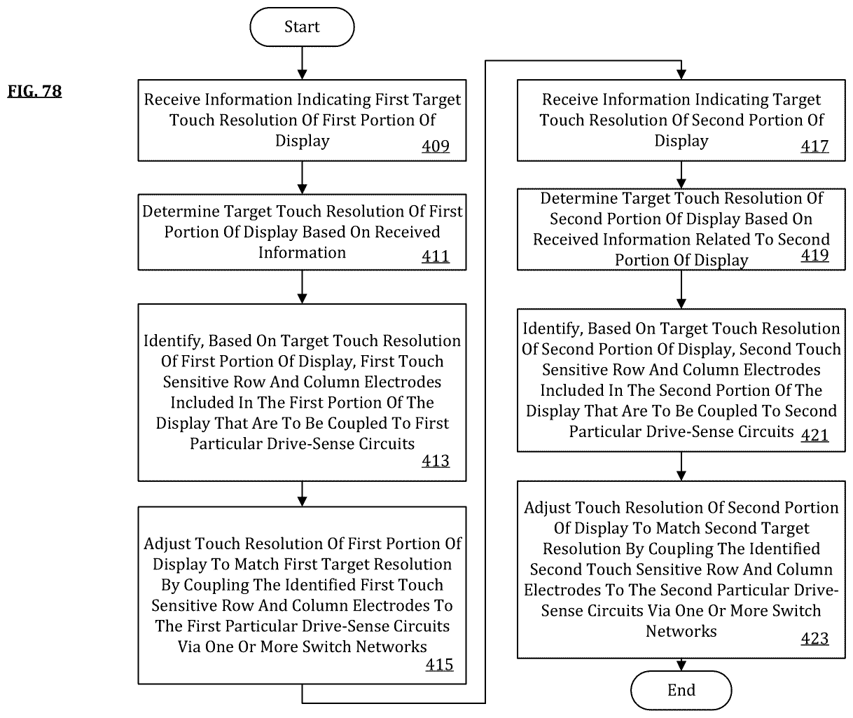

Referring next to FIG. 78, a method of adjusting a touch resolution of a touch sensitive display will be discussed. At block 409 a switch controller receives information indicating a first target touch resolution of first portion of display. The information can be received from a graphics processing module, a core control module, a touch screen processing module, or another external processor or processing module. The information indicating a target touch resolution can include an explicit target touch resolution specified as an absolute measurement, e.g., a number of millimeters, as a number of pixels, as a pitch, as a number of electrodes per DSC, as a number of smallest electrode pads to be coupled to form a composite electrode pad, as a number of sub-pixel electrodes per electrode pad, or the like. The information indicating the first target touch resolution can also specify a delta from a current touch resolution, a percentage of a maximum touch resolution, or the like.

In some embodiments, the information indicating the first target touch resolution can include a location of an object of interest rendered on the display, characteristics of an application sending frames to be rendered on the display, a type of frame being rendered on the display, a current software display resolution, a maximum display resolution of the touch screen, user preferences, area boundaries to which the target touch resolution is to be applied, timing parameters associated with the touch resolution, thresholds indicating capacitance, voltage, impedance, or other thresholds to be met as a prerequisite to be met before changing the touch resolution, or the like.

As illustrated by block 411, the target touch resolution of first portion of display is determined based on received information. The target touch resolution can be set to an explicit resolution included in the information received, calculated based on a current touch resolution and a delta, or the like. A target touch resolution can be determined using a lookup table that cross references particular program types, program identifiers, frame types, frame rates, or other information to particular resolutions.

As illustrated by block 413, touch sensitive row and column electrodes to be selectively coupled to first particular drive-sense circuits are identified, based on the target touch resolution determined at block 411. The determination can be made by choosing one of multiple different techniques for adjusting the touch resolution from a lookup table, for example by changing electrode size, leaving certain electrodes unused, based on a granularity, based on a sensitivity, or the like. For example, if the target resolution can be achieved by grouping smallest electrode pads into larger electrodes or by leaving some electrode pads unused, the switch controller can opt to leave the current size of the electrode pads unchanged, and alter the touch resolution by changing the number of unused electrode pads. The switch controller will have knowledge of which electrode pads, or line and column electrodes, are located in any particular area of the touch screen.

As illustrated by block 415, the switch controller will adjust the touch resolution of the relevant portion of display to match the first target resolution by coupling the identified first touch sensitive row and column electrodes to the first particular drive-sense circuits via one or more switch networks.

As illustrated by block 417, the switch controller receives information indicating target touch resolution of second portion of display. Based on that information, the target touch resolution of the second portion of the display is determined, as illustrated by block 419. The appropriate touch sensitive row and column electrodes, and the DSC(s) to which they are to be coupled are identified at block 421. As illustrated at block 423, the switch controller couples the identified row and column electrodes to the identified DSCs to achieve the target touch resolution of the second portion of the display. Note that adjusting the touch resolution of the second portion of the display does not necessarily change the current touch resolution of the first portion of the display.

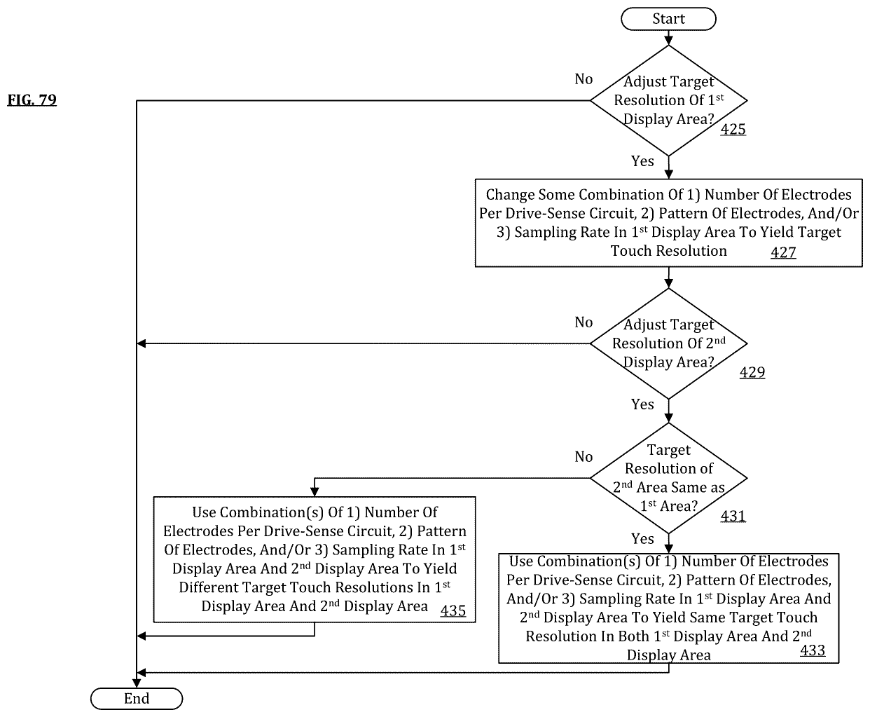

Referring next to FIG. 79, another method of adjusting a touch resolution of a touch sensitive display will be discussed. As illustrated by block 425, a switch controller makes a determination regarding whether to adjust the touch resolution of a first display area. This decision can be based on information received at the switch controller from an external processor, based on expiration of a timer, based on the switch detecting that a different program is rendering images in the first display area, and the like. If the switch controller determines that the touch resolution of an area does not need to be changed, the method ends.

If the touch resolution needs to be changed, the switch controller changes some combination of 1) the number of electrodes per drive-sense circuit, 2) the pattern of electrodes, and/or 3) the sampling rate in the first display area to yield target touch resolution. FIGS. 65-77 illustrate various methods of changing the number of electrodes per drive-sense circuit and/or the pattern of electrodes. In addition to those methods, the switch controller 405 may control the reference voltage switch network 402 to select a voltage reference source that uses a higher or lower frequency, which can permit the DSCs to increase or reduce its sampling rate. A faster sampling rate can be used in some embodiments to increase touch resolution. A combination of one or more of these techniques can be used to yield the target touch resolution for a particular area of a touch screen display.

As illustrated by block 429, a decision is made regarding whether to adjust the touch resolution of a second, different area of the touch screen display. If no adjustment of the second area is needed, the method ends. If, however, the switch controller determines that an adjustment is necessary, a check is made at block 431 to determine if the target touch resolution of the second display area is the same as the target touch resolution of the first display area.

As indicated by block 435, if the target touch resolutions of the first and second display area are different, the switch controller uses a different combination of 1) a number of electrodes per drive-sense circuit, 2) a pattern of electrodes, and/or 3) sampling rate in 1^{st} display area and 2^{nd} display area to yield different target touch resolutions in 1^{st} display area and 2^{nd} display area.

As indicated by block 435, if the target touch resolutions of the first and second display area are to be the same, the switch controller uses some combination of 1) a number of electrodes per drive-sense circuit, 2) a pattern of electrodes, and/or 3) sampling rate in 1^{st} display area and 2^{nd} display area to yield different target touch resolutions in 1^{st} display area and 2^{nd} display area. The combination of items may or may not be same, as long as the selected combinations achieve the same touch resolution. For example, using one electrode per drive sense circuit and leaving one unused electrode between the electrodes that are coupled to drive sense circuits may yield a first touch resolution. But using two electrodes per drive sense circuit without leaving any unused electrodes might achieve that same touch resolution.

Additionally, the switch controller may decide that if both the first area and the second area are to be the same, a third combination of electrode pattern, number of electrodes per drive sense circuit may be used on the entire display in conjunction with an altered sampling rate. In some such embodiments, the combination used in the first area can be changed to a more efficient combination yielding the same touch resolution.

Referring next to FIG. 80 a method of controlling a switch network to adjust a touch resolution of a touch sensitive display including row and column electrodes will be discussed. As illustrated by block 441, a switch controller receives information indicating a touch resolution/granularity/sample rate of a display area including touch sensitive row electrodes, touch sensitive column electrodes, and drive sense circuits coupled to touch sensitive row and column electrodes via switch network(s).

As illustrated by block 443, the switch controller determines a target touch resolution of the display area based on received information. If it is determined at block 445 that the touch resolution of the display area does not need to be adjusted, for example because the current touch resolution of the display area already matches the target touch resolution, or because the current touch resolution is within a threshold delta of the target touch resolution, the method proceeds to block 447 and the current configuration of row and column electrodes remains unchanged.

If, however, the touch resolution of the display area is to be changed, the switch controller selects, based on the target touch resolution of display area, particular touch sensitive row and column electrodes included in the first portion of the display that are to be coupled to particular drive-sense circuits via switch network(s), as illustrated by block 449.

As illustrated by block 451, the switch controller generates and transmits control signal(s) to the switch network(s), where those control signals cause the switch network(s) to couple particular touch sensitive row and column electrodes to particular drive sense circuits. The control signals can include placing voltages to the gates of switching transistors, sending high or low logic levels to logic circuitry included in a multiplexer or other switch, or the like.

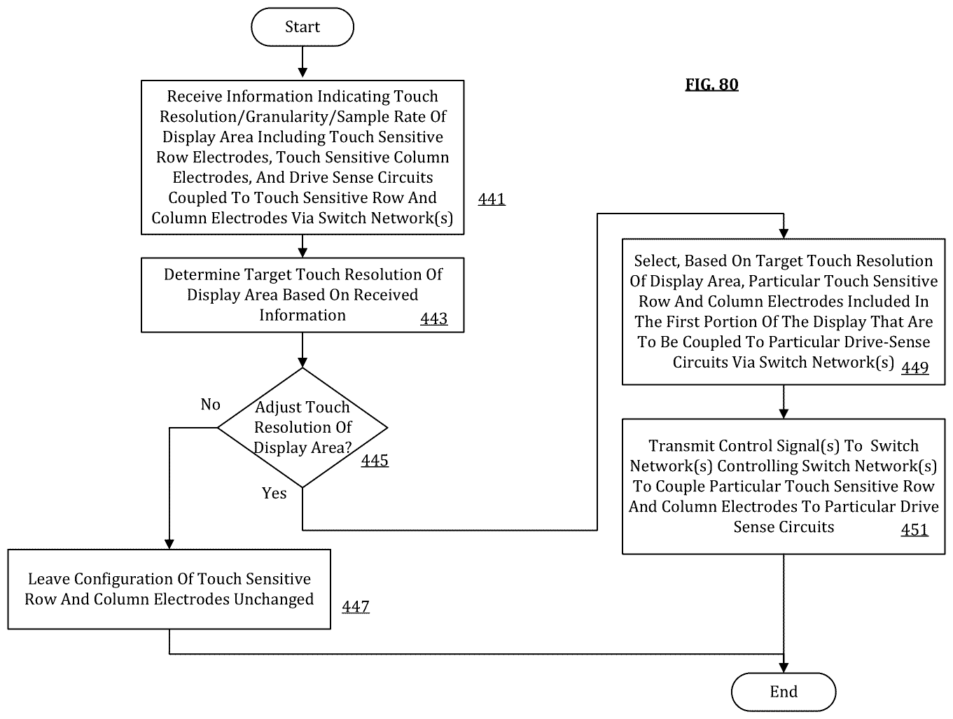

Referring next to FIG. 81 a method of controlling a switch network to adjust a touch resolution of a touch sensitive display including electrode pads will be discussed. As illustrated by block 455, a switch controller receives information indicating touch resolution/granularity/sample rate of display area including an array of electrode pads coupled to drive sense circuits via switch network(s). At block 457, a target touch resolution of the display area is determined based on the received information. If it is determined at block 459 that the touch resolution of the display area does not need to be adjusted, the method proceeds to block 461 and the current configuration of electrode pads remains unchanged.

As illustrated by block 463, if the touch resolution of the display area is to be changed, the switch controller selects, based on the target touch resolution of display area, particular electrode pads to be coupled to particular drive-sense circuits via switch network(s) to adjust the touch resolution to match the target touch resolution.

As illustrated by block 465, the switch controller generates and transmits control signal(s) to the switch network(s), where those control signals cause the switch network(s) to couple particular electrode pads to particular drive sense circuits.

Various embodiments herein include a switch controller that uses various information related to touch resolution to determine target touch resolution(s) and to control one or more switch networks to implement that target touch resolution. For example, at least one embodiment includes a method comprising: receiving, at a switch controller, information associated with a touch resolution of an area of a display, wherein the display is configured to render frames of data into a series of visible images concurrently with detecting a touch, and wherein the display includes: a plurality of touch sensitive row electrodes and a plurality of touch sensitive column electrodes; a plurality of drive-sense circuits selectively coupled to the plurality of touch sensitive row electrodes and the plurality of touch sensitive column electrodes via a switch network controlled by the switch controller; determining, by the switch controller, based on the information associated with the touch resolution of the area of the display, a target touch resolution of the area of the display; selecting, by the switch controller, particular touch sensitive row electrodes and particular touch sensitive column electrodes to be coupled to particular drive-sense circuits, via the switch network, to adjust the touch resolution of the area of the display to match the target touch resolution; and transmitting one or more control signals from the switch controller to the switch network, wherein the one or more control signals control the switch network to couple particular touch sensitive row electrodes and particular touch sensitive column electrodes to the particular drive-sense circuits.

The method can also include receiving, from a processing module coupled to the display, information indicating one or more characteristics of an application displaying the series of visible images; and wherein determining the target touch resolution of the area of the display is based, at least in part, on the one or more characteristics of the application displaying the series of visible images.

In some embodiments, the method includes receiving, from a processing module coupled to the display, information indicating one or more characteristics of a data frame being rendered on the display; and wherein determining the target touch resolution of the area of the display is based, at least in part on the one or more characteristics of the data frame being rendered on the display.

Yet other embodiments can also include receiving, from a processing module coupled to the display, information associated with a second touch resolution of at least a second area of the display; and determining a second target touch resolution of the at least a second area of the display based, at least in part, on the information associated with the second touch resolution of the at least a second area of the display.

The method can also be implemented to include receiving, from a processing module coupled to the display, information indicating a display location of a particular object; and determining a second target touch resolution associated with the display location of the particular object, wherein the second target touch resolution is different than the target touch resolution.

Various implementations of the method also include receiving, from a processing module coupled to the display, information indicating that a particular object is displayed within the area of the display; and determining the target touch resolution of the area of the display based, at least in part, on the particular object being present within the area of the display.

Further embodiments also include receiving, from a processing module coupled to the display, information indicating a resolution of the series of visible images; and determining the target touch resolution of the area of the display based, at least in part on the resolution of the series of visible images.

The method can also be implemented to include receiving, at the switch controller, information indicating a sampling rate associated with touch sensitive row electrodes and touch sensitive column electrodes included in the area of the display; and determining the target touch resolution of the area of the display based, at least in part on the sampling rate.

Additionally, some methods include receiving, at the switch controller, information indicating a granularity associated with touch sensitive row electrodes and touch sensitive column electrodes included in the area of the display; and determining the target touch resolution of the area of the display based, at least in part on the granularity.

A second method according to various embodiments comprises: receiving, at a switch controller, information associated with a touch resolution of an area of a display, wherein the display is configured to render frames of data into a series of visible images concurrently with detecting a touch, wherein the display includes: an array of electrode pads extending across a touch area and having a pitch capable of supporting a highest touch resolution; a plurality of drive-sense circuits selectively coupled to the array of electrode pads via a switch network controlled by the switch controller; determining, by the switch controller, based on the information associated with the touch resolution of the area of the display, a target touch resolution of the area of the display; selecting, by the switch controller, particular electrode pads to be coupled to particular drive-sense circuits, via the switch network, to adjust the touch resolution of the area of the display to match the target touch resolution; and transmitting one or more control signals from the switch controller to the switch network, wherein the one or more control signals control the switch network to couple the particular electrode pads to the particular drive-sense circuits.

Various embodiments of the second method include receiving, from a processing module coupled to the display, information indicating one or more characteristics of an application displaying the series of visible images; and wherein determining the target touch resolution of the area of the display is based, at least in part, on the one or more characteristics of the application displaying the series of visible images.

The second method can also include receiving, from a processing module coupled to the display, information indicating one or more characteristics of a data frame being rendered on the display; and wherein determining the target touch resolution of the area of the display is based, at least in part on the one or more characteristics of the data frame being rendered on the display.

Some implementations of the second method can include receiving, from a processing module coupled to the display, information associated with a second touch resolution of at least a second area of the display; and determining a second target touch resolution of the at least a second area of the display based, at least in part, on the information associated with the second touch resolution of the at least a second area of the display.

Yet further embodiments of the second method further include receiving, from a processing module coupled to the display, information indicating that a particular object is displayed within the area of the display; and determining the target touch resolution of the area of the display based, at least in part, on the particular object being present within the area of the display.

Additionally, the second method can be adapted to include receiving, from a processing module coupled to the display, information indicating a resolution of the series of visible images; and determining the target touch resolution of the area of the display based, at least in part on the resolution of the series of visible images.

The switch controller itself can include processing circuitry; an input coupling the processing circuitry to an external processor; an output coupling the processing circuitry to a switch network, wherein the switch network is configured to operate under control of the processing circuitry, and to selectively couple a plurality of touch sensitive row electrodes and a plurality of touch sensitive column electrodes included in a display to a plurality of drive-sense circuits, wherein the display is configured to render frames of data into a series of visible images concurrently with detecting a touch; the input configured to receive, from the external processor, information associated with a touch resolution of an area of a display; the processing circuitry configured to: determine, based on the information associated with the touch resolution of the area of the display, a target touch resolution of the area of the display; select particular touch sensitive row electrodes and particular touch sensitive column electrodes to be coupled to particular drive-sense circuits to adjust the touch resolution of the area of the display to match the target touch resolution; generate one or more control signals, wherein the one or more control signals control the switch network to couple particular touch sensitive row electrodes and particular touch sensitive column electrodes to the particular drive-sense circuits; and the output configured to transmit the one or more control signals to the switch network.

Various implementations of the switch controller the information associated with the touch resolution of the area of the display includes information indicating one or more characteristics of an application displaying the series of visible images; and wherein the target touch resolution of the area of the display is determined based, at least in part, on the one or more characteristics of the application displaying the series of visible images.

In some embodiments the information associated with the touch resolution of the area of the display includes information indicating one or more characteristics of a data frame being rendered on the display; and wherein the target touch resolution of the area of the display is determined based, at least in part, on the one or more characteristics of the data frame being rendered on the display.

In other embodiments of the switch controller, the information associated with the touch resolution of the area of the display includes information associated with a second touch resolution of at least a second area of the display; and the processing circuitry is further configured to: determine, based on the information associated with a second touch resolution of at least a second area of the display, a second target touch resolution of the second area of the display; select second particular touch sensitive row electrodes and second particular touch sensitive column electrodes included in the second area of the display to be coupled to second particular drive-sense circuits to adjust the second touch resolution of the second area of the display to match the second target touch resolution; and generate other control signals configured to control the switch network to couple the second particular touch sensitive row electrodes and the second particular touch sensitive column electrodes to the second particular drive-sense circuits.

In some implementations of the switch controller, wherein the processing circuitry is configured to: receive, from the external processor, second information indicating at least one of a resolution of the series of visible images, third information indicating a sampling rate associated with touch sensitive row electrodes and touch sensitive column electrodes included in the area of the display, or fourth information indicating a granularity associated with touch sensitive row electrodes and touch sensitive column electrodes included in the area of the display; and determine the target touch resolution of the area of the display based, at least in part, on at least one of the second information, the third information, or the fourth information.

FIG. 82 is a logic diagram of an example of altering the resolution of a touch screen display based on displayed video content that includes one or more touch-related images. The method is executed by one or more processing modules (e.g., 42, 82, and/or 48 of the previous figures). A touch screen display that implements the illustrated method can be utilized in a variety of applications and devices. For example, the touch screen display can be integrated into a television, countertop video gaming arcade, kiosk (e.g., a home automation kiosk, a store kiosk, or a museum kiosk), a robotic control system (e.g., such as a robotic-assisted surgery system), an automotive touch display, an e-reader, an Automated Teller Machine (ATM), an emulated game controller, or other type of device that can be used to display touch-related images. The displayed video content can be any type of content employing touch-related images, such as video content generated by strategy games, puzzle and board games, multi-player games, video editing software, graphic design software, interactive streaming applications, multi-user applications, etc.

The method begins at step 467 where the processing module(s), operating in conjunction with a switch controller and one or more switch networks such as described above, establishes an initial touch resolution for a display area of a touch screen display. The initial touch resolution can be a default touch resolution or a previously-established touch resolution and is established by selectively coupling row electrodes and column electrodes of the display area to drive-sense circuits (DSCs) 28 of the touch screen display such as described in conjunction with FIGS. 1A-1C and FIGS. 65-81.

The method continues at step 469 where the processing module determines if video content presented in a display area of the touch screen display includes a touch-related image(s). A touch related image can include, for example and without limitation, one or more of a touch icon, a menu selection option, a control command, a robotic-assisted surgery control icon, a humanoid/gaming character, etc. In the context of touch-enabled gaming, a touch-related image can correspond to a variety of control commands to perform functions such as panning a camera angle, dragging objects (e.g., animated building blocks, vehicles, supplies, etc.), zooming in on or rotating a landscape or object, selecting an object or area, manipulating tiled graphics, etc.

If no touch-related image is detected, the method repeats at step 469. If a touch-related image is detected at step 469, the method continues at step 471 where the processing module associates the touch-related image with at least a first portion of the display area. In an example, the first portion of the display area corresponds to the entire display area. In other examples, the first portion of the display area closely corresponds to an area that is slightly larger than the displayed touch-related image, the portion of the display area in which the touch-related image is presently displayed, and/or a portion of the display area in which the touch-related image is predicted to be displayed (e.g., within a particular time period). In a further example, the size of the first portion of the display area can be personalized to correspond to or account for the size of a particular user's fingers or stylus (e.g., such as determined through a prior calibration process).

Next, at step 473, the processing module generates touch resolution change information that indicates the first portion of the display area and a second touch resolution, which may be a greater or lesser resolution than the first touch resolution. The method continues at step 475, where the touch resolution of the first portion of the display area is modified in accordance with the touch resolution change information. Examples of generating touch resolution change information and modifying the touch resolution of a portion of a display area are described above in conjunction with FIGS. 78-81.

FIG. 83 is a logic diagram of an example of altering the resolution of a touch screen display based on characteristics of displayed video content. The method is executed by one or more processing modules (e.g., 42, 82, and/or 48 of the previous figures). In the illustrated method, one or more characteristics of displayed video content are utilized to establish and/or dynamically alter the touch resolution of a display area of a touch screen display. Such video content characteristics can include, for example, changes in the rate of motion of all or a portion(s) of the displayed video content.

The method begins at step 477 where the processing module(s), operating in conjunction with a switch controller and one or more switch networks such as described above, establishes a first touch resolution for a display area of a touch screen display. The first touch resolution is established by selectively coupling row electrodes and column electrodes of the display area to drive-sense circuits (DSCs) 28 of the touch screen display in a manner such as described in conjunction with FIGS. 1A-1C and FIGS. 65-81. The first touch resolution can be a default touch resolution or a previously-established touch resolution. In another example, the first touch resolution is established utilizing identification information associated with the displayed video content. For example, meta-data associated with fast-paced gaming content or sporting content with touch-based input options can be utilized by the processing module to establish (or modify) a first touch resolution.

The method continues at step 479 where the processing module determines if there is a change in the rate of motion of video content presented in a display area of the touch screen, such as changes in the rate of motion of all or portions of a display image (e.g., as rendered from display frames of data). In an example, the display image includes one or more touch-related images.

The processing module can determine a change in the rate of motion based on information received from video graphics processing module 48, an operating system 89, an application 73, and/or other system components such as described in conjunction with FIGS. 2-5. In an example, the processing module analyzes an MPEG/compressed data stream (e.g., the magnitude of motion vectors used in a block motion estimation process) to identify changes in the rate of motion of all or portions of displayed video content. In another example, the processing module analyzes motion interpolation/motion-compensated frame interpolation information (e.g., artificial, intermediate data frames) generated by certain displays to reduce motion blur when operating at a higher refresh rate than source content.

If no change in the rate motion of video content is detected, or a change in the rate of motion is below a threshold established for triggering a modification to a touch resolution, the method repeats at step 479. If a change in the rate of motion of the display image is detected at step 469, the method continues at step 471 where the processing module associates the display image with at least a first portion of the display area. In an example, the first portion of the display area corresponds to the entire display area. In another example, the first portion of the display corresponds to a portion(s) of the display in which a change in the rate of motion is identified. Continuing with this example, if the change in the rate of motion corresponds to a touch-related image (e.g., a touch icon), the first portion of the display area can be selected to encompass a current location of the displayed image and a projected location of the image. In a further example, the size of the first portion of the display area is related to a detected rate of motion or a magnitude of change in the rate of motion (e.g., such that a relatively faster moving or accelerating image is associated with a relatively larger portion of the display area for purposes of altering a corresponding touch resolution).

Next, at step 483, the processing module generates touch resolution change information that indicates the first portion of the display area and a second touch resolution, which may be a greater or lesser resolution than the first touch resolution. The method continues at step 485, where the touch resolution of the first portion of the display area is modified in accordance with the touch resolution change information. Examples of generating touch resolution change information and modifying the touch resolution of a portion of a display area are described above in conjunction with FIGS. 78-81.

In another embodiment according to the present disclosure, a touch screen display and associated methods are described for altering a touch screen resolution based on detection of a proximate finger or stylus. In this embodiment, the touch screen display includes a display configured to display images in a display area. The touch screen display further includes a plurality of row electrodes and a plurality of column electrodes (e.g., selectively formed from integrated electrode pads), wherein the plurality of row electrodes and the plurality of column electrodes are spaced apart to support at best a highest touch resolution; a plurality of drive-sense circuits; a first switch network coupling a first set of drive-sense circuits to the plurality of row electrodes; a second switch network coupling a second set of drive-sense circuits to the plurality of column electrodes, the first set of drive-sense circuits and the second set of drive-sense circuits operable to drive signals on to the plurality of row electrodes and the plurality of column electrodes; and a switch controller coupled to the first switch network and to the second switch network, the switch controller configured to control the first switch network and the second switch network to control touch resolution of at least a portion of the touch screen display between the highest touch resolution and lesser touch resolutions. The touch screen display of this embodiment further includes a processing module coupled to the plurality of drive-sense circuits and to the switch controller. The processing module is configured to sense an electrical characteristic of at least one row electrode and at least one column electrode based on the signals and detect, based on the electrical characteristic, a proximate finger or stylus. In response to detecting the proximate finger or stylus, the processing module is further configured to transmit touch resolution change information to the switch controller.

In another embodiment according to the present disclosure, a touch screen display and associated methods are described for altering a touch screen resolution based on one or more touch-related images in displayed video content. In this embodiment, the touch screen display includes a display configured to display video content in a display area. The touch screen display further includes a plurality of row electrodes and a plurality of column electrodes (e.g., selectively formed from integrated electrode pads), wherein the plurality of row electrodes and the plurality of column electrodes are spaced apart to support at best a highest touch resolution; a plurality of drive-sense circuits; a first switch network coupling a first set of drive-sense circuits to the plurality of row electrodes; a second switch network coupling a second set of drive-sense circuits to the plurality of column electrodes; and a switch controller coupled to the first switch network and to the second switch network, the switch controller configured to control the first switch network and the second switch network to control touch resolution of at least a portion of the touch screen display between the highest touch resolution and lesser touch resolutions. The touch screen display of this embodiment further includes a processing module coupled to the plurality of drive-sense circuits and to the switch controller. The processing module is configured to identify a touch-related image in the video content. In response to identifying a touch-related image, the processing module is further configured to associate the touch-related image with a first portion of the display area and transmit touch resolution change information to the switch controller, wherein the touch resolution change information indicates the first portion of the display area and a target touch resolution for the first portion of the display area.

In another embodiment according to the present disclosure, a touch screen display and associated methods are described for altering a touch screen resolution based on characteristics of displayed video content, such as a change in the rate of motion of the video content. In this embodiment, the touch screen display includes a display configured to display frames of data in a display area. The touch screen display further includes a plurality of row electrodes and a plurality of column electrodes (e.g., selectively formed from integrated electrode pads), wherein the plurality of row electrodes and the plurality of column electrodes are spaced apart to support at best a highest touch resolution; a plurality of drive-sense circuits; a first switch network coupling a first set of drive-sense circuits to the plurality of row electrodes; a second switch network coupling a second set of drive-sense circuits to the plurality of column electrodes; and a switch controller coupled to the first switch network and to the second switch network, the switch controller configured to control the first switch network and the second switch network to control touch resolution of at least a portion of the touch screen display between the highest touch resolution and lesser touch resolutions. The touch screen display of this embodiment further includes a processing module coupled to the plurality of drive-sense circuits and to the switch controller. The processing module is configured to identify a change in the rate of motion of at least one portion of a display image generated from the frames of data. In response to identifying a change in the rate of motion, the processing module is further configured to associate the at least one portion of the display image with at least a first portion of the display area and transmit touch resolution change information to the switch controller, wherein the touch resolution change information indicates the first portion of the display area and a target touch resolution for the first portion of the display area.

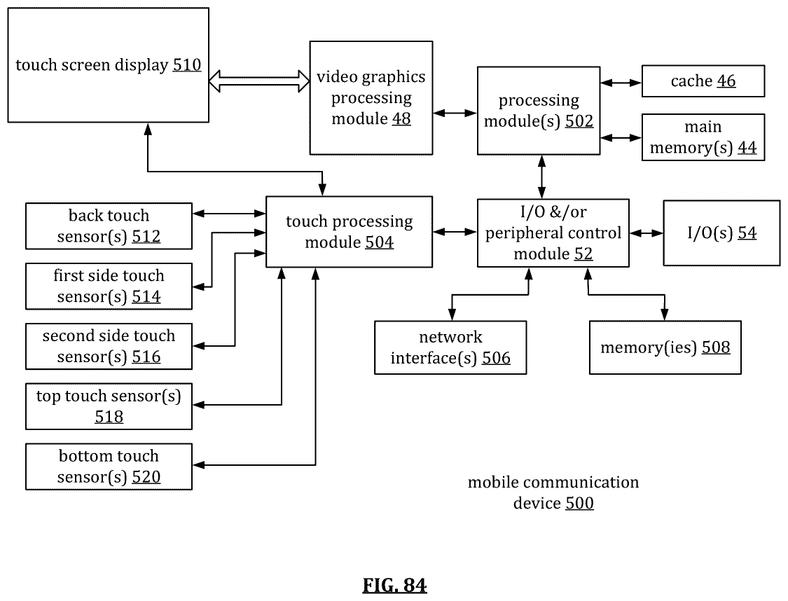

FIG. 84 is a block diagram of a mobile communication device having touch sensors used to determine when to disable functions of the mobile communication device. The mobile communication device 500 of FIG. 84 has components similar/same as those of the computing device of FIG. 2 with similar elements being number consistently. The mobile communication device 500 of FIG. 84 includes components consistent with a cellular telephone, small format tablet device, and/or another portable communication device. Thus, the mobile communication device 500 includes one or more wired and/or wireless network interfaces 506 to support wireless communications. Further, the mobile communication device 500 includes one or more processing modules 502 and memories 508 tailored to support of the mobile communication device 500.

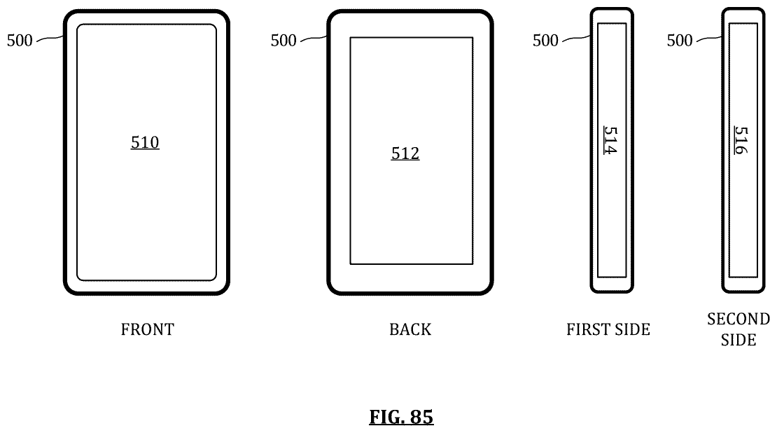

The mobile communication device 500 includes a case, within and upon which its other components are formed/housed. Similar to the computing device of FIG. 2, the mobile communication device 500 includes a touch processing module 504 that couples to a touch screen display 510 that has touch sensors and drive sense circuits, and which is located on a front surface of the case. However, the mobile communication device 500 also includes one or more back touch sensors 512 located on a back surface of the case, one or more first side touch sensors 514 located on a first side of the case, and one or more second side surface sensors 516 located on a second side of the case. Locations of the touch sensors upon the case of the mobile communication device 500 will be illustrated and described with reference to FIGS. 85-86. The mobile communication device 500 may also include one or more top touch sensors 518 located on a top of the case and one or more bottom touch sensors 520 located on a bottom of the case.

FIG. 85 is a diagram illustrating various views of a mobile communication device and touch sensors located thereon. As shown, the touch screen display 510 is located on a front surface of the case, a back touch sensor 512 is located on a back surface of the case, a first side touch sensor 514 is located on a first side of the case, and a second side touch sensor 516 is located on a second side of the case. Not shown are one or more top touch sensors 518 located on a top of the case and one or more bottom touch sensors 520 located on a bottom of the case.

FIG. 86 is a diagram illustrating various views of a differing touch sensor construct of the mobile communication device. As shown, the touch screen display 510 is located on a front surface of the case, a back touch sensor 512 is located on a back surface of the case, a first side touch sensor 514 is located on a first side of the case, and a second side touch sensor 516 is located on a second side of the case. Not shown are one or more top touch sensors 518 located on a top of the case and one or more bottom touch sensors 520 located on a bottom of the case. As compared to the structure of FIG. 85, the back touch sensor 512, the first side touch sensor 514 and the second side touch sensor 516 of FIG. 86 have smaller areas than those of commonly numbered components.

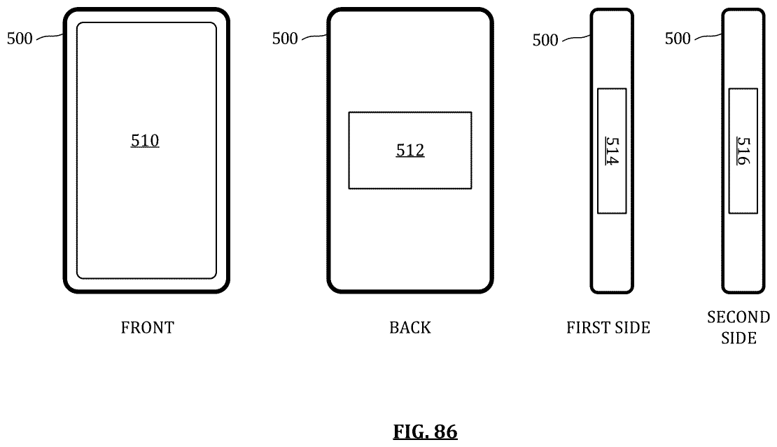

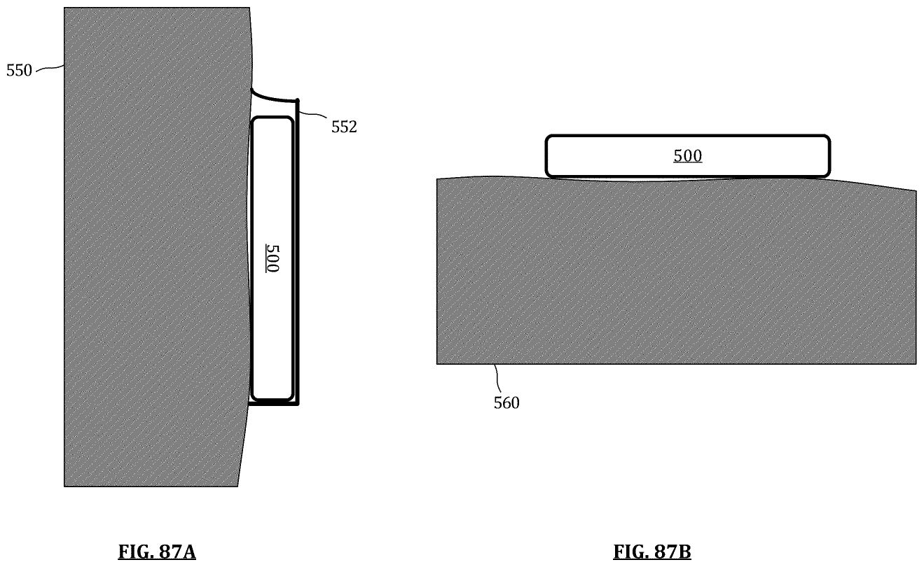

FIG. 87A is a diagram illustrating the mobile communication device located in a pocket of a user. As shown, the mobile communication device has either its front surface or its back surface resting against a body part of a user 550 while in a pocket 552 of the user 550. In many cases, while in the pocket 552 of the user 550, the mobile communication device 500 is not being actively used by the user. However, with prior mobile communication devices, operations of the mobile communication device 500 may be initiated simply by the touch screen display 510 being activated by the touch of the user 550, e.g., leg, chest, etc. Such unintended touching may lead to pocket dials, unintended text messages, unintended application launches, among other unintended operations.

FIG. 87B is a diagram illustrating the mobile communication device resting on a surface. When the mobile communication device 500 is placed onto a surface of an object 560, e.g., table, couch, countertop, person, etc., the touch screen display 510 or the back surface touch sensor 512 may sense a partial, substantial, or full touch, mostly depending upon the conductivity of the object 560.

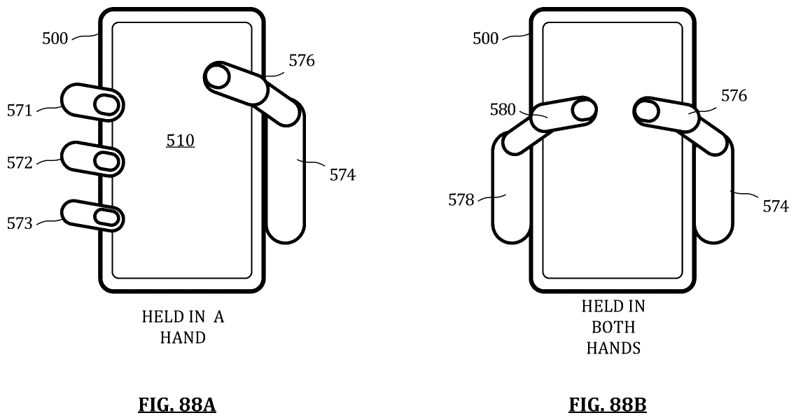

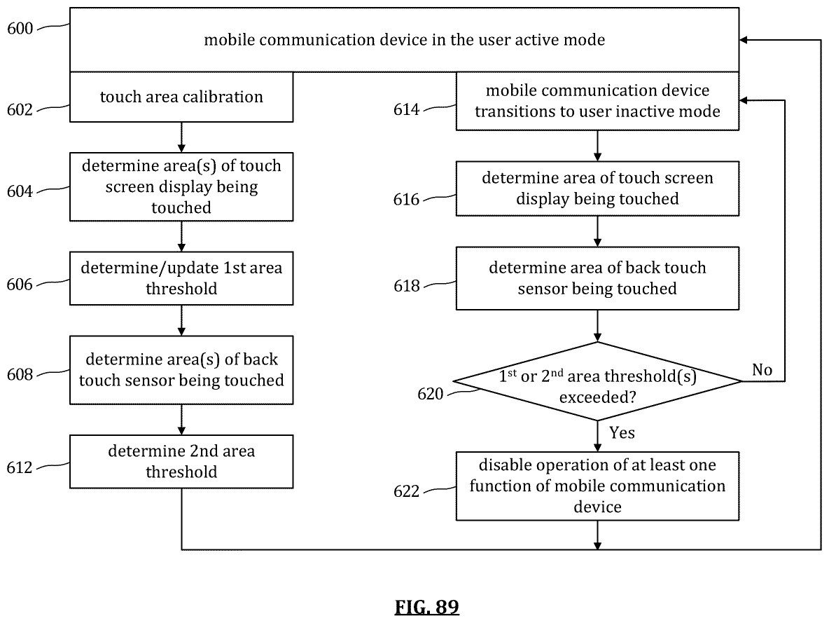

FIG. 88A is a diagram illustrating the mobile communication device held by a hand of a user. When the mobile communication device is held in the hand of a user, the user's palm 574, thumb 576, and fingers 571, 572, and 573 contact the case. Based upon their positions, the palm 574, thumb 576, and fingers 571, 572 and/or 573 may contact the first side touch sensor 514 and/or the second side touch sensor 516. The thumb 576 and/or tips of fingers 571, 572 and 573 may contact the touch screen display 510. These types of touches indicate that the user is interacting with the mobile communication device and based upon these touches, the mobile communication device 500 is in a user active mode.

FIG. 88B is a diagram illustrating the mobile communication device held in both hands of a user. Held in this position, a right palm 574 may contact a first side touch sensor 514 while a left palm 578 may contact a second side touch sensor. Further, right thumb 576 and left thumb 580 may contact the touch screen display 510. These types of touches indicate that the user is interacting with the mobile communication device and, based upon these touches, the mobile communication device 500 is in a user active mode.

FIG. 89 is a flow chart illustrating operation of the mobile communication device according to aspects herein. At operation 600 the mobile communication device 500 is the user active mode, characterized by the user holding the mobile communication device 500 in a hand or interacting with the mobile communication device 500 via the touch screen display 510 or via other interaction, e.g., voice recognition, button depression(s), etc.

From the user active mode 600, the mobile communication device may initiate touch area calibration at 602. In such case, the area(s) of the touch screen display being touched are determined at 604. Based upon this determination, a first area threshold is initially determined or updated at 606. Next, the area(s) of the back touch sensor being touched are determined at 608. Based upon this determination, a second area threshold is initially determined or updated at 612. From 612 operation returns to 600.

Also, from the user active mode 600, the mobile communication device may transition to a user inactive mode at 614. Generally, the user inactive mode is entered when user has not interfaced with the mobile communication device for a period of time via and is not holding the mobile communication device in his or her hand. From 614, the area of the touch screen display being touched is determined at 616 and the area of the back touch sensor being touched is determined at 618. These areas are compared to the first and second thresholds, respectively, at 620. If these thresholds are not exceeded, operation returns to 614. However, if one or more of these thresholds are exceeded, at least one function of the mobile communication device is disabled at 622. Operation remains at 622 until the mobile communication device transitions to the user active mode at 600.

Referring to all of FIGS. 84-89, according to embodiments described herein, a mobile communication device has a case having a front surface, a back surface, a first side, a second side, a top, and a bottom. The mobile communication device also has a touch screen display located on the front surface of the case and a back touch sensor located on the back surface case. The mobile communication device further has a touch processing module coupled to the touch screen display and to the back touch sensor. The touch screen processing module is configured to determine that a touch has been made on an area of the touch screen display or on the back sensor that exceeds a touch area threshold. A processing module of the mobile communication device communicatively couples to the touch processing module and is configured to determine whether the mobile communication device is in a user active mode and when the mobile communication device is not in a user active mode, based upon a determination that an area of the touch screen display being touched exceeds a first area threshold and/or an area of the back touch sensor being touched that exceeds a second area threshold, disable operation of at least one function of the mobile communication device.

The mobile communication device may further include a first side touch sensor located on the first side of the case and coupled to the touch processing module and a second side touch sensor located on the second side of the case and coupled to the touch processing module. The touch processing module is configured to detect touches on the first side touch sensor and on the second side touch sensor and to determine, when touches are detected on the first side touch sensor or on the second side touch sensor, that the mobile communication device is in the user active mode.

The touch processing module may be further configured to periodically determine areas of the touch screen display being touched while the mobile communication device is in the user active mode and determine the first area threshold based upon the periodically determined areas.

The touch processing module may be configured to periodically determine areas of the back touch sensor being touched while the mobile communication device is in the user active mode and determine the second area threshold based upon the periodically determined areas.

The at least one function of the mobile communication device disabled may include one or more of touch screen video display, voice calling, voice conferencing, video calling, video conferencing, audio playback, video playback, texting, social media application interaction, application launching, application servicing, application interfacing or payment processing, among other functions.

The touch screen display may have a first touch resolution and the back touch sensor may have a second touch resolution that is lesser than the first touch resolution. The touch screen display may have a variable touch resolution and, in the user active mode the touch screen display resolution may be greater than the touch screen display resolution when in the user inactive mode.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or may further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A touch screen display comprising:
a display configured to display images in a display area;
a plurality of row electrodes integrated into the display;
a plurality of column electrodes integrated into the display, wherein the plurality of row electrodes and the plurality of column electrodes are spaced apart to support at best a highest touch resolution;
a plurality of drive-sense circuits;
a first switch network coupling a first set of drive-sense circuits to the plurality of row electrodes;
a second switch network coupling a second set of drive-sense circuits to the plurality of column electrodes, the first set of drive-sense circuits and the second set of drive-sense circuits operable to drive signals on to the plurality of row electrodes and the plurality of column electrodes;
a switch controller coupled to the first switch network and to the second switch network, the switch controller configured to control the first switch network and the second switch network to control touch resolution of at least a portion of the touch screen display between the highest touch resolution and lesser touch resolutions; and
a processing module coupled to the plurality of drive-sense circuits and to the switch controller, the processing module configured to:
sense an electrical characteristic of at least one row electrode and at least one column electrode based on the signals;
detect, based on the electrical characteristic, a proximate finger or stylus; and
in response to detecting the proximate finger or stylus, transmit touch resolution change information to the switch controller.

2. The touch screen display of claim 1, wherein the switch controller is further configured to control the first switch network and the second switch network to modify a touch resolution of the at least a portion of the touch screen display in response to the touch resolution change information.

3. The touch screen display of claim 2, wherein detecting a proximate finger or stylus includes detecting the proximate finger or stylus in a first portion of the display area, and wherein modifying the touch resolution includes increasing the touch resolution of the first portion of the display area.

4. The touch screen display of claim 2, wherein the switch controller is configured to control the first switch network and the second switch network to:
couple a first number of column electrodes in a first portion of the display area to a first subset of the first set of drive-sense circuits;
couple a first number of row electrodes in the first portion of the display area to a first subset of the second set of drive-sense circuits;
couple a second number of column electrodes in a second portion of the display area to a second subset of the first set of drive-sense circuits, wherein the first number of column electrodes is different than the second number of column electrodes; and
couple a second number of row electrodes in the second portion of the display area to a second subset of the second set of drive-sense circuits, wherein the first number of row electrodes is different than the second number of row electrodes.

5. The touch screen display of claim 1, wherein:
the plurality of row electrodes includes one or more electrode pads on a first substantially transparent and conductive layer of the display; and
the plurality of column electrodes includes one or more electrode pads on a second substantially transparent and conductive layer of the display.

6. The touch screen display of claim 1, wherein:
the plurality of row electrodes includes one or more sub-pixel electrodes; and
the plurality of column electrodes includes one or more sub-pixel electrodes.

7. The touch screen display of claim 1, wherein:
the plurality of row electrodes includes at least two line electrodes; and
the plurality of column electrodes includes at least two line electrodes, wherein the plurality of column electrodes are separated from the plurality of row electrodes by a dielectric layer and have a differing orientation than the plurality of row electrodes.

8. The touch screen display of claim 1, wherein the signals from the first set of drive-sense circuits and the second set of drive-sense circuits include a common reference signal that has a DC component and an oscillating component such that the signals driving the plurality of row electrodes and the plurality of column electrodes have the same signal characteristics.

9. A method for controlling touch resolution in a display, the method comprising:
establishing a first touch resolution for a display area of the display, including:
coupling, via a first switch network, a first set of drive-sense circuits to a plurality of row electrodes of the display; and
coupling, via a second switch network, a second set of drive-sense circuits to a plurality of column electrodes of the display, wherein a touch resolution is proportional to a number of row electrodes and a number of column electrodes individually coupled to a respective drive-sense circuit;
driving signals from the first set of drive-sense circuits and the second set of drive-sense circuits on to the plurality of row electrodes and the plurality of column electrodes;
sensing, based on the signals, an electrical characteristic of at least one row electrode and at least one column electrode;
detecting, based on the electrical characteristic, a proximate finger or stylus; and
in response to detecting the proximate finger or stylus, establishing a second touch resolution for the display, wherein the second touch resolution differs from the first touch resolution.

10. The method of claim 9, wherein detecting a proximate finger or stylus includes detecting the proximate finger or stylus in a first portion of the display area, and wherein establishing a second touch resolution for the display includes increasing the touch resolution of the first portion of the display area.

11. The method of claim 10, wherein increasing the touch resolution of the first portion of the display area includes:
coupling a first number of column electrodes in the first portion of the display area to a first subset of the first set of drive-sense circuits;
coupling a first number of row electrodes in the first portion of the display area to a first subset of the second set of drive-sense circuits;
coupling a second number of column electrodes in a second portion of the display area to a second subset of the first set of drive-sense circuits, wherein the first number of column electrodes is greater than the second number of column electrodes on a per-area basis; and
coupling a second number of row electrodes in the second portion of the display area to a second subset of the second set of drive-sense circuits, wherein the first number of row electrodes is greater than the second number of row electrodes on a per-area basis.

12. The method of claim 9, wherein:
the plurality of row electrodes includes one or more electrode pads on a first substantially transparent and conductive layer of the display; and
the plurality of column electrodes includes one or more electrode pads on a second substantially transparent and conductive layer of the display.

13. The method of claim 9, wherein:
the plurality of row electrodes includes one or more sub-pixel electrodes; and
the plurality of column electrodes includes one or more sub-pixel electrodes.

14. The method of claim 9, wherein:
the plurality of row electrodes includes at least two line electrodes; and
the plurality of column electrodes includes at least two line electrodes, wherein the plurality of column electrodes are separated from the plurality of row electrodes by a dielectric layer and have a differing orientation than the plurality of row electrodes.

15. The method of claim 9, wherein the electrical characteristic is indicative of a change in mutual impedance between the at least one row electrode and the at least one column electrode.

16. A touch screen display comprising:
a display configured to display images in a display area;
an array of electrode pads extending across a touch area and having a pitch capable of supporting a highest touch resolution;
a plurality of drive-sense circuits;
a switch network coupled between the array of electrode pads and the plurality of drive-sense circuits;
a switch controller coupled to the switch network and configured to:
control the switch network to form row electrodes from a first group of the array of electrode pads and to form column electrodes from a second group of the array of electrode pads, the row electrodes and the column electrodes formed to have a controllable touch resolution between the highest touch resolution and lesser touch resolutions; and
control the switch network to drive signals from a first set of drive-sense circuits on to the row electrodes and drive signals from a second set of drive-sense circuits on to the column electrodes; and
a processing module coupled to the plurality of drive-sense circuits and to the switch controller, the processing module configured to:
sense an electrical characteristic of at least one row electrode and at least one column electrode based on the signals;
detect, based on the electrical characteristic, a proximate finger or stylus; and
in response to detecting the proximate finger or stylus, transmit touch resolution change information to the switch controller.

17. The touch screen display of claim 16, wherein the switch controller is further configured to control the switch network to modify a touch resolution of at least a portion of the touch screen display in response to the touch resolution change information.

18. The touch screen display of claim 17, wherein detecting a proximate finger or stylus includes detecting the proximate finger or stylus in a first portion of the display area, and wherein modifying the touch resolution includes increasing the touch resolution of the first portion of the display area.

19. The touch screen display of claim 16, wherein:
the first group of the array of electrode pads are formed on a first substantially transparent and conductive layer of the display; and
the second group of the array of electrode pads are formed on a second substantially transparent and conductive layer of the display.

20. The touch screen display of claim 16, wherein the electrical characteristic is indicative of a change in mutual impedance between the at least one row electrode and the at least one column electrode.
